(19) United States
(12) Patent Application Publication
(10) Pub. No.: US 2025/0141747 A1
(43) Pub. Date: May 1, 2025

(54) DISPLAY APPARATUS AND CONTROL METHOD

(71) Applicant: VIDAA (NETHERLANDS) INTERNATIONAL HOLDINGS B.V., Duiven (NL)

(72) Inventors: Ziming ZHU, Duiven (NL); Baoshan DUAN, Duiven (NL)

(21) Appl. No.: 19/008,406

(22) Filed: Jan. 2, 2025

Related U.S. Application Data
(63) Continuation of application No. PCT/EP2024/064215, filed on May 23, 2024.

(30) Foreign Application Priority Data
May 24, 2023 (CN) 202310594415.5
May 24, 2023 (CN) 202310596551.8
Jul. 20, 2023 (CN) 202310897377.0
Aug. 21, 2023 (CN) 202311052226.1

(51) Int. Cl. H04L 41/0895; H04L 9/40; H04L 41/22

(52) U.S. Cl. CPC H04L 41/0895; H04L 41/22; H04L 63/0428; H04L 63/0823

(57) ABSTRACT

The present application provides an electronic device and a control method for the electronic device. A control device, after discovering a first device, based on receiving an adding command for a network configuration for the first device input from a user, can send a network configuration request to the first device to establish a first encrypted session with the first device. The control device, under this first encrypted session, verifies legitimacy of the first device and, after the first device passes verification, can send network configuration information to the first device.

### CROSS REFERENCE TO RELATED APPLICATIONS

The present application is continuation of PCT Application No. PCT/EP2024/064215, filed on May 23, 2024, which is claims priority to the Chinese patent application No. 202310596551.8 filed on May 24, 2023, the Chinese patent application No. 202310594415.5 filed on May 24, 2023, the Chinese patent application No. 202310897377.0 filed on Jul. 20, 2023, and the Chinese patent application No. 202311052226.1 filed on Aug. 21, 2023, the entire contents of which are incorporated herein by reference.

### TECHNICAL FIELD

The present application relates to the technical field of Internet of Things devices, in particular to a control device, a commissionee device and a control method between devices.

### BACKGROUND

The Internet of Things (IoT) is an Internet-based information carrier that allows all devices that can be independently addressed to form an interconnected network. The devices in the Internet of Things may be divided into control devices and commissionee devices, and a user may control a commissionee device through a control device.

When adding the commissionee device to the control device, the user searches for the commissionee device through the control device. Based on that the control device discovers the commissionee device on the basis of a discovery protocol supported by the commissionee device, device information of the commissionee device, such as a device name, an Internet Protocol (IP) address, and a Media Access Control (MAC) address may be obtained. Further, a command is sent to the commissionee device on the basis of the device information to realize the control for the commissionee device.

In accordance with the above process, the control device is likely to take control for an illegal commissionee device and threaten the security of itself, as well as other commissionee devices under its control in the interaction process. Moreover, any control device may control the same commissionee device in accordance with the above process, and thus when the commissionee device has been controlled by the control device used by the user, other control devices may still control it at will, resulting in interference with the control for the commissionee device by the control device used by the user.

### SUMMARY

some embodiments of the present application provide a control device which may include a display, configured to display a device adding interface, the device adding interface being capable of including a discovered first device; a memory, storing a node operational certificate corresponding to a virtual domain of the control device, wherein the virtual domain may include the control device and a commissionee device controlled by the control device; and at least one processor, configured to execute a computer instruction to cause a display apparatus to execute: controlling, in response to an adding command input from a user on the basis of the first device, the display to display a network configuration interface, the adding command being used for instructing a network configuration for the first device, and the network configuration interface being used for the user to perform a network configuration operation on the first device; sending, in response to the network configuration operation from the user, a network configuration request to the first device, the

network configuration request being used for requesting an establishment of a first encrypted session with the first device; sending a verification request to the first device via the first encrypted session, the verification request being used for requesting a device attestation certificate of the first device; sending, based on that the first device is identified to be attested according to the received device attestation certificate, network configuration information to the first device via the first encrypted session, the network configuration information being capable of including a node operational certificate assigned to the first device, and controlling, after the network configuration for the first device, the display to display a commissionee device interface, the commissionee device interface being capable of including the first device; sending, in response to a selection command input from the user on the basis of the first device, an interaction request to the first device via the first encrypted session, the interaction request being used for requesting an establishment of a second encrypted session with the first device, wherein the second encrypted session is established on the basis of the node operational certificate held by the control device and the node operational certificate held by the first device respectively; and sending, in response to a control operation from the user, a corresponding command to the first device via the second encrypted session.

Some embodiments of the present application provide a commissionee device, which may include: a communicating device, configured to communicate with a first control device; and at least one processor, configured to execute a computer instruction to cause a display to: establish, in response to a network configuration request sent from the first control device, a first encrypted session with the first control device, the first control device having a corresponding virtual domain, and a commissionee device in the virtual domain holding a node operational certificate assigned by the control device; send, in response to a verification request sent from the first control device via the first encrypted session, a device attestation certificate to the first control device via the first encrypted session; receive network configuration information sent from the first control device via the first encrypted session after the first electronic device identifies that the commissionee device passes verification, the network configuration information being capable of including a node operational certificate assigned by the first control device; establish, in response to a session request sent from the first control device via the first encrypted session, a second encrypted session with the first control device, wherein the second encrypted session is established on the basis of the node operational certificate held by the commissionee device and the node operational certificate held by the first control device respectively; and execute, in response to a command sent from the first control device via the second encrypted session, a corresponding task.

some embodiments of the present application provide a control method. A control device displays a device adding interface. The device adding interface may include a discovered first device, and a memory, storing a node operational certificate corresponding to a virtual domain of the control device, wherein the virtual domain may include the control device and a commissionee device controlled by the control device. The method may include: displaying, in response to an adding command input from a user on the basis of the first device, a network configuration interface, the adding command being used for instructing a network configuration for the first device, and the network configuration interface being used for the user to perform a network configuration operation on the first device; sending, in response to the network configuration operation from the user, a network configuration request to the first device, the network configuration request being used for

requesting an establishment of a first encrypted session with the first device; sending a verification request to the first device via the first encrypted session, the verification request being used for requesting a device attestation certificate of the first device; sending, based on that the first device is identified to be attested according to the received device attestation certificate, network configuration information to the first device via the first encrypted session, the network configuration information being capable of including a node operational certificate assigned to the first device, and controlling, after the network configuration for the first device, a display to display a commissionee device interface, the commissionee device interface being capable of including the first device; sending, in response to a selection command input from the user on the basis of the first device, an interaction request to the first device via the first encrypted session, the interaction request being used for requesting an establishment of a second encrypted session with the first device, wherein the second encrypted session is established on the basis of the no-objection certificate held by the control device and the node operational certificate held by the first device respectively; and sending, in response to a control operation from the user, a corresponding command to the first device via the second encrypted session.

some embodiments of the present application provide a control method applied to the commissionee device as described in the preceding embodiments. When the commissionee device communicates with a first control device, the method may include: establishing, in response to a network configuration request sent from the first control device, a first encrypted session with the first control device, the first control device having a corresponding virtual domain, and the commissionee device in the virtual domain holding a node operational certificate assigned by the control device; sending, in response to a verification request sent from the first control device via the first encrypted session, a device attestation certificate to the first control device via the first encrypted session; receiving network configuration information sent from the first control device via the first encrypted session after the first electronic device identifies that the commissionee device passes verification, the network configuration information being capable of including a node operational certificate assigned by the first control device; establishing, in response to a session request sent from the first control device via the first encrypted session, a second encrypted session with the first control device, wherein the second encrypted session is established on the basis of the node operational certificate held by the commissionee device and the node operational certificate held by the first control device respectively; and executing, in response to a command sent from the first control device via the second encrypted session, a corresponding task.

### BRIEF DESCRIPTION OF FIGURES

FIG. 1 is a schematic diagram of Internet of Things according to some embodiments of the present application.

FIG. 2 is a diagram of a configuration of a second type of commissionee device according to some embodiments of the present application.

FIG. 3 is a diagram of a configuration of an operating system of a second type of commissionee device according to some embodiments of the present application.

FIG. 4 is a schematic diagram of an interaction of a control device 1 controlling a commissionee device 2 according to some embodiments of the present application.

FIG. 5 is a schematic diagram of a commissionee device interface according to some embodiments of the present application.

FIG. 6 is a schematic diagram of virtual domains in the same one wireless local area network according to some embodiments of the present application.

FIG. 7 is a flowchart of a first control device discovering a first device and displaying a discovery result according to some embodiments of the present application.

FIG. 8 is a schematic diagram of a system frame configured for a first device according to some embodiments of the present application.

FIG. 9 is a schematic diagram of an interaction of a first control device controlling a first device according to some embodiments of the present application.

FIG. 10 is a flowchart of a first control device establishing a first encrypted session with a first device according to some embodiments of the present application.

FIG. 11 is a flowchart of a first control device and a first device establishing a passcode-authenticated session establishment (PASE) session according to some embodiments of the present application.

FIG. 12 is a flowchart of a first control device verifying a first device according to some embodiments of the present application.

FIG. 13 is a schematic diagram of a first control device displaying prompt information when a first device fails to pass attestation according to some embodiments of the present application.

FIG. 14 is a schematic diagram of an interaction of a first control device controlling a first device to be added to a specified network according to some embodiments of the present application.

FIG. 15 is a schematic diagram of a commissionee device interface displayed by a first control device according to some embodiments of the present application.

FIG. 16 is a flowchart of a first control device adjusting a position of a first device in a commissionee device interface according to some embodiments of the present application.

FIG. 17 is a flowchart of a first control device establishing a second encrypted session with a first device according to some embodiments of the present application.

FIG. 18 is a flowchart of a cell phone A controlling a smart door lock according to some embodiments of the present application.

FIG. 19 is a flowchart of a cell phone A controlling a television (TV) according to some embodiments of the present application.

FIG. 20 is a schematic diagram of an interaction of a first control device controlling a first device in appearance of a second control device according to some embodiments of the present application.

FIG. 21 is a flowchart of a first device responding to a command when being added to virtual domains of a plurality of control devices simultaneously according to some embodiments of the present application.

FIG. 22 is a schematic diagram of a cell phone A managing a control privilege of a cell phone B over a TV according to some embodiments of the present application.

FIG. 23 is a schematic diagram of a commissionee device list according to some embodiments of the present application.

FIG. 24 is a flowchart of a primary control device updating a device state of a commissionee device according to some embodiments of the present application.

FIG. 25 is a flowchart of a primary control device storing an MAC address of a first device according to some embodiments of the present application.

FIG. 26 is a flowchart of a primary control device obtaining an MAC address of a first device according to some embodiments of the present application.

FIG. 27 is a flowchart of a primary control device managing a first device after adding the first device to a virtual domain according to some embodiments of the present application.

FIG. 28 is a schematic diagram of a TV performing network configurations for a cell phone A and a tablet computer B according to some embodiments of the present application.

FIG. 29 is a schematic diagram of managing a device after a TV adds a cell phone A and a tablet computer B to a virtual domain according to some embodiments of the present application.

FIG. 30 is a flowchart of a primary control device updating a device state of a second device according to some embodiments of the present application.

FIG. 31 is a schematic diagram of a TV updating a device state of a cell phone A according to some embodiments of the present application.

FIG. 32 is a flowchart of managing a device state of a commissionee device after a primary control device is re-powered up according to some embodiments of the present application.

FIG. 33 is a flowchart of managing each node after a primary control device is re-powered up according to some embodiments of the present application.

FIG. 34 is a schematic diagram of managing a cell phone A and a tablet computer B after a TV is re-powered up according to some embodiments of the present application.

FIG. 35 is a flowchart of a third-party device assigning a control privilege of a commissionee device to a primary control device newly added to a virtual domain according to some embodiments of the present application.

FIG. 36 is a flowchart of a third-party device assigning a control privilege of a second node to a primary control device according to some embodiments of the present application.

FIG. 37 is a schematic diagram of a commissionee device list displayed by a third-party device according to some embodiments of the present application.

FIG. 38 is a flowchart of a third-party device assigning a primary control device with a control privilege to a control device newly added to a virtual domain according to some embodiments of the present application.

FIG. 39 is a schematic diagram of a primary control device list displayed by a third-party device according to some embodiments of the present application.

FIG. 40 is a flowchart of a third-party device assigning a control privilege of a commissionee device newly added to a virtual domain to a primary control device newly added to the virtual domain according to some embodiments of the present application.

FIG. 41 is a schematic diagram of a scenario in which a primary control device and a commissionee device perform an inter-device network configuration on the basis of a third-party device according to some embodiments of the present application.

FIG. 42 is a flowchart of a third-party device deleting a control privilege of a first node over a second node according to some embodiments of the present application.

FIG. 43 is a flowchart of a third-party device deleting a control privilege of a first node over a second node according to some embodiments of the present application.

FIG. 44 is a flowchart of a third-party device deleting a control privilege of a first node over a second node according to some embodiments of the present application.

FIG. 45 is a schematic diagram of virtual domains in the same one wireless local area network according to some embodiments of the present application.

FIG. 46 is a flowchart of a control device performing a network configuration for a commissionee device according to some embodiments of the present application.

FIG. 47 is a schematic diagram of a scenario in which a smart device can perform an OTA proxy upgrade through a display apparatus located in the same one virtual domain as the smart device according to some embodiments of the present application.

FIG. 48 is a flowchart of a smart device performing a system upgrade through a display apparatus according to some embodiments of the present application.

FIG. 49 is a flowchart of a smart device identifying a display apparatus according to some embodiments of the present application.

FIG. 50 is a flowchart of a display apparatus obtaining a response status according to some embodiments of the present application.

FIG. 51 is a flowchart of a display apparatus downloading a target upgrade package from a cloud server according to some embodiments of the present application.

FIG. 52 is a flowchart of a smart device downloading a target upgrade package from a display apparatus according to some embodiments of the present application.

FIG. 53 is a flowchart of a smart device installing a target upgrade package according to some embodiments of the present application.

FIG. 54 is a schematic diagram of a network configuration for a TV through a cell phone in an example(s) according to some embodiments of the present application.

FIG. 55 is a schematic diagram of a TV realizing an OTA proxy upgrade through a cell phone in an example(s) according to some embodiments of the present application.

FIG. 56 is a schematic diagram of a TV with a control privilege controlling a controlled TV to perform an OTA proxy upgrade in an example(s) according to some embodiments of the present application.

FIG. 57 is a schematic diagram of a network configuration for a door lock through a TV in an example(s) according to some embodiments of the present application.

FIG. 58 is a schematic diagram of a door lock realizing an OTA proxy upgrade through a TV in an example(s) according to some embodiments of the present application.

FIG. 59 is a schematic diagram of a TV controlling a door lock to realize an OTA proxy upgrade in an example(s) according to some embodiments of the present application.

### DETAILED DESCRIPTION

Some embodiments will be described in detail below, and examples thereof are shown in the accompanying drawings. When the following description refers to the drawings, unless otherwise indicated, the same numbers in different drawings indicate the same or similar elements. The implementations described in the following embodiments do not represent all implementations consistent with the present application. They are merely examples of systems and methods consistent with some aspects of the present application as detailed in the claims.

It should be noted that the brief description of terms in the present application is only for the convenience of understanding the implementations described below, rather than intended to limit the implementations of the present application. Unless otherwise indicated, these terms shall be understood in accordance with their common and usual meanings.

The terms “first”, “second”, “third”, etc. in the description, claims and drawings in the present application are used to distinguish similar or same objects or entities, and do not necessarily mean to define a specific order or sequence, unless otherwise indicated. It should be understood that the terms so used can be interchanged under appropriate circumstances.

The Internet of Things is an Internet-based information carrier that allows all devices that can be independently addressed to form an interconnected network. The devices in the Internet of Things may be divided into control devices and commissionee devices. When a device can control other devices in the Internet of Things, the device is a control device, and when a device is controlled by other devices in the Internet of Things, the device is a commissionee device. Thus, the same device may be both the control device and the commissionee device in the Internet of Things. A user may control the commissionee device through the control device, and the control device will respond to an operation from the user to send a corresponding command and send corresponding data to the commissionee device, and the commissionee device can respond to the command to execute a corresponding operation and receive the transmitted data.

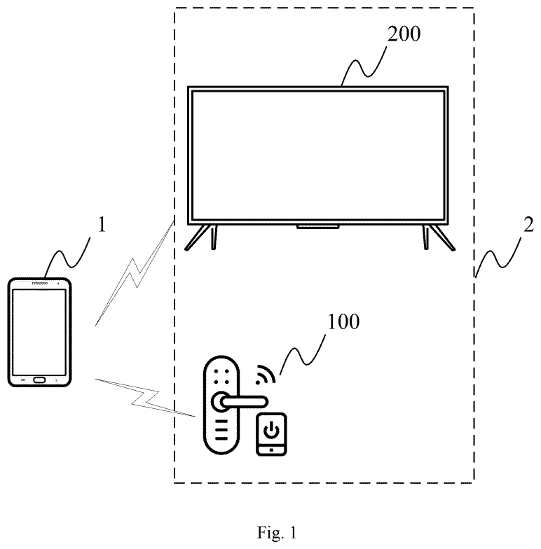

The Internet of Things shown in FIG. 1 is taken as an example. The Internet of Things may include a control device 1 and a commissionee device 2, wherein the commissionee device 2 may include a first type of commissionee device 100 and a second type of commissionee device 200. The user can send a command to the commissionee device 2 through the control device 1 to control the commissionee device 2.

The control device 1, i.e., a primary control device, and the commissionee device 2, provided by some embodiments of the present application may have a variety of implementation forms, e.g., the primary control device and the commissionee device may be display apparatuses or non-display apparatuses.

In some embodiments, based on that the primary control device is the display

apparatus, the display apparatus may have a variety of implementation forms, for example, it may be a cell phone, a smart TV, a laser projection device, a display, an electronic bulletin board, and an electronic table, as shown in FIG. 1, and it also may be a device with a display screen, such as a cell phone, a tablet computer, and a smart watch. A control application supported by the commissionee device 2 can be installed on the control device 1, and on the basis of the control application, the control device 1 may send a command to the commissionee device 2. Communication between the control device 1 and the commissionee device 2 may include at least one of Bluetooth protocol communication, Near Field Communication (NFC) or other short-range communication modes, so that the control device 1 may establish short-range communication with the commissionee device 2. The control device 1 further can support an Internet protocol that allows it to access a wireless network and send a command to the commissionee device 2 wirelessly. The user may input a command through virtual buttons, physical buttons, voice inputs, etc. on the display screen of the control device 1.

The first type of commissionee device 100 can be a device that does not have a visualization interface, such as a smart door lock shown in FIG. 1, and may also be a smart headphone, a smart stereo, a smart light, a smart air conditioner, a smart stove, a smart bathroom, etc. The first type of commissionee device 100 may include a communicating device, and the first type of commissionee device 100 may establish sending and receiving of a control signal and a data signal through the communicating device and the control device 1. The first type of commissionee device 100 may further access the wireless network through the communicating device.

Since the first type of commissionee device 100 does not have the visualization interface, the user cannot set the wireless network directly on the first type of commissionee device 100, and needs to access the wireless network with the assistance of other devices with the help of a Bluetooth communication protocol. Taking the smart door lock as an example, it is necessary to first establish Bluetooth communication with the cell phone, then the cell phone can send network interface configuration information of the wireless network to the smart door lock through Bluetooth communication, and the smart door lock accesses the wireless network according to the network interface configuration information.

The second type of commissionee device 200 can be a device having a visualization interface, such as the smart TV shown in FIG. 1, and it may further be a laser projection device, a display, an electronic bulletin board, an electronic table, a cell phone, a tablet computer, a smart watch, etc. Since the second first type of commissionee device 200 has the visualization interface, the user can set the wireless network directly on the second type of commissionee device 200.

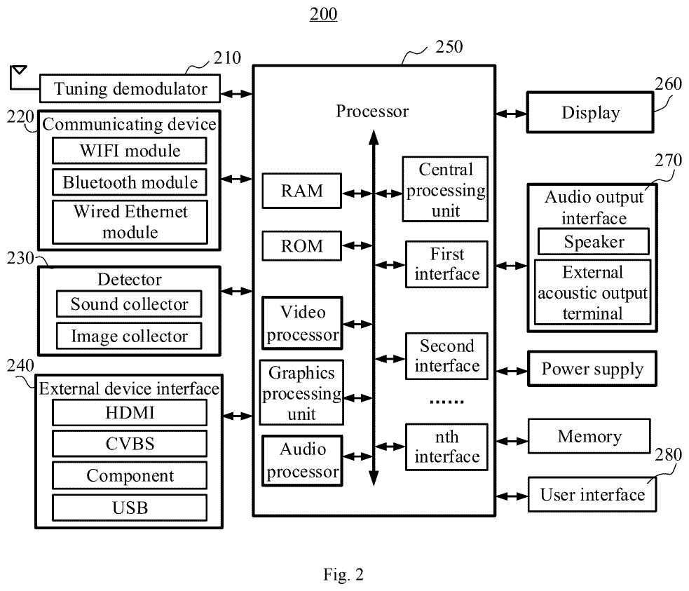

FIG. 2 shows a block diagram of a configuration of a second type of commissionee device 200 according to some embodiments. The second type of commissionee device 200 may include at least one of a tuning demodulator 210, a communicating device 220, a detector 230, an external device interface 240, at least one processor 250, a display 260, an audio output interface 270, a memory, a power supply, or a user port 280.

The second type of commissionee device 200 may establish sending and receiving of the control signal and the data signal through the communicating device 220 and the control device 1. The second type of commissionee device 200 may further access the wireless network through the communicating device 220. In some embodiments, the processor(s) 250 and the tuning demodulator 210 may be located in different

split devices, that is, the tuning demodulator 210 may also be located in an external device of a main device where the at least one processor is located, such as an external set top box. In some embodiments, the at least one processor can control work of the display apparatus and responds to operations of the user through various software control programs stored on the memory. The at least one processor can control the overall operation of the second type of commissionee device 200. In some embodiments, the at least one processor may include at least one of a central processing unit (CPU), a video processor, an audio processor, a graphics processing unit (GPU), a random access memory (RAM), a read-only memory (ROM), a first interface to an nth interface for input/output, a communication bus (Bus), etc.

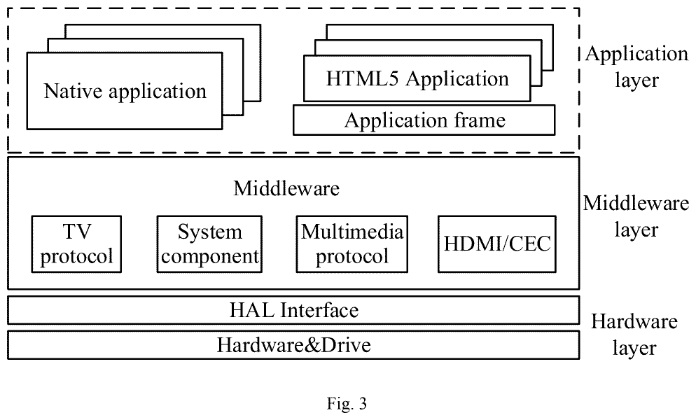

In some embodiments, the display 260 may include a display panel component for presenting an image, a driving component for driving image display, a component for receiving an image signal from output of the at least one processor to display a video content, an image content, and a menu control interface, and a user control UI. In some embodiments, the display 260 may be a liquid crystal display, an organic light-emitting diode (OLED) display, or a projection display, and may also be a projection apparatus or a projection screen. In some embodiments, the user may input a user command on a Graphics User Interface (GUI) displayed on the display 260, and a user input interface receives the user input command through the GUI. Alternatively, the user may input a user command by inputting a specific sound or gesture, and the user input interface recognizes the sound or gesture through a sensor to receive the user input command. In some embodiments, the second type of commissionee device 200 may be based on a VIDAA software platform, as shown in FIG. 3, where an operating system based on a Linux platform can be divided into three layers, which are an application layer, a middleware layer and a hardware layer from top to bottom respectively. The application layer may include various applications as well as application frames. The middleware layer may include various protocols and components. The hardware layer may include various interfaces as well as hardware and drivers. In some embodiments, a third-party application can be further integrated on the second type of commissionee device 200 in addition to a Native App to provide richer functions and resources to the user through the third-party application.

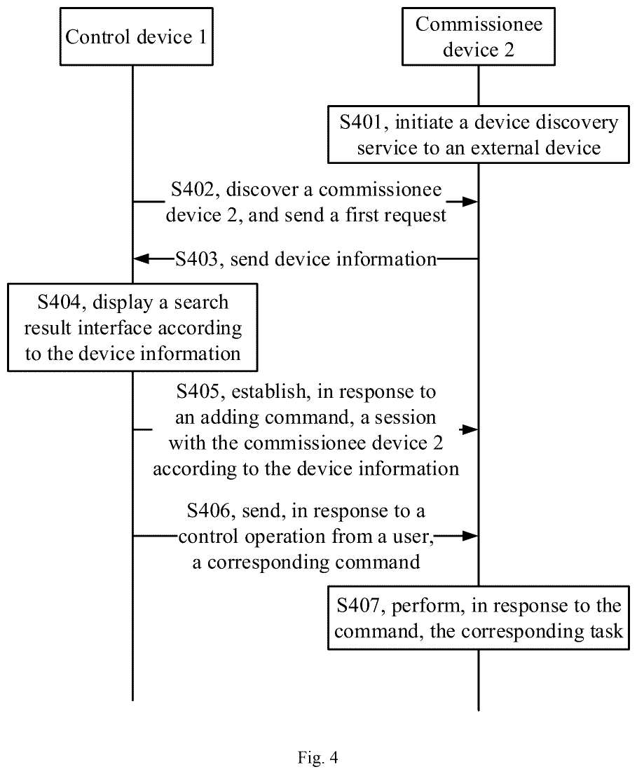

The control device 1 and the commissionee device 2 to be controlled need to connect with the same one local area network first, and after the user adds the commissionee device 2 to the control device 1, the control device 1 may control the commissionee device 2. The control device 1 and the commissionee device 2 are both electronic devices. A control process between the control device 1 and the commissionee device 2, with reference to a schematic diagram of an interaction shown in FIG. 4, may include the following.

S401, the commissionee device 2 initiates a device discovery service to an external device.

After the commissionee device 2 initiates a discovery service to one or more external devices, other devices may search for the commissionee device 2 on the basis of a discovery protocol supported by the commissionee device 2. The discovery protocol supported by the commissionee device 2 may be a Universal Plug and Play (UPnP) protocol, a Multicast Domain Name System (mDNS) protocol, etc.

S402, the control device 1 can send a first request to the commissionee device 2 after discovering the commissionee device 2.

The first request can be used for requesting device information of the

commissionee device 2, such as a device name, an Internet Protocol (IP) address, and a Media Access Control (MAC) address.

S403, the commissionee device 2, in response to the request of the control device 1, can send device information to the control device 1.

S404, the control device 1 displays a search result interface according to the device information of the commissionee device 2.

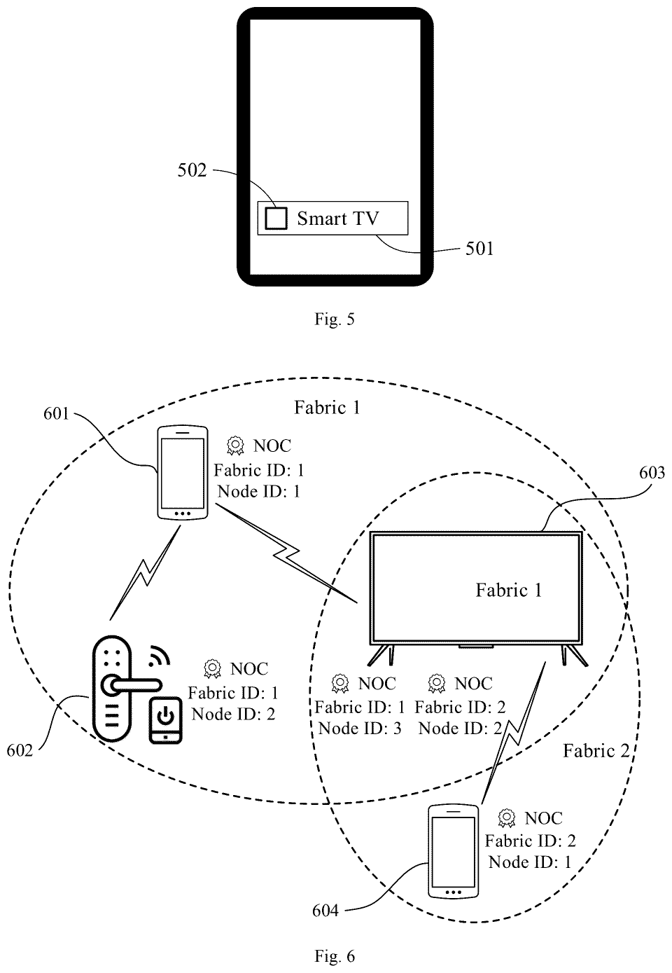

The search result interface may include an item of the commissionee device 2, and the item may include information such as a device name of the commissionee device 2, and a corresponding icon. Taking the control device 1 as a cell phone and the commissionee device 2 as a Smart TV as an example, based on that the cell phone searches for the Smart TV and obtains device information of the Smart TV, a commissionee device interface as shown in FIG. 5 may be displayed, which may include an item 501, and the item 501 may include a device name Smart TV of the Smart TV, and a corresponding icon 502.

S405, the control device 1, in response to an adding command input from the user, establishes a session with the commissionee device 2 according to device information of the commissionee device 2.

The user inputs an adding command on the basis of the item of the commissionee device 2 in the search result interface, and the adding command can be used for instructing the addition of the control for the commissionee device 2. The control device 1 may directly establish a session, i.e., a control relationship, with the commissionee device 2 according to the device information of the commissionee device 2.

S406, the control device 1, in response to a control operation from the user, on the basis of the session, can send a corresponding command to the commissionee device 2.

The user can perform a control operation on the control device 1, and the control device 1, in response to the control operation, can generate a corresponding command and can send the command to the commissionee device 2 to instruct the commissionee device 2 to perform a corresponding task.

S407, the commissionee device 2, in response to a command, can perform the corresponding task.

Thus the control process between the control device 1 and the commissionee device 2 is realized.

In accordance with the above process, the control device 1 is likely to take control for the illegal commissionee device 2 and threaten the security of itself, as well as other commissionee devices 2 under its control in the interaction process. Moreover, any control device 1 may control the same commissionee device 2 on the basis of steps S401-S407, and thus when the commissionee device 2 has been controlled by the control device 1 used by the user, other control devices 1 may still control it at will, resulting in interference with the control for the commissionee device 2 by the control device 1 used by the user.

In view of the issues above, some embodiments of the present application provide a control method between devices, which may be applied to the control device 1 and the commissionee device 2 as described in FIG. 1-FIG. 3, or other control devices and commissionee devices. The control device 1 and the commissionee device 2 described in FIG. 1-FIG. 3 are taken as examples for illustration in some embodiments of the present application. With this control method, the legitimacy of the commissionee device 2 may be effectively ensured, and the control device 1 used by the user to control the commissionee device 2 may be effectively

prevented from being interfered by other control device(s) 2.

In some embodiments of the present application, each control device 1 can have a corresponding virtual domain (Fabric), and the virtual domain may include a control device 1 and the commissionee device 2 controlled by the control device 1. The control device 1 and the commissionee device 2 belonging to the same one virtual domain access the same one local area network (i.e., a specified network), and the virtual domain to which the devices belong is identified by Node Operational Certificates (NOCs) they hold. After the control device 1 has a control privilege over the commissionee device 2, it adds the commissionee device 2 to its own virtual domain and assigns the NOC to the commissionee device 2. When the commissionee device 2 obtains the NOC assigned by the control device 1, it indicates that the commissionee device 2 is added to the virtual domain of the control device 1. The NOC held by each device in the virtual domain (which may include the control device 1 and the commissionee device 2) may include: a virtual domain identifier, such as a Fabric ID, used for uniquely identifying the virtual domain, and a node identifier, such as a Node ID, used for uniquely identifying the device in the virtual domain. That is, virtual domains of different control devices 1 have different Fabric IDs, and the Node IDs of the devices in the same one virtual domain are different, but the Node IDs of the devices belonging to different virtual domains may be the same. Within the same one local area network, one or more virtual domains may be included, and there may be overlaps between the virtual domains.

FIG. 6 is a schematic diagram of virtual domains in the same one wireless local area network, which may include virtual domains Fabric 1 and Fabric 2, as shown in FIG. 6, wherein Fabric 1 is a virtual domain of a cell phone 601, Fabric 1 may also include a smart door lock 602 and a TV 603 controlled by the cell phone 601, Fabric B is a virtual domain of a cell phone 604, and Fabric 2 may further include the TV 603 controlled by the cell phone 604. The NOC held by the cell phone 601 may include a Fabric ID: 1 and a Node ID: 1. The smart door lock 602 holds a NOC assigned by the cell phone 601, and the NOC may include a Fabric ID: 1 and a Node ID: 2. The TV 603 holds a NOC assigned by the cell phone 601, and the NOC may include a Fabric ID: 1 and a Node ID: 3. The TV 603 further holds a NOC assigned by the cell phone 604, and the NOC may include a Fabric ID: 2 and a Node ID: 2. The NOC held by the cell phone 604 may include a Fabric ID: 2 and a Node ID: 1.

The control process between the control device 1 and the commissionee device 2 are illustrated in conjunction with the following embodiments.

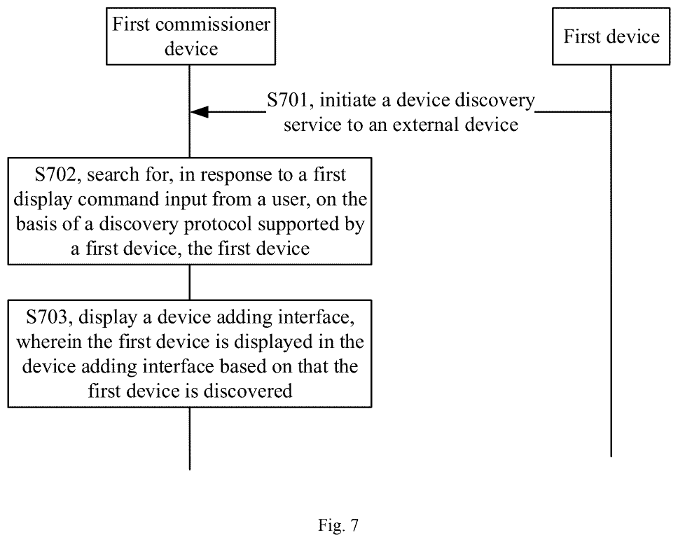

In an example(s), illustration is made by taking a first control device being the control device 1 and a first device being the commissionee device 2 as examples. A control application supported by the first device can be installed on the first control device. Before a network configuration by the first control device for the first device, a device adding interface may be displayed in accordance with an interaction process shown in FIG. 7, which may include the following.

S701, the first device initiates a device discovery service to an external device.

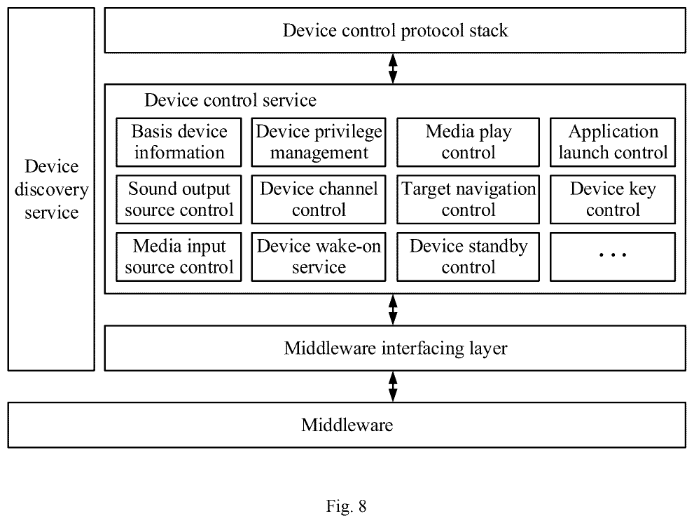

The first device may be configured with a system frame as shown in FIG. 8, where the first device is configured with a device discovery service and a device control service, as shown in FIG. 8. Discoveries supported by the device discovery service may include UPnP, a DNS Service Discovery (DNS-SD), etc. The device control service realizes interfacing with the control device on the basis of a device control

protocol stack, and the device control device interfaces with device middleware through a middleware interfacing layer to realize the control for the device. Device control services may include: device basic information, device privilege management, media playback control, application launch control, sound output source control, device channel control, target navigation control, device key control, media input source control, device wake-on service, device standby control, etc.

The first device may be discovered on a Bluetooth network based on that the first device is a first type of commissionee device 100 and a Bluetooth service is turned on. Based on that the first device is a second type of commissionee device 200 and has accessed a specified network, i.e., has accessed the same one wireless local area network as the first control device, the first device may be discovered on the wireless local area network.

S702, the first control device, in response to a first display command input from the user, on the basis of a discovery protocol supported by the first device, searches for the first device.

The first display command is used for instructing display of the device adding interface which may include a device discovered by the first commissionee device.

When the first control device searches for the first device on the basis of the discovery protocol supported by the first device, the first control device searches for the first device on the basis of the Bluetooth device discovery protocol supported by the first device based on that the first device is the first type of commissionee device 100. The first control device searches for the first device on the basis of the wireless network device discovery protocol supported by the first device based on that the first device is the second type of commissionee device 200.

S703, the first control device displays a device adding interface, wherein the first device is displayed in the device adding interface based on that the first device is discovered.

The first control device, based on that it discovers the first device, displays the first device in the device adding interface when the device adding interface is displayed to prompt the user that the first device is discovered. The device adding interface may further include other discovered devices, which is not limited here.

After discovering the first device, the first control device may interact with the first device in accordance with a process shown in FIG. 9, which may include the following.

S901, the first control device, in response to an adding command input from the user on the basis of the first device, displays a network configuration interface.

The adding command can be used for instructing network configuration for the first device to add the first device to the virtual domain of the first control device by way of the network configuration for the first device, i.e., to add the first device as the commissionee device of the first control device.

In the present application, the first control device does not directly add the first device as the commissionee device, but rather ensures the security of controlling the operation of the first device through a process of the network configuration for the first device. Thus, the first control device, in response to the adding command, displays a network configuration interface. The network configuration interface is used for the user to perform the network configuration operation on the first device.

S902, the first control device, in response to a network configuration

operation from the user, can send a network configuration request to the first device.

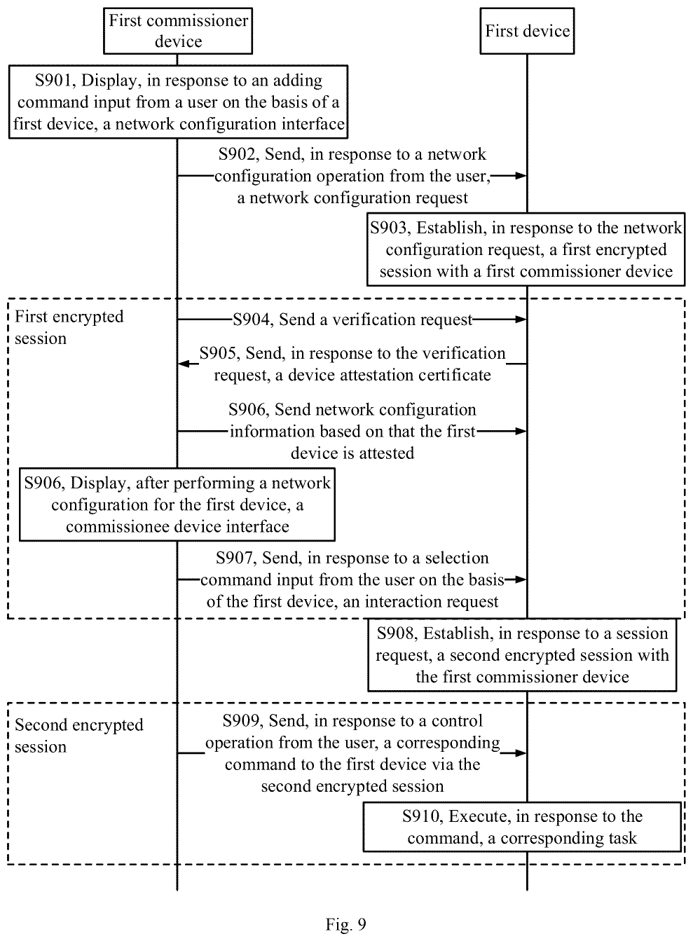

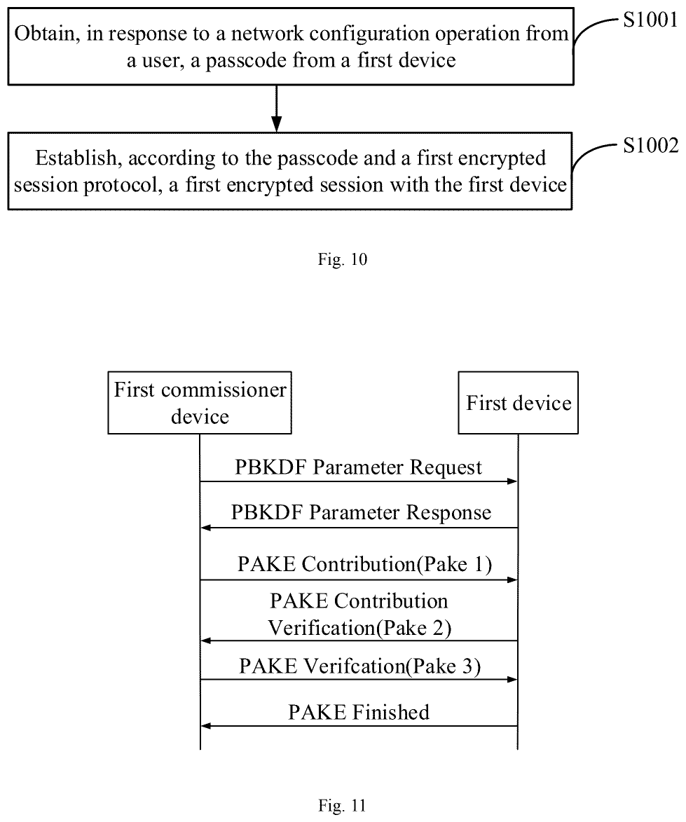

The user can perform a network configuration operation on the first device on the basis of the network configuration interface, and the first control device, in response to a network configuration request, can send the network configuration request to the first device to request establishment of a first encrypted session with the first device. The first control device may establish the first encrypted session with the first device in accordance with a process shown in FIG. 10, which may include the following.

S1001, in response to the network configuration operation from the user, a passcode is obtained from the first device.

The first device provides the passcode, which is used for establishing the encrypted session.

The network configuration interface may include a scanning box for a two-dimensional code, and the first device provides the passcode in a form of the two-dimensional code. The network configuration operation from the user is to place the two-dimensional code provided by the first device within a scanning range of the scanning box in order to identify the passcode in the two-dimensional code by the first control device.

The network configuration interface may include an input box for a pairing code, and the first device provides the passcode in a form of the pairing code. The network configuration operation from the user is to input the pairing code provided by the first device into the input box so as to obtain the passcode provided by the first device. The passcode provided by the first device may be the pairing code, or may be the passcode obtained by the first control device from the first device on the basis of the pairing code, e.g., the first control device may send a request containing the pairing code to the first device so as to request the passcode from the first device, and the first device receives the request, and, after identifying that the pairing code is correct, feeds the passcode back to the first control device.

The network configuration interface may include prompt information that prompts obtaining the passcode according to NFC communication, and the first device provides the passcode through the NFC technology. The network configuration operation from the user can be to place the first control device within a NFC transmission distance of the first device to establish NFC communication with the first device and to obtain the passcode on the basis of the NFC communication.

S1002, the first encrypted session is established with the first device according to the passcode and a first encrypted session protocol.

The first encrypted session protocol may be a Passcode-Authenticated Session Establishment (PASE) protocol, and the first control device may establish a PASE session with the first device according to the obtained passcode. In this PASE session, both the first control device and the first device encrypt sent data, as well as decrypt received data by using an encryption key generated according to the passcode and the PASE protocol. As a result, the security of the interaction can be effectively ensured.

The process of establishing the PASE session between the first control device and the first device is illustrated in conjunction with FIG. 11.

The PASE protocol is the process of establishing the encrypted session

between devices by sharing the passcode and using the Password-authenticated key agreement (PAKE) protocol. The two parties in the network configuration process are set to interact on the basis of a SPAKE2+ algorithm to generate the shared passcode with greater security strength for subsequent communication, wherein the SPAKE2+ algorithm is a type of the PAKE algorithm, is on the basis of an elliptic curve and belongs to an enhanced password-authenticated key exchange algorithm.

In some embodiments of the present application, the first control device can send a Password-Based Key Derivation Function (PBKDF) parameter (Param) request (Request) package to the first device, and the PBKDF Param Request package may include: a random (initiator Random) generated by the first control device, a session id, a passcode provided by the first device, and a Boolean value false. A code for the PBKDF Param Request package may be as follows:

PBKDFParamRequest=
{
initiatorRandom(1)=InitiatorRandom,
initiatorSessionId(2)=InitiatorSessionId,
passcodeID(3)=PasscodeId,
hasPBKDFParameters(4)=HasPBKDFParameters,
}
initiatorRandom[1]:OCTET STRING[length 32],
initiatorSessionId[2]:UNSIGNED INTEGER[range 16-bits],
passcodeId[3]: UNSIGNED INTEGER[length 16-bits],
hasPBKDFParameters[4]:BOOLEAN.

After receiving the PBKDF Param Request package sent from the first control device, the first device can determine whether the passcode is consistent/same with the passcode provided by itself. If not, an error code is fed back, and the process ends. If yes, a PBKDF Param Response message package is sent to the first control device, and the PBKDF Param Response message package may include a random (responderRandom) generated by the first device and a Responder session id. Based on that hasPBKDFParameters is false, the PBKDF Param Response message package may further include: salt and an iteration count. A code for the PBKDF Param Response message package may be as follows:

PBKDFParamResponse =
{
initiatorRandom(1)=PBKDFParamRequest.InitiatorRandom,
responderRandom(2)=ResponderRandom,
responderSessionId(3)= ResponderSessionId,
pbkdf_parameters(4)=PBKDFParameters,
}
initiatorRandom[1]:OCTET STRING[length 32],
responderRandom[2]:OCTET STRING[length 32],
responderSessionId[3]:UNSIGNED INTEGER[range 16-bits],
pbkdf_parameters [4]:Crypto_PBKDFParameterSet.

The first control device and the first device run a HASH-Secure Hash Algorithm (SHA) 256 based on the PBKDF Param Request package and the PBKDF Param Response message package to generate context variables. SHA256 can generate a 256-bit HASH value which can be referred to as a message digest for a message of any length.

The first control device and the first device call PBKDF-SHA256 on the basis of the passcode, salt, and iteration count as parameters to generate random numbers w₀ and w₁. The first device further needs to calculate a result of a scalar multiplication algorithm for the elliptic curve according to an equation (1):

$$L = P \times {w}_{1} . \qquad ( 1 )$$

Wherein L represents the result of the scalar multiplication algorithm for the elliptic curve, P represents a base point of the elliptic curve, and w₁ represents the random number.

The first control device can send a package (Pake) 1 to the first device on the basis of the PAKE protocol. The first control device can generate a random number x, compute and obtain a public key according to equation (2), and carry the public key in Pake1:

$$X = x \times P + {w}_{0} \times M . \qquad ( 2 )$$

Wherein x represents a random number, X is the public key, P represents a base point of the elliptic curve, w₀ represents a random number, and M is an additional point of the elliptic curve.

The first device can send a package Pake 2 to the first control device on the basis of the PAKE protocol. The first device can generate a random number y, compute and obtain the public key according to an equation (3):

$$Y = y \times P + {w}_{0} \times N . \qquad ( 3 )$$

Wherein Y represents the public key, y represents a random number, P represents a base point of the elliptic curve, w₀ represents a random number, and N is an additional point of the elliptic curve.

The first device can determine two intermediate parameters according to an equation (4) and an equation (5) respectively:

$$Z = h \times x \times ( Y - {w}_{0} \times N ) . \qquad ( 4 )$$

Wherein Z represents the first intermediate parameter.

$$V = h \times {w}_{1} \times ( Y - {w}_{0} \times N ) . \qquad ( 5 )$$

Wherein V represents the first intermediate parameter.

The first device can determine a K_main value by using the HASH-SHA256 algorithm on the basis of Z, V, context, X, Y, w₀, M and N. The first device derives a shared key ke and a set of confirmation keys kcv and kcp on the basis of a key derivation function HKDF of a Keyed-Hash Message Authentication Code (HMAC). The first device can use kcv as a key to perform a HASH-based MAC operation on the public key X sent from the first control device to generate a confirmation message cB. The first device can use both Y and cB as the content of Pake2.

The first control device can determine two intermediate parameters

according to an equation (6) and an equation (7) respectively:

$$Z = h \times y \times ( X - {w}_{0} \times M ) ; \qquad ( 6 )$$

$$V = h \times y \times L . \qquad ( 7 )$$

The first control device can determine a K_main value on the basis of the same method as the first device, as well as derive a shared key ke and a set of confirmation keys kcv and kcp. The first control device can perform an HMAC operation on the public key X with the key kcv to obtain a cB, and compare it with the cB sent from the first device. Based on that the two cBs agree, the first control device can perform an HMAC operation on the public key Y sent from the first device by using kcp to generate a confirmation message cA, and carry cA in Pake3.

After the first device receives Pake3, it also can perform an HMAC operation on the public key Y by using kcp to obtain a cA and compares it with the cA in Pake3. Based on that the two cAs agree, they pass the authentication.

The first device can send a Status Report (GeneralCode:Success) to the first control device to indicate that the interaction is successfully finished.

After the authentication by Pake3, the first control device and the first device call HKDF to derive I2RKey and R2IKey from the key. For the first control device, information is encrypted with I2RKey, and information is decrypted with R2IKey. For the first device, information is encrypted with R2IKey, and information is decrypted with I2RKey.

S903, the first device, in response to the network configuration request sent from the first control device, establishes a first encrypted session with the first control device, and stops providing the device discovery service to external device.

The first device, in response to the network configuration request sent from the first control device, establishes the first encrypted session with the first control device on the basis of a first encrypted session protocol, such as the PASE protocol, by using a passcode provided by the first device itself, and a process of data communication with the first control device on the basis of the first encrypted session may refer to step S902, which is not detailed here.

In some embodiments, the first device, after establishing the first encrypted session with the first control device, stops the device discovery service to external device(s). For example, termination of the device discovery service may be implemented by turning off the device discovery service, and when providing the device discovery service needs to be resumed, the device discovery service needs to be restarted. For example, a Linux firewall mechanism may also be used, and on the basis of keeping the device discovery service turned on, only a port on which the device discovery service communicates with the outside environment is blocked, so that the port cannot receive a message request sent from an external device, thus realizing the effect of stopping the device discovery service. When the device discovery service outward needs to be resumed, only the blocking of the port needs to be turned off, and the device discovery service does not need to be restarted.

On the basis that the first device stopping providing the device discovery service to external device after establishing the first encrypted session with the first control device, the first device does not receive message requests from other control devices when it is controlled by the first control device,

thus effectively avoiding interference generated by other control devices to the first control device.

It is also on the basis that the first device stops providing the device discovery service to external devices after establishing the first encrypted session with the first control device, and as long as the first device maintains the first encrypted session with the first control device, the first device cannot communicate with other control devices. Based on that the first control device does not perform network configuration on the first device, this will result in that network configurations always cannot be performed on the first device by other control devices, i.e., the first device cannot be controlled by other control devices. In view of this issue, the first device may set a timeout period for the first encrypted session after establishing the first encrypted session with the first control device. The first device can terminate, based on that a verification request sent from the first control device is not received within the timeout period, the first encrypted session to allow control by other control devices.

S904, the first control device sends a verification request to the first device via the first encrypted session.

The verification request can be used for requesting a device attestation certificate of the first device.

S905, the first device, in response to the verification request sent from the first control device via the first encrypted session, sends the device attestation certificate to the first control device via the first encrypted session.

S906, the first control device, based on that the first device is determined to be authenticated according to the device attestation certificate, sends the network configuration information to the first device through the first encrypted session, and, after the network configuration for the first device, displays the commissionee device interface.

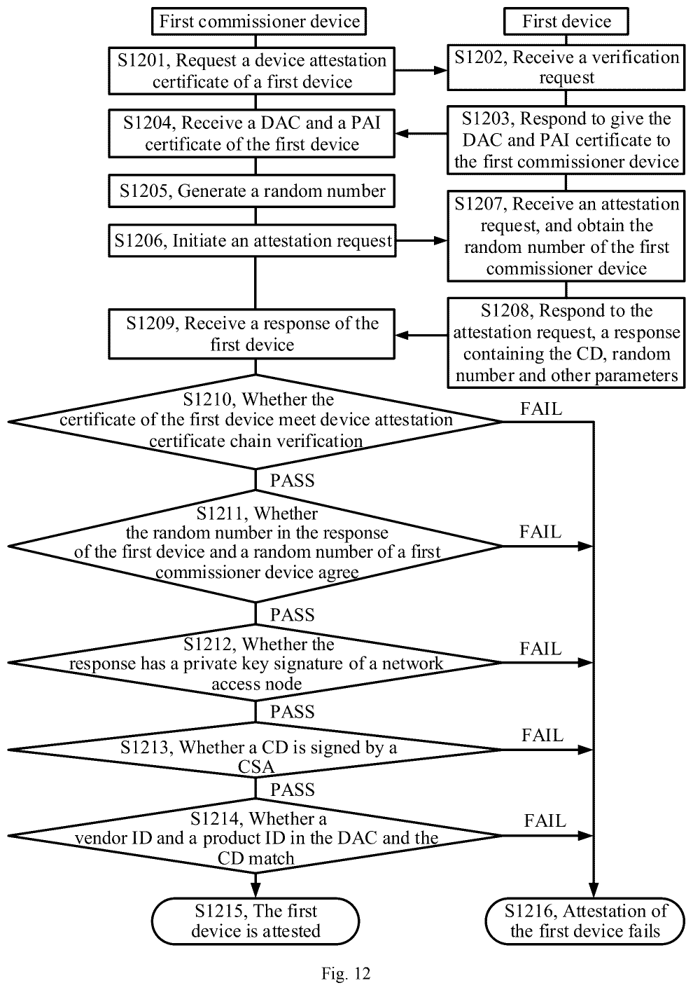

The first control device may interact with the first device to verify the device attestation certificate of the first device in accordance with a process shown in FIG. 12, and the specific process can be as follows.

The Matter protocol is an Internet of Things protocol, devices that can be added to the Internet of Things are required to support this protocol, and devices connected on the basis of the Matter protocol may be called Matter devices. When leaving a factory, each Matter device is assigned a unique Device Attestation Certificate (DAC). The DAC is issued by a Product Attestation Intermediate (PAI) certificate, which is held by a device vendor. The PAI certificate is issued by a Product Attestation Authority (PAA) certificate, and all trusted PAA certificates are stored in a Distributed Compliance Ledger (DCL) provided by a Connectivity Standards Alliance (CSA). A certificate chain may be formed on the basis of the above certificate issuance relationship, i.e., PAA certificate→PAI certificate→DAC certificate. The DAC and the PAI certificate are burned into devices during production and stored permanently.

Through the first encrypted session, the following steps can be executed. S1201, the first control device sends an attestation request to the first device to request the device attestation certificate of the first device. S1202, the first device receives the attestation request. S1203, the first device, in response to the attestation request, sends the DAC and the PAI certificate to the first control device. S1204, the first control device receives the DAC and the PAI certificate. S1205, the first control device generates a first random number. S1206, the first control device sends an attestation request to the first device, the attestation request carrying the first random number. S1207, the first device, after receiving the attestation request, obtains the first random number carried in the attestation request. S1208, the first device, in response to the attestation request, generates CD and a

second random number, and sends the CD and the second random number to the first control device. S1209, the first control device receives a response from the first device. S1210, the first control device verifies whether the DAC and the PAI certificate of the first device meet the device attestation certificate chain, i.e., obtains the issuer, i.e., the PAA certificate, of the DAC and the PAI certificate on the basis of the certificate chain, and verifies whether the PAA certificate is trusted. S1211, the first control device, based on that the DAC and the PAI certificate meet the device attestation certificate chain, verifies whether the second random number and the first random number agree. S1212, the first control device, based on that the second random number and the first random number agree, verifies whether there is a private key signature of a network access node. S1213, the first control device, based on that there is the private key signature of the network access node, verifies whether the CD is signed by the CSA. S1214, the first control device, based on that the CD is signed by the CSA, verifies whether a vendor ID and a product ID in the DAC and the CD certificate match. S1215, if yes, the first device is attested. In all the above verification processes, whenever a process of verification failure occurs, S1216, the verification for the first device fails.

The first control device can perform product attestation on the first device according to the device attestation certificate of the first device, based on that the first device is attested, it indicates that the first device is a legal device and is subjected to product attestation, and the first control device may choose to control the first device. Based on that the first device is not attested, e.g., the device attestation certificate is not attested, or the device attestation certificate is not sent to the first control device, it indicates that the first device is not legal or is subjected to no product attestation, and there is a risk for the first control device to control the first device.

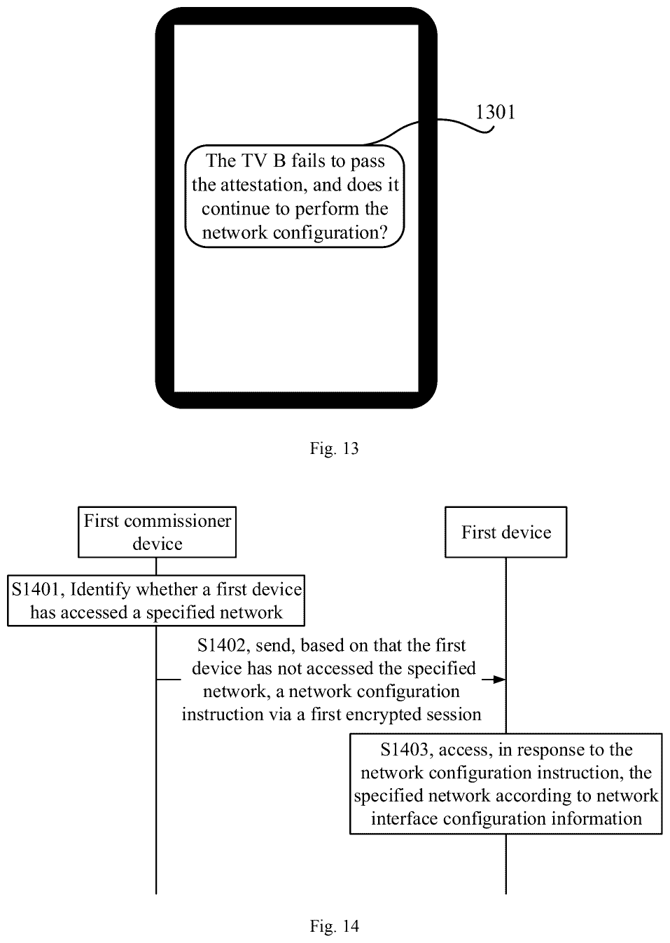

In some embodiments, based on that the first device is not attested, the first control device may display prompt information to prompt the user that the first device is not attested and ask the user whether to continue the network configuration for the first device. This prompt information may be presented as a pop-up window, voice, and other modes. Taking the first control device as a cell phone as an example, and taking the first device as a TV B as an example, when the TV B fails to pass attestation of the cell phone, the cell phone may display a pop-up window 1301 as shown in FIG. 13, and in the pop-up window 1301, it displays prompt information “The TV B fails to pass the attestation, and do you want to continue to perform the network configuration?”. Based on that the user inputs an instruction for continuing the network configuration on the basis of the prompt information, the first control device will continue the network configuration for the first device. Based on that the user inputs an instruction for discontinuing the network configuration on the basis of the prompt information, the first control device will end the process of the network configuration for the first device.

When the first device is attested, the first control device can send network configuration information to the first device. The network configuration information may include a NOC assigned by the first control device to the first device, and the NOC represents the first device being added to the virtual domain of the first control device, i.e., the first control device finishes the network configuration for the first device. The NOC of the first device may include a Fabric ID of the virtual domain of the first control device, and a Node ID of the first device in the virtual domain.

The purpose of the first control device to perform the network configuration

for the first device is to add the first device to its own virtual domain for subsequent control for the first device. A network basis on which the first control device may control the first device is that both the first control device and the first device access a specified network, such as a wireless local area network. Thus, to ensure that the first control device can perform control for the first device added to the virtual domain, the first control device may ensure that the first device accesses the specified network in accordance with a process shown in FIG. 14, which may include the following.

S1401, the first control device determines whether the first device has accessed the specified network.

The specified network can be a wireless local area network accessed by the first control device.

The first control device may determine whether the first device has accessed the specified network on the basis of the process of discovering the first device in step S702. Based on that the first control device discovers the first device on the specified network, the first device has accessed the specified network. Based on that the first control device discovers the first device on the Bluetooth network, the first device has not accessed the specified network.

S1402, the first control device, based on that the first device has not accessed the specified network, sends a network configuration instruction to the first device via the first encrypted session.

The network configuration instruction can be used for instructing the first device to access the specified network according to the network interface configuration information.

Accordingly, the network configuration information sent from the first control device to the first device may further include, in addition to the NOC assigned to the first device, the network interface configuration information that is used by the first device to access the wireless local area network that the first control device has accessed. The network interface configuration information may include: a Service Set Identifier (SSID) and a network password (password) for the wireless local area network.

S1403, the first device, in response to the network configuration instruction sent from the first control device through the first encrypted session, accesses the specified network according to the network interface configuration information.

After the first device accesses the specified network, the first control device may send a command to the first device on the basis of the specified network to realize the control for the first device.

In some embodiments, the network configuration information may further include Coordinated Universal Time (UTC), and the first device adjusts its own time on the basis of the UTC to synchronize the time of the first control device with the time of the first device.

After performing the network configuration for the first device, the first control device acting as a commissioner displays a commissionee device interface.

In some embodiments, the first control device acting as a commissioner device may directly and automatically display the commissionee device interface after performing the network configuration for the first device. In some embodiments, the first control device and the first commissioner device can be used interchangably.

In some embodiments, the first commissioner device may display prompt

information to prompt the user to finish the network configuration after performing the network configuration for the first device. The first control device may further display a shortcut button that is used for jumping to the display of the commissionee device interface.

In some embodiments, the first commissioner device may display a main page of a control App after performing the network configuration for the first device, and the main page may include an entry to the commissionee device interface. The user may input a display command to the first commissioner device on the basis of the entry to instruct the first commissioner device to display the commissionee device interface.

The commissionee device interface may include all commissionee devices (i.e., commissionee devices that have been added to the virtual domain of the first commissioner device) that are controlled by the first commissioner device, and these commissionee devices may include the first device. The user may quickly and accurately grasp the commissionee devices that can be controlled by the first commissioner device on the basis of this commissionee device interface, as well as select a commissionee device to be controlled.

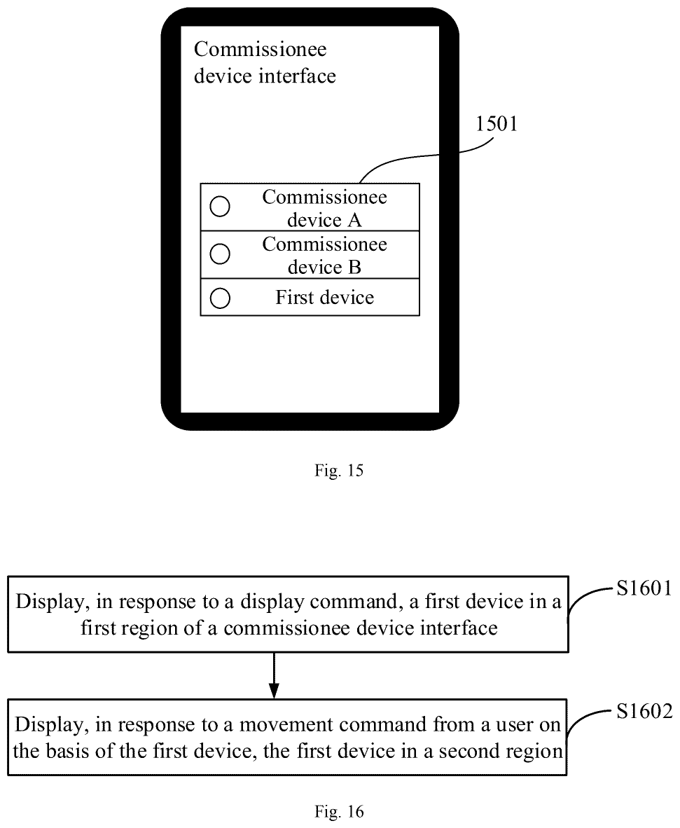

In some embodiments, each commissionee device may be presented in the commissionee device interface in a form of a commissionee device list. Reference may be made to the commissionee device interface shown in FIG. 15, the commissionee device interface may include the commissionee device list 1501, and from the commissionee device list 1501, the commissionee devices under the first commissioner device may include a commissionee device A, a commissionee device B, and the first device.

In some embodiments, all the commissionee devices may be displayed in different regions in the commissionee device interface. The commissionee device interface may include a first region and a second region, wherein the first region is a region where a category to which the commissionee device belongs is undefined, i.e., the commissionee device displayed in the first region has not yet been defined in the category to which it belongs, and the second region is a region where a category to which the commissionee device belongs is defined, i.e., the commissionee device displayed in the second region has been defined in the category to which it belongs. The number of the second region is at least one, wherein each second region corresponds to a category to which the commissionee device belongs, and different second regions correspond to different categories. The user may add a new category to which the commissionee device belongs in a customizing mode so as to add a new second area to the commissionee device interface. The categories to which the commissionee devices belong may include: type of device, region in a room, etc.

Each commissionee device may be displayed in the commissionee device interface in a form of an icon item, which may include an icon and name of the commissionee device, the icon can be used for visualizing the device category to which the device belongs or a corresponding physical object, and the name is used for identifying the device in a form of text. The icon and the name are both editable, i.e. the user may edit the icon item to the icon and name he/she wants.

When the first commissioner device displays the commissionee devices in the commissionee device interface in different regions, the first commissioner device may adjust the position of the first device in the commissionee device interface in accordance with a process shown in FIG. 16, which may include the following.

S1601, the first device is displayed in the first region of the commissionee

device interface. A commissionee device, e.g., the first device, newly added to the first commissioner device is by default displayed first in the first region.

S1602, in response to a movement command from the user on the basis of the first device, the first device is moved into the second region for display.

The user may move the icon item of the first device into the second region for display, which is a category corresponding to the category to which the first device belongs.

S907, the first commissioner device, in response to a selection command input from the user on the basis of the first device, sends an interaction request to the first device via the first encrypted session.

The selection command can be used for instructing the first commissioner device to establish a session with the first device, and the session can be used for transmitting a command to begin control for the first device.

The interaction request is used for requesting an establishment of a second encrypted session with the first device, and the second encrypted session is established on the basis of NOCs held by the first commissioner device and the first device respectively. The first commissioner device establishes the second encrypted session with the first device according to the held NOC and a second encrypted session protocol, the second encrypted session protocol may be a Sigma protocol, and in the established (Certificate-Authenticated Session Establishment, CASE) session, the first commissioner device and the first device may generate a key pair I2RKey and R2IKey for encryption and decryption according to the held NOCs and CASE protocols, and use the key pair to encrypt sent data and decrypt received data. As a result, the security of the interaction may be effectively ensured.

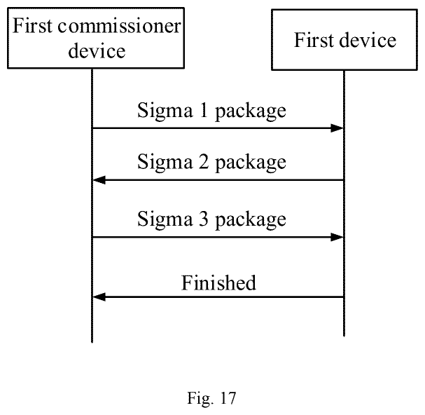

A process of establishing the CASE session between the first commissioner device and the first device is illustrated in conjunction with FIG. 17.

The first commissioner device first can generate the key pair, a random number, and a session identifier (e.g., session ID), and then packages the random number, a session ID, a Fabric ID, a Node ID, and a public key in the key pair into a Sigma 1 package on the basis of the Sigma protocol and can send the Sigma 1 package to the first device. After receiving the message, the first device extracts a root public key, the Fabric ID, the Node ID plus a random number sent from the first commissioner device, traverses information of each Fabric recorded by the first device, and verifies the Node ID. The first device can generate a random number, a session ID, and a key pair. The random number, the session ID, and a public key in the key pair are then packaged into a Sigma 2 package, and the Sigma 2 package is sent to the first commissioner device. The first commissioner device packages a generated NOC and public key, and the public key of the first device into a Sigma 3 package, and can send the Sigma 3 package to the first device. The first device parses the NOC, obtains the Fabric ID and the Node ID in the certificate, and can perform match verification on them with the Fabric ID and Node ID obtained from the Sigma 1 package. Based on that the match is successful, they pass the verification. Based on that the match fails, the verification fails. At the end of the verification, the first device feeds a verification finished message back to the first commissioner device.

S908, the first device, in response to a session request sent from the first commissioner device via the first encrypted session, establishes a second encrypted session with the first commissioner device.

After accessing the specified network, the first device has a basis for

wireless network communication with the first commissioner device. The process of establishing the second encrypted session between the first device and the first commissioner device and communication using the second encrypted session may refer to step S907 and will omit here.

S909, the first commissioner device, in response to a control operation from the user, sends a corresponding command to the first device via the second encrypted session.

The command may be an instruction for controlling the first device to perform a corresponding operation. Taking the first device as a smart door lock as an example, the command may be an inside-lock instruction, an unlock instruction, an alarm instruction, etc.

The first commissioner device may further send data to the first device via the second encrypted session, at which time the command may be a screen cast instruction, a mirroring instruction, etc., to instruct the first device to display the received data.

S910, the first device, in response to the command sent from the first commissioner device via the second encrypted session, executes a corresponding task.

The first device, after executing the corresponding task, feeds back an execution result to the first commissioner device.

On the basis of the control process between the first commissioner device and the first device, the first commissioner device, before controlling the first device, first can perform product attestation on the first device to ensure the legitimacy of the first device that is added to the virtual domain, and thus ensures the security of itself as well as other commissionee devices in the virtual domain. As well, the first commissioner device and the first device ensure the security of the control process through the second encrypted session. Moreover, the first device may stop providing the device discovery service to external device to effectively prevent other control devices from interfering with the control process of the first commissioner device.

The control process between the first commissioner device and the first device is discussed in conjunction with the following examples.

The first commissioner device being a cell phone A, and the first device being the first type of commissionee device 100, such as a smart door lock, are taken as an example.

A control application supported by the smart door lock is installed on the cell phone A. The cell phone A has accessed a wireless local area network A, an SSID of which is “AAA”, a password is “123456789”, and the cell phone A has a Bluetooth function turned on. The cell phone A, in response to a first display command from the user, searches for the smart door lock according to a Bluetooth network, and after finding the smart door lock, displays a device adding interface as shown in \textcircled{1} in FIG. 18, and the device adding interface may include an item 1801 of the smart door lock. The user inputs an adding command on the basis of the item 1801, and the cell phone A, in response to the adding command, displays a network configuration interface as shown in \textcircled{2} in FIG. 18, and the network configuration interface may include a scanning box 1802. The user scans a two-dimensional code on the smart door lock through this scanning frame 1802 to obtain a passcode provided by the smart door lock, such as “5894”. The cell phone A can send a network configuration request to the smart door lock to request an establishment of a first encrypted session with the smart door lock. After the smart

door lock agrees to the network configuration request of the cell phone A, the cell phone A and the smart door lock establish a PASE session according to “5894” and a PASE protocol. The smart door lock, after establishing the PASE session, discontinues providing a device discovery service outward to avoid being discovered by other devices. On the basis of the PASE session, the cell phone A can send a verification request to the smart door lock, the smart door lock, in response to the verification request, feeds back a device attestation certificate to the cell phone A, and the cell phone A can perform product attestation on the smart door lock according to the device attestation certificate. After the smart door lock is attested, the cell phone A adds the smart door lock to a virtual domain to which it belongs and assigns a NOC to the smart door lock. As shown in \textcircled{3} in FIG. 18, Fabric 1 of the cell phone A may include the cell phone A and the smart door lock. The NOC held by the cell phone A may include a Fabric ID: 1 of Fabric 1, and a Node ID: 1 of the cell phone A in Fabric 1. The NOC held by the smart door lock may include a Fabric ID: 1 of Fabric 1, and a Node ID: 2 of the smart door lock in Fabric 1. After the user inputs the display command, the cell phone A will display a commissionee device interface as shown in \textcircled{4} in FIG. 18, and the commissionee device interface may include an icon item of the smart door lock. Based on that a display region of the commissionee device in the commissionee device interface is divided according to a region of the commissionee device in a house, the commissionee device interface may include an undefined region 1803, a living room region 1804, and a bedroom region 1805 as shown in \textcircled{4} in FIG. 18. In this case, the icon item of the smart door lock is displayed by default in the undefined region 1803. Based on that the cell phone A further has other commissionee devices, such as a washing machine and a light, an icon item of the washing machine may be displayed in the living room region 1804, and an icon item of the light may be displayed in the bedroom region 1805. As shown in \textcircled{4} in FIG. 18, the icon item of the smart door lock may include an icon and a name, the icon may visualize the smart door lock, and the name is “door lock”, so as to represent the smart door lock in a form of text. The user may manually edit the icon and the name of the smart door lock. Based on that the user inputs a movement command on the basis of the icon item of the smart door lock, such as by long-pressing the icon item of the smart door lock and dragging it to the living room region 1804, the cell phone A will, in response to a movement command, display the icon item of the smart door lock in the living room region 1804, as shown in \textcircled{5} in FIG. 18. Since the smart door lock does not access the wireless local area network A, the network configuration information sent from the cell phone A to the smart door lock may further include network interface configuration information such as: SSID: AAA, the password: 123456789, and a network configuration instruction. The smart door lock, in response to the network configuration instruction, accesses the wireless local area network A according to the network interface configuration information. Based on that the user inputs a selection command on the basis of the icon item displaying the smart door lock, the cell phone A, in response to the selection command, can send an interaction request to the smart door lock to request an establishment of a second encrypted session with the smart door lock. After the smart door lock agrees to the interaction request, the cell phone A and the smart door lock establish a CASE session on the basis of the NOC held by each of them and a CASE protocol. On the basis of the CASE session, the cell phone A may send a command to the smart door lock. For example, the user inputs an inside-lock instruction, the cell phone A can send the inside-lock
instruction to the smart door lock, and the smart door lock, in response to the inside-lock instruction, is locked inside.

The first commissioner device being a cell phone A, and the first device being the second type of commissionee device 200, such as a TV, are taken as an example.

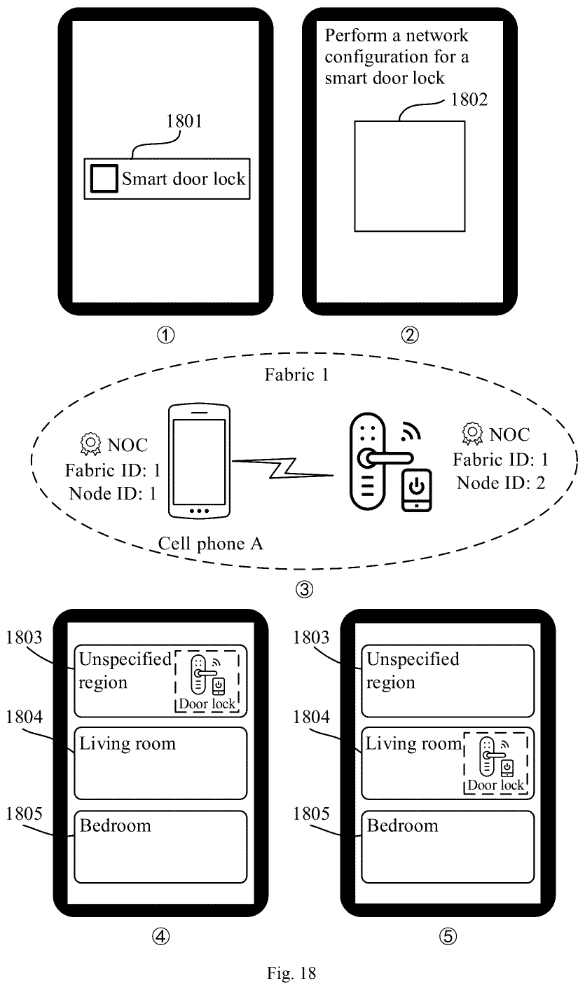

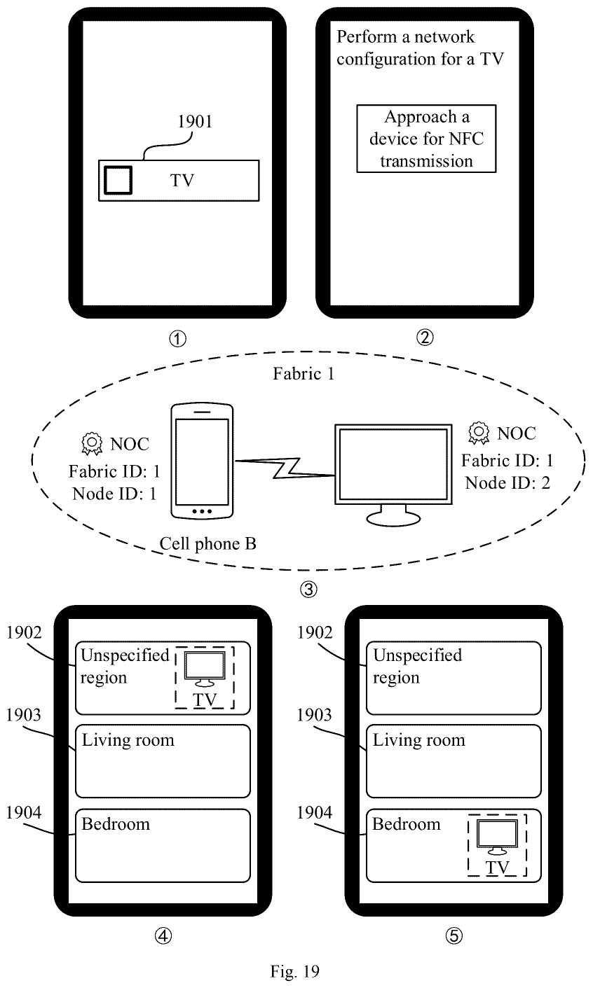

A control application supported by the TV is installed on the cell phone A. Both the cell phone A and the TV have accessed the wireless local area network A. The cell phone A, in response to a first display command from a user, searches for the TV on the wireless local area network A, and after finding the TV, displays a device adding interface as shown in \textcircled{1} in FIG. 19, and the device adding interface may include an item 1901 of the TV. The user inputs an adding command on the basis of the item 1901, the cell phone A, in response to the adding command, displays a network configuration interface as shown in \textcircled{2} in FIG. 19, and the network configuration interface may include prompt information “Approach the device for NFC transmission”. The user moves the cell phone A to be within a NFC communication distance of the TV, and to communicate with the TV over NFC to obtain a passcode provided by the TV, such as “1111”. The cell phone A can send a network configuration request to the TV to request an establishment of a first encrypted session with the TV. After the TV agrees to the network configuration request of the cell phone A, the cell phone A and the TV establish a PASE session according to “1111” and a PASE protocol. The TV, after establishing the PASE session, discontinues providing a device discovery service outward to avoid being discovered by other devices. On the basis of the PASE session, the cell phone A can send a verification request to the TV, the TV feeds back a device attestation certificate to the cell phone A in response to the verification request, and the cell phone A can perform product attestation on the TV according to the device attestation certificate. After the TV is attested, the cell phone A adds the TV to a virtual domain to which it belongs and assigns a NOC to the TV. As shown in \textcircled{3} in FIG. 19, Fabric 1 of the cell phone A may include the cell phone A and the TV. The NOC held by the cell phone A may include a Fabric ID: 1 of Fabric 1, and a Node ID: 1 of the cell phone A in Fabric 1. The NOC held by the TV may include a Fabric ID: 1 of Fabric 1, and a Node ID: 1 of the TV in Fabric 1. After the user inputs the display command, the cell phone A will display a commissionee device interface as shown in \textcircled{4} in FIG. 19, and the commissionee device interface may include an icon item of the TV. A region division of the commissionee device interface may refer to the above example(s) and will not be repeated here. The commissionee device interface may include the undefined region 1902, the living room region 1903, and the bedroom region 1904 as shown in \textcircled{4} in FIG. 19. At this time, the icon item of the TV is displayed in the undefined region 1902. Based on that the user inputs a movement command on the basis of the icon item of the TV, such as by long-pressing the icon item of the TV and dragging it to the bedroom region 1904, the cell phone A will, in response to the movement command, display the icon item of the TV in the bedroom region 1904, as shown in \textcircled{5} in FIG. 19. Based on that the user inputs a selection command on the basis of the icon item displaying the TV, the cell phone A, in response to the selection command, can send an interaction request to the TV to request an establishment of a second encrypted session with the TV. After the TV agrees to the interaction request, the cell phone A and the TV establish a CASE session on the basis of the NOC held by each of them and a CASE protocol. On the basis of the CASE session, the cell phone A may send a command to the TV. For example, the user inputs a channel cut instruction, the cell phone A can

send the channel cut instruction to the TV, and the TV switches channels in response to the channel cut instruction.

In some embodiments, control privilege information of each control device is stored in the commissionee device, and may include: a Fabric ID of a virtual domain of the control device, a Node ID of the control device in the virtual domain, and a control privilege that the control device has over the commissionee device. As a result, the control privilege information corresponds uniquely to the control device.

Privileges of the control the device may mainly include: View, Operate, Manage, and Administer. Based on that the control device has the View privilege, a TV information state (such as currently played application or video information) may be read or subscribed to, but cannot be modified or controlled. Based on that the control device has the Operate privilege, in addition to having the View privilege, it also has privileges to be able to write operation data and invoke an operation command. Based on that the control device has the Manage privilege, in addition to having the Operate privilege, it also has a privilege to modify basic settings of a TV device, e.g., a sound, an image mode, and other TV device settings. Based on that the control device has the Administer privilege, in addition to having the Manage privilege, it also has a privilege to modify a connected device, and a privilege to set and modify a TV parental lock.

On the basis of the above examples, the first commissioner device has the Administer privilege of the first device, and the privileges of the first commissioner device are stored in the first device. The Fabric ID of Fabric 1 of the first commissioner device being 1, and the Node ID in Fabric 1 being 1 are taken as an example. The first device may record the privileges of the first commissioner device in a device privilege management module as {Fabric Index: 1; Privilege: Administer; subjects: [device_node_id_1]}.

Based on that a second device (i.e., a second control device) appears and wants to control the first device, the first commissioner device and the first device may manage the second control device in accordance with an interaction process shown in FIG. 20, which may include the following.

S2001, the first commissioner device, in response to a service turn-on command input from the user, sends a first instruction to the first device via the second encrypted session.

The second control device establishes communication with the first commissioner device to send a control request for the first device to the first commissioner device, and based on that the user agrees to the control request, the service turn-on command is input. The first instruction is used for instructing the first device to resume providing the device discovery service outward.

The first device, after establishing the first encrypted session with the first commissioner device, discontinues providing the device discovery service outward to avoid interference generated by other control devices to the control for the first commissioner device. After the appearance of the second control device that is allowed to control the first device, the user may control the first device to resume providing the device discovery service outward through the first commissioner device so as to enable the first device to be discovered by the second control device and be added to a virtual domain of the second control device to be controlled by the second control device.

S2002, the first device, in response to the first instruction sent from the first

commissioner device via the second encrypted session, resumes providing the device discovery service to external device.

The first device may set a timeout period for outward providing time of the device discovery service, and based on that a network configuration request of the second control device is not received within the timeout period, automatically discontinue providing the device discovery service outward. Moreover, based on that the first device establishes the first encrypted session with the second control device, the first device automatically discontinues providing the device discovery service outward. The process in which the second control device adds the first device to a virtual domain to which it belongs may refer to the control process of the first commissioner device and the first device in the above example(s), which is not repeated here.

After the first device is added to the virtual domain of the second control device, the first device can send an adding result to the first commissioner device. The first device, after being added to the virtual domain of the second control device, sets a default privilege for the second control device, which is other than the Administer privilege, and records control privilege information of the second control device. A Fabric ID of Fabric 2 of the second control device being 2, a Node ID in Fabric 2 being 0, and a default privilege being an Operate privilege are taken as an example. The first device may record the privileges of the second control device in the device privilege management module as {Fabric Index: 2; Privilege: Operate; subjects: [device_node_id0]}.

S2003, the first commissioner device, in response to a second display command input from the user, displays a control privilege management interface.

The first commissioner device, on the basis of an adding result sent from the first device, may display the control privilege management interface, wherein based on that the first device has been added to the virtual domain of the second control device, the control privilege management interface will be capable of including privileges available to the second control device to control the first device, such as a View privilege, an Operate privilege, a Manage privilege, and an Administer privilege.

S2004, the first commissioner device, in response to a privilege management command input from the user on the basis of the privilege management interface, sends a second instruction to the first device via the second encrypted session.

The user, on the basis of the control privilege management interface, turns off a current privilege of the second control device, and turns on a privilege set for the second control device so as to input the privilege management command. The second instruction is used for instructing the first device to set the privilege instructed by the privilege management command for the second device.

S2005, the first device, in response to the second instruction sent from the first commissioner device via the second encrypted session, sets the control privilege indicated by the second instruction for the second control device.

The first device, in response to the second instruction, modifies the control privilege of the second control device through the device privilege management module.

The first device, when being added to virtual domains of a plurality of

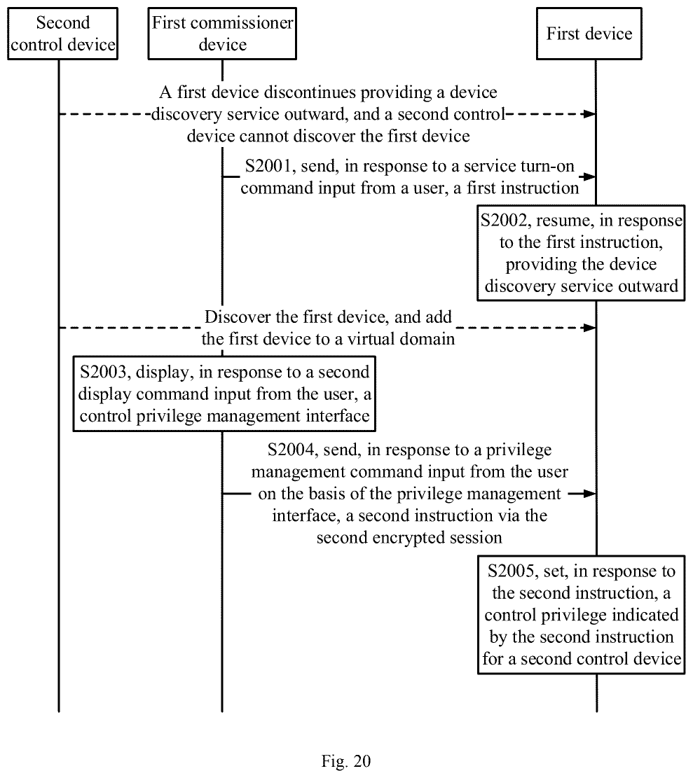

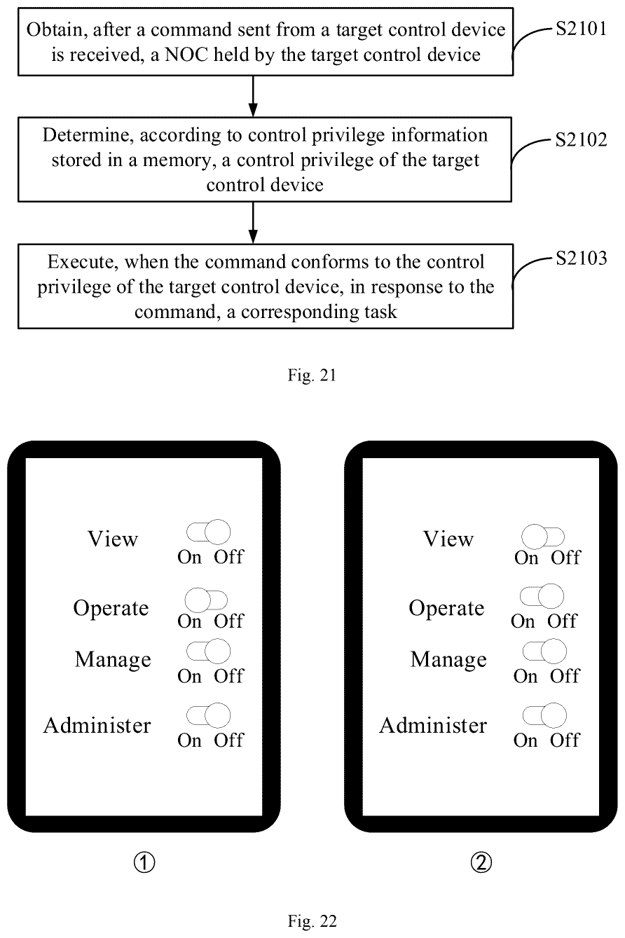

control devices simultaneously, may respond to a command in accordance with a process shown in FIG. 21, which may include the following.

S2101, after the command sent from a target control device via the second encrypted session is received, a NOC held by the target control device is obtained.

The command can be an instruction encrypted by the target control device by using the NOC, so that the first device may obtain the NOC of the target control device after decrypting the instruction. The NOC held by the target control device may include a target Fabric ID and a target Node ID, the target Fabric ID is used for uniquely identifying a virtual domain of the target control device, and the target Node ID is used for uniquely identifying the target control device in the virtual domain of the target control device.

S2102, a control privilege of the target control device is determined according to control privilege information stored in a memory.

The target Fabric ID and the target Node ID are compared with the Fabric ID and the Node ID of the respective control privilege information so as to determine control privilege information that contains the target Fabric ID and the target Node ID, and a control privilege in the control privilege information is the control privilege of the target control device.

S2103, when the command conforms to the control privilege of the target control device, in response to the command, a corresponding task is executed.

The first device can determine whether the received command conforms to the control privilege of the target control device, and if yes, the first device responds to the command and executes the corresponding task. Based on that the control privilege of the target control device is exceeded, the command is not responded to.

On the basis of the control process among the first commissioner device, the second control device, and the first device, when the first commissioner device can control the first device, based on that the second control device wants to control the first device, the first commissioner device may cause the second control device to add the first device to the virtual domain by instructing the first device to resume providing the device discovery service outward. Moreover, the first commissioner device may configure the second control device with a privilege to control the first device so as to manage and control the second control device.

The control process among the first commissioner device, the second control device, and the first device is illustrated in conjunction with the following examples.

In some embodiments, the second control device being a cell phone B is taken as an example. On the basis of the above example(s), the cell phone A has the Administer privilege to the TV, and the device privilege management module of the TV stores the control privilege information of the cell phone A, such as: {Fabric Index: 1; Privilege: Administer; subjects: [device_node_id_1]}.

The control application supported by the TV is installed on the cell phone B. The cell phone B also has accessed the wireless local area network A. The cell phone B establishes communication with the cell phone A and can send a control request for the TV to the cell phone A. Based on that the user agrees to the request, a service turn-on command is input at the cell phone A. The cell phone A, in response to the service turn-on command, can send a first instruction to the TV, and the TV, in response to the first instruction,

resumes providing the device discovery service outward. The cell phone B searches for the TV on the wireless local area network A, and after finding the TV, may add the TV to a corresponding virtual domain. The process of adding the TV to the virtual domain by the cell phone B may refer to the process of adding the TV to the virtual domain by the cell phone A in the above example(s), and will not be repeated here. An NOC held by the cell phone B may include a Fabric ID: 2 of Fabric 2, and a Node ID: 0 of the cell phone B in Fabric 2. An NOC assigned to the TV by the cell phone B may include a Fabric ID: 2 of Fabric 2, and a Node ID: 1 of the TV in Fabric 2. After being added to the virtual domain of the cell phone B, the TV feeds back an adding result to the cell phone A. The TV configures default privileges for the cell phone B, such as an Operate privilege, and records control privilege information of the cell phone B, such as {Fabric Index: 2; Privilege: Operate; subjects: [device_node_id_0]}.

When managing privileges of the cell phone B to control the TV, the user may input a display command to the cell phone A. The cell phone A, in response to the display command, displays a privilege management interface which may include the privileges available to the cell phone B to control the TV. As shown in 0 in FIG. 22, the privilege management interface may include switches for a View privilege, an Operate privilege, a Manage privilege, and an Administer privilege, and when a privilege is turned on, the cell phone B can use the privilege. When the privilege is turned off, the cell phone B cannot use the privilege. The switches for the View privilege, the Manage privilege, and the Administer privilege are turned off, and the switch for the Operate privilege is turned on, indicating that the cell phone B currently has the Operate privilege. Taking the user of the cell phone A being a parent and the user of the cell phone B being a child as an example, the parent can not only set a parental lock for the TV through the cell phone A to restrict programs that the child can watch, but also the parent can set the privileges of the cell phone B through the cell phone A to restrict operations of the child on the TV. As shown in \textcircled{2} in FIG. 22, the parent turns off the switch for the Operate privilege and turns on the switch for the View privilege. The cell phone A can send a modification result to the TV in a form of a second instruction, the TV, in response to the second instruction, modifies the control privilege information of the cell phone B through the device privilege management module, and the modified privilege is: {Fabric Index: 2; Privilege: View; subjects: [device_node_id_0]}. At this time, the child can only control the TV to perform a task related to the View privilege through the cell phone B.

Taking the cell phone B having the View privilege as an example, based on that the child can send an instruction for modifying the parental lock of the TV through the cell phone B, the cell phone B will send a corresponding command to the TV to instruct a modification of the parental lock of the TV. After receiving the command, the TV obtains the NOC held by the cell phone B, and thus identifies the Fabric ID: 2 and the Node ID: 0. The TV may determine that the privilege of the cell phone B is the View privilege by comparing the stored control privilege information. The TV identifies that the command does not conform to the View privilege, does not respond to the command, and feeds back a corresponding error code so as to restrict the child from modifying the parental lock of the TV.

In the technical field of Internet of Things, the Matter protocol is an open

source standard for smart homes, and is developed, certified, and promoted by the Connectivity Standards Alliance. The Matter protocol is on the basis of the Internet Protocol (IP), and smart home devices, mobile applications and cloud services that follow the Matter protocol enable interconnection and communication. The primary control device may perform a network configuration on the commissionee device on the basis of the Matter protocol so as to add the commissionee device to a Matter network of the primary control device, i.e., a virtual domain. After the commissionee device is added to the virtual domain of the primary control device, the primary control device has control privileges of the commissionee device. The commissionee device in the virtual domain of the primary control device may also be referred to as a node device or a Node, etc.

The Matter protocol specifies supported events for each Matter device, which may include events related to a device state, such as a Start Up event and a Shut Down event. The Matter protocol requires that each Matter device must support the Start Up event, i.e., each Matter device must publish the Start Up event after it is started up. The Matter protocol specifies that it is optional for each Matter device to support the Shut Down event or not, i.e., each Matter device may send the Shut Down event when it is shut down, or it may not send the Shut Down event. Furthermore, the Matter protocol specifies that the primary control device needs to subscribe to an event before it can receive it. For example, the primary control device needs to subscribe to a Start Up event of the commissionee device before it can receive the Start Up event sent from the commissionee device. The primary control device manages the commissionee device according to the events sent from the commissionee device, e.g., the primary control device manages a device state of the commissionee device, such as an on-line state or an off-line state, according to the Start Up event and the Shut Down event sent from the commissionee device. At the same time, the primary control device does not differentiate between displaying special functions supported by the commissionee device, such as a remote network wake-on function.

On the basis of the Matter protocol, based on that the primary control device has not subscribed to the Start Up event of the commissionee device before the commissionee device can send the Start Up event, or based on that the primary control device is started up after the commissionee device can send the Start Up event, the primary control device will not be able to receive the Start Up event sent from the commissionee device, which will result in the primary control device being not able to accurately update the on-line state of the commissionee device. As well, based on that the commissionee device does not support the Shut Down event, the primary control device will not receive the Shut Down event sent from the commissionee device, resulting in the primary control device being not able to accurately update the off-line state of the commissionee device. Accordingly, based on that the primary control device does not accurately and timely update the device state of the commissionee device, the user cannot control the commissionee device on the basis of the device state of the commissionee device. Moreover, since the primary control device does not differentiate between displaying the special functions possessed by the commissionee devices, it makes it impossible for the user to determine the special functions supported by each commissionee device or to use these special functions quickly.

In some embodiments, the primary control device may obtain a passcode provided by the commissionee device by scanning a two-dimensional code provided by the commissionee device, according to an input pairing code, through NFC interaction with the commissionee device, and other modes, and

after discovering the commissionee device, can use the passcode to establish an encrypted session with the commissionee device, and can perform a network configuration for the commissionee device so as to add the commissionee device to its own virtual domain.

In some other embodiments, the primary control device may perform the network configuration for the commissionee device by a third-party device, such as a cell phone, and a tablet computer. For example, the third-party device can perform network configurations for the primary control device and the commissionee device respectively so as to add the primary control device and the commissionee device to a virtual domain of the third-party device, and then the third-party device can send each other's device information to the primary control device and the commissionee device, so as to record in the primary control device that it has control privileges for the commissionee device, and record in the commissionee device that the primary control device has the control privileges, thereby realizing the assignment of the control privileges to the commissionee device for the primary control device, and completing the network configuration for the commissionee device by the primary control device.

In the process of the primary control device performing the network configuration for the commissionee device, a NOC is assigned to the commissionee device, which may include a virtual domain identifier, such as a Fabric ID, of the virtual domain to which the commissionee device belongs, and a node identifier, such as a Node ID, of the commissionee device in the virtual domain. Devices (which may include the primary control device and the commissionee device) added to the same one virtual domain have the same Fabric ID to identify devices located in the same one virtual domain, and devices in the same one virtual domain (which may include the primary control device and the commissionee device) have different Node IDs to uniquely identify the corresponding devices in the virtual domain. The primary control device may obtain the device information of the commissionee device added to the virtual domain. The device information of the commissionee device may include a UUID of the device, a device name (Name), a Vendor Name of the device, a Node ID of the device, etc.

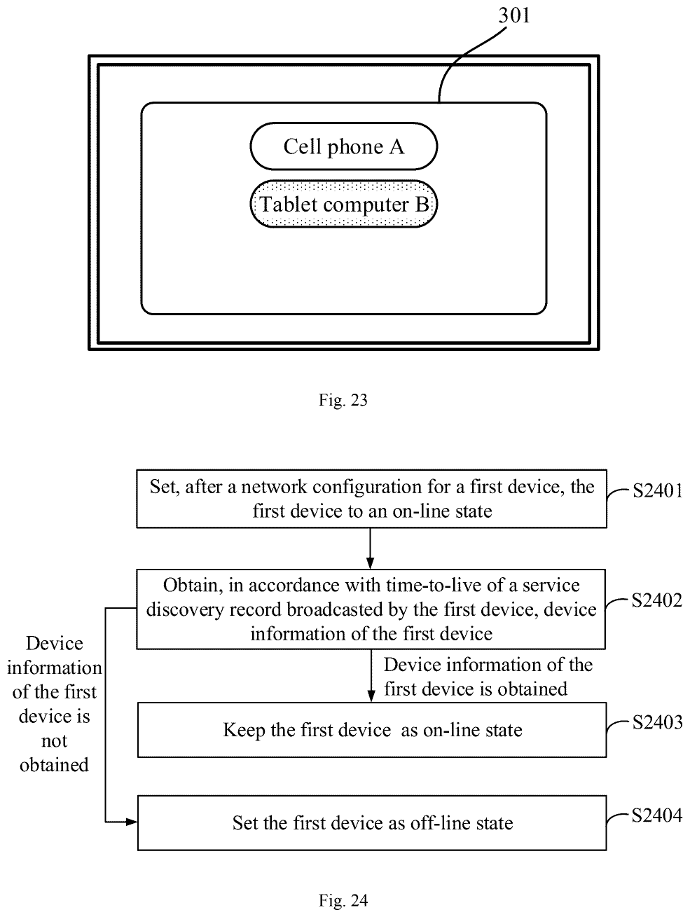

In some embodiments, based on that the primary control device is a display apparatus, the primary control device may be configured to have a function to display a commissionee device list. After performing the network configuration for the commissionee devices, the primary control device may display the commissionee device list to show the user the commissionee devices that have been added to the virtual domain. The commissionee device list may include an option for each commissionee device, as well as a device state of each commissionee device, such as an on-line state and an off-line state. The commissionee device in the on-line state may respond to a command of the primary control device to execute a corresponding task, and the commissionee device in the off-line state cannot respond to the command of the primary control device to execute the corresponding task. The primary control device being a TV and the commissionee devices being a cell phone A and a tablet computer B are taken as an example. After the TV can perform network configurations for the cell phone A and the tablet computer B, a commissionee device list 301 as shown in FIG. 23 may be displayed, and the commissionee device list 301 may include options for the cell phone A and the tablet computer B. Based on that cell phone A is in an on-line state and the tablet computer B is in an off-line state, the option for the cell phone A is shown as active, e.g. not grayed out, and the option for the tablet computer B is shown as grayed out. In

this way, the user can quickly determine that the TV currently can control the cell phone A and cannot control the tablet computer B on the basis of the commissionee device list 301.

The Matter protocol specifies supported events for each Matter device, which may include events related to a device state, such as a Start Up event and a Shut Down event. The Matter protocol requires that each Matter device must support the Start Up event, i.e., each Matter device must publish the Start Up event after it is started up. The Matter protocol specifies that it is optional for each Matter device to support the Shut Down event or not, i.e., each Matter device may send the Shut Down event when it is shut down, or it may not send the Shut Down event. Furthermore, the Matter protocol specifies that the primary control device needs to subscribe to an event before it can receive it. For example, the primary control device needs to subscribe to a Start Up event of the commissionee device before it can receive the Start Up event sent from the commissionee device. The primary control device manages the commissionee device according to the events sent from the commissionee device, e.g., the primary control device manages a device state of the commissionee device, such as an on-line state or an off-line state, according to the Start Up event and the Shut Down event sent from the commissionee device. At the same time, the primary control device does not differentiate between displaying special functions supported by the commissionee device, such as a remote wake-on (Wake On Lan) function.

On the basis of the Matter protocol, based on that the primary control device has not subscribed to the Start Up event of the commissionee device before the commissionee device can send the Start Up event, or based on that the primary control device is started up after the commissionee device can send the Start Up event, the primary control device will not be able to receive the Start Up event sent from the commissionee device, which will result in the primary control device being not able to accurately update the on-line state of the commissionee device. As well, based on that the commissionee device does not support the Shut Down event, the primary control device will not receive the Shut Down event sent from the commissionee device, resulting in the primary control device being not able to accurately update the off-line state of the commissionee device. Accordingly, based on that the primary control device does not accurately and timely update the device state of the commissionee device, the state of the commissionee device cannot be accurately and timely displayed in the commissionee device list, and thus the user cannot control the commissionee device on the basis of the device state of the commissionee device. Moreover, since the primary control device does not differentiate between displaying the special functions possessed by the commissionee devices, it makes it impossible for the user to determine the special functions supported by each commissionee device or to use these special functions quickly. Still taking the commissionee device list 301 shown in FIG. 23 as an example, based on that the TV does not accurately and timely update device states of the cell phone A and the tablet computer B, e.g., the cell phone A does not support a Shut Down event, and the TV has not subscribed to the Start Up event of the tablet computer B before the tablet computer B can send the Start Up event, the TV cannot obtain the Shut Down event of the cell phone A, and the Start Up event of the tablet B after the cell phone A is shut down and the tablet computer B is started up, and thus still displays the commissionee device list 301 as shown in FIG. 23, without being able to update the device state of the cell phone A to the off-line state and the device state of the tablet computer B to the on-line state. In this way, the user will mistakenly believe that the TV can still control the cell phone A and cannot control

the tablet computer B, resulting in an ineffective operation by the user. Moreover, on the basis of the commissionee device list 301 as shown in FIG. 23, the user cannot quickly determine whether the cell phone A and the tablet computer B support the remote wake-on function, and thus cannot wake up the cell phone A and the tablet computer B in a remote wake-on mode when the cell phone A and the tablet computer B are in the off-line state.

In view of the above issues, some embodiments of the present application provide a device management method for a commissionee device to ensure that the primary control device can accurately update the device state of each commissionee device in the virtual domain to which it belongs, as well as display the special functions supported by each commissionee device.

In some embodiments, the primary control device is always powered up, and, after the network configuration for the commissionee device, the primary control device may update the device state of the commissionee device in accordance with a process shown in FIG. 24, which may include the following.

S2401, the first device is set to an on-line state after the network configuration for the first device.

In some embodiments, “network configuration” means that a configuration device assigns a Fabric credential to a to-be-configured device so that the to-be-configured device becomes a node in the Fabric. A network configuration operation can comprises one or more steps as follows. Device discovery: the to-be-configured device needs to broadcast and provide network configuration information. When discovering a to-be-configured device on the network, the configuration device needs to parse out a passcode from the network configuration information for a next stage of PASE process. Secure channel establishment by using PASE (Passcode-Authenticated Session Establishment): the configuration device and the to-be-configured device will use PASE to establish an encryption key. Subsequent interactions between the two devices will be encrypted on the basis of the PASE key. Under the protection of PASE, the configuration device will obtain description information of the to-be-configured device, and obtain vendor information, product information, device matching type and other information. In this process, the configuration device will check the obtained information to verify the authenticity of the to-be-configured device and whether it is an attested MATTER device. The configuration device provides an operating certificate, a network interface configuration, and other information to the to-be-configured device so that the to-be-configured device may be configured. If the to-be-configured device has not accessed the IP network previously, the to-be-configured device will access the network by using configuration information of the configuration device. The configuration device can send a CSR (Certificate Signing Request) request to the to-be-configured device and obtains detailed CSR information. The to-be-configured device will create a unique operational key pair to be used in the subsequent CASE process. The configuration device can generate a node operational certificate through a domain manager device, passes the NOC to the to-be-configured device, and installs it. The configuration device and the to-be-configured device establish a CASE session on the basis of the CASE protocol by using the NOC, and subsequent requests and responses to operational instructions will be communicated under the encryption of the CASE session.

After the primary control device performs the network configuration for the

first device, the first device is added to the virtual domain of the primary control device as a commissionee device of the primary control device.

When the primary control device performs the network configuration for the first device, a NOC is assigned to the first device, which may include a Fabric ID of a virtual domain to which the primary control device belongs, and a Node ID of the first device in the virtual domain. The Fabric ID may be a compressed Fabric ID, and the compressed Fabric ID is usually a 64-bit ID. The primary control device may obtain device information of the first device, and the device information of the first device may include a Node ID, a Universally Unique Identifier (UUID), a device name (Name), a Vendor Name, etc. The device information of the first device may also include a device state (Power State) of the first device, such as an on-line state and an off-line state. The primary control device sets the device state of the first device to the on-line state by default after performing the network configuration for the first device.

The primary control device may store the device information of the first device in accordance with a specified data structure, such as storing the device information of the first device in accordance with the following data structure:

```
struct NodeInfo{
  UUID:string;
  Name:string;
  VendorName:string;
  Id:int;
  PowerState: bool;
}.
```

Where UUID, Name, and Vendor Name may all be described as strings, ID is used for describing the Node ID, and Power State may be represented by a Boolean value, where if true, it is the on-line state, and if false, it is the off-line state.

S2402, device information of the first device is obtained in accordance with time-to-live of a service discovery record broadcasted by the first device.

The Matter protocol specifies that the device discovery is operational (Operational Discovery). The first device, after being added to the virtual domain of the primary control device and after being started up, must publish the service discovery record through a Multicast Domain Name System (mDNS) service, such as a record with a Domain Name System Service Discovery (DNS-SD) format (hereafter referred to as a DNS-SD record).

The DNS-SD record may include a Time to Live (TTL) field that records a duration for which the DNS-SD record lives, and the first device updates the DNS-SD record in accordance with the Time to Live.

How long the Time to Live of the record is, on the other hand, indicates that the device must update its record regularly for the duration specified by TTL. If the first device is in the on-line state, the first device can update the DNS-SD record regularly; and if the first device is in the off-line state, the first device cannot update the DNS-SD record. The primary control device may determine the device state of

the first device in accordance with the Time to Live.

In some embodiments, the primary control device may be configured to identify whether the DNS-SD record updated by the first device is received in accordance with the Time to Live so as to determine the device state of the first device according to a reception result. The primary control device may determine that the first device is in the on-line state if it receives the DNS-SD record updated by the first device, and the primary control device may determine that the first device is in the off-line state if it does not receive the DNS-SD record updated by the first device.

In some other embodiments, the primary control device may be configured to obtain the device information of the first device in accordance with the Time to Live, such as reading a UUID of the first device so as to determine the device state of the first device according to an obtained result. For example, the primary control device may create a timer for the first device, a duration of the timer is the Time to Live, such that the primary control device may, on the basis of a reminder from the timer, send a first request to the first device according to a port number, an IP address, etc., of the first device as published in the DNS-SD record, and the first request is used for requesting to obtain the device information, such as the UUID, of the first device. The primary control device may determine that the first device is in the on-line state if it obtains the device information of the first device, e.g., the obtained device information of the first device is consistent with the device information in the record; and the primary control device may determine that the first device is in the off-line state if it does not obtain the device information of the first device.

S2403, based on that the device information of the first device is obtained, the first device is kept as on-line state.

Based on that the primary control device determines that the first device is still in the on-line state, e.g., obtaining the device information of the first device, or receiving the DNS-SD record updated by the first device, the first device is kept in the on-line state, i.e., the device state of the first device does not need to be changed.

S2404, based on that the device information of the first device is not obtained, the first device is set as off-line state.

Based on that the primary control device determines that the first device is in the off-line state, e.g., not obtaining the device information of the first device, or not receiving the DNS-SD record updated by the first device, the first device is set in the off-line state so as to update the device state of the first device in time.

In this way, the primary control device may actively display and update the device state of the first device, instead of relying on a subscription mechanism, an active publication of the first device, and other modes, to determine the device state of the first device. Even if the first device does not support the publication of the Shut Down event, the ability of the primary control device to display the off-line state of the first device is not affected. Even if the primary control device has not yet subscribed to the Start Up event of the first device, the ability of the primary control device to display the on-line state of the first device is not affected, and the primary control device may determine the device state of the first device more accurately and timely.

The primary control device may update the commissionee device list

according to the updated device state of the first device.

In some embodiments, the primary control device does not display the commissionee device list, and based on that the user inputs a command to the primary control device, the primary control device obtains the device state of the first device in response to the command and displays the commissionee device list according to the obtained device state of the first device. Based on that the device state of the first device is the on-line state, the first device is displayed as in the on-line state in the commissionee device list; and based on that the device state of the first device is the off-line state, the first device is displayed as in the off-line state in the commissionee device list.

In some other embodiments, the primary control device displays the commissionee device list, and, after performing the network configuration for the first device, sets the first device to the on-line state by default, so that the first device is displayed as in the on-line state in the commissionee device list. The primary control device updates the state of the first device displayed in the commissionee device list after updating the device state of the first device. Based on that the device state of the first device is the on-line state, the first device is still displayed as in the on-line state in the commissionee device list; and based on that the device state of the first device is updated to the off-line state, the first device is updated to be displayed as in the off-line state in the commissionee device list.

In this way, the user may accurately determine the device state of the first device on the basis of the commissionee device list, and effectively control the first device through the primary control device according to the device state of the first device.

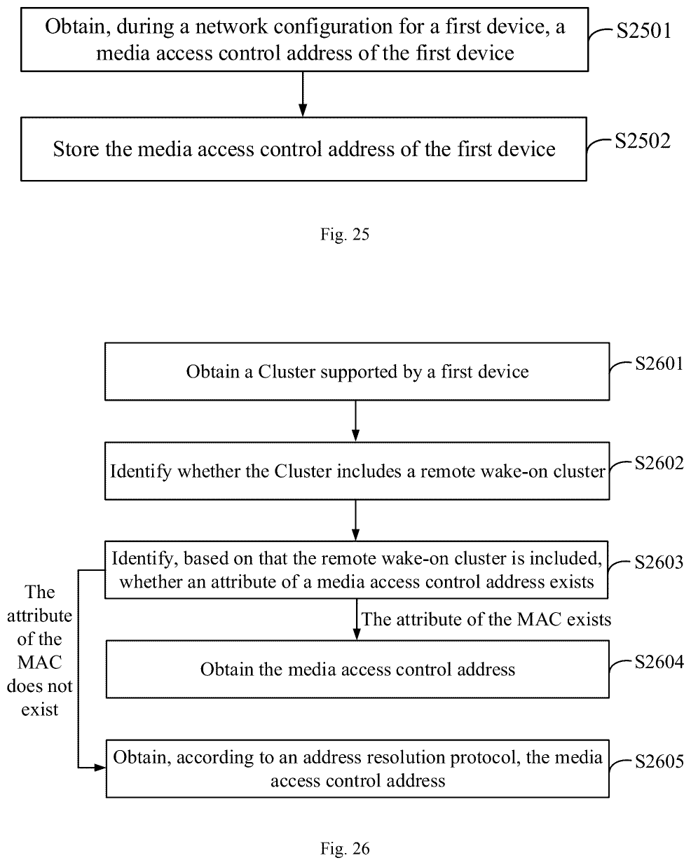

In some embodiments, the first device can support a remote wake-on function. The primary control device can send a remote wake-on instruction to the first device according to a Media Access Control (MAC) address of the first device to remotely wake on the first device. The primary control device may store the MAC address of the first device in a process shown in FIG. 25, which may include the following.

S2501, the media access control address of the first device is obtained during the network configuration for the first device.

The MAC address of the first device is an address used by the primary control device to send the remote wake-on instruction to the first device.

S2502, the media access control address of the first device is stored.

After obtaining the MAC address of the first device, the primary control device stores the MAC address for subsequent use when it needs to remotely wake on the first device.

The primary control device may use the MAC address of the first device as the device information of the first device, and store the device information of the first device in accordance with a specified data structure, such as storing the device information of the first device in accordance with the following data structure:

```
struct NodeInfo{
  UUID:string;
  Name:string;
  VendorName:string;
  Id:int;
  Mac:unsigned char[6];
  PowerState: bool;
}.
```

Where Mac is the MAC address of the first device and is an array containing six unsigned char elements. Based on that the first device does not support the remote wake-on function, the six elements in the Mac array are all 0.

In some embodiments, the Matter protocol specifies a Cluster, and functions supported by Matter have corresponding Clusters. The primary control device may obtain the MAC address of the first device in accordance with a process shown in FIG. 26, which may include the following.

S2601, a Cluster supported by the first device is obtained.

The primary control device obtains the Cluster supported by the first device when performing the network configuration for the first device.

S2602, whether the Cluster includes a remote wake-on Cluster is identified.

Based on that the first device can support a remote wake-on function, the Cluster supported by the first device may include a remote wake-on n Cluster.

S2603, based on that the remote wake-on Cluster is included, whether an attribute of a media access control address exists is identified.

The remote wake-on Cluster may include the attribute of the MAC address, and the attribute may be used for implementing the remote wake-on function. The attribute may publish the MAC address.

S2604, based on that the attribute of the media access control address exists, the media access control address is obtained.

Based on that the attribute of the MAC address exists in the remote wake-on Cluster, the primary control device may directly obtain the MAC address published by the attribute, i.e., the MAC address of the first device.

S2605, based on that the attribute of the media access control address does not exist, the media access control address is obtained according to an address resolution protocol.

In a Matter protocol, a root endpoint is a special endpoint on a device that is used for providing device-level description of functions and features. The root endpoint contains a descriptor cluster that is used for describing attributes, command events, and services of the device, providing other devices with a detailed understanding of its functions and features. The descriptor cluster may provide the following information including but not limited to: Device Type list, Server List, Client List, and PartList. When the device accesses Fabric, other devices, by querying a descriptor cluster of the device, may determine a specific device type of the device and exactly which endpoints and clusters are supported.

Some companies believe that the MAC address involves user privacy, so they hide the MAC address. In this case, the primary control device may resolve the MAC address of the first device according to the Address Resolution Protocol (ARP) protocol after determining that the remote wake-on Cluster is included.

Based on that the commissionee device list cannot display the special

functions supported by the first device, the user will not be informed of the special functions supported by the first device on the basis of the commissionee device list, and thus will not be able to use the special functions of the first device. For example, the first device can support the remote wake-on function, but based on that the primary control device does not display that the first device can support the remote wake-on function in the commissionee device list, the user cannot be informed that the first device can support the remote wake-on function, and cannot use the remote wake-on function of the first device directly on the basis of the commissionee device list.

In order to solve the above problem, the primary control device, in response to a command from the user, displays the commissionee device list. When the commissionee device list may include the first device, based on that the first device is in the on-line state, the first device is displayed as in the on-line state in the commissionee device list; and based on that the first device is in the off-line state, the first device is displayed as in the off-line state in the commissionee device list. Based on that the primary control device stores the MAC address of the first device, the primary control device may determine that the first device can support the remote wake-on function according to the MAC address, the commissionee device list may further include a first button of the first device, and the first button is used for inputting a remote wake-on instruction. In this way, the user may determine that the first device can support the remote wake-on function according to the first button, and may input an instruction to the primary control device on the basis of the first button so as to control the primary control device to send a remote wake-on instruction to the first device, thereby remotely wake on the first device.

Taking the primary control device being a TV and the first devices are a cell phone A and a tablet computer B as an example, a process of managing the commissionee devices by the primary control device is illustrated.

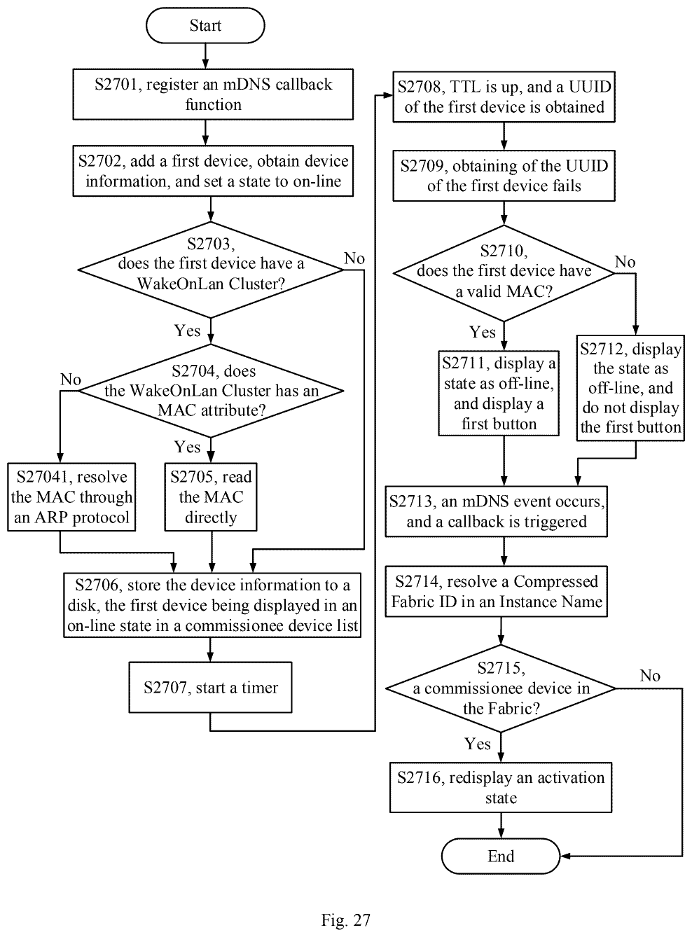

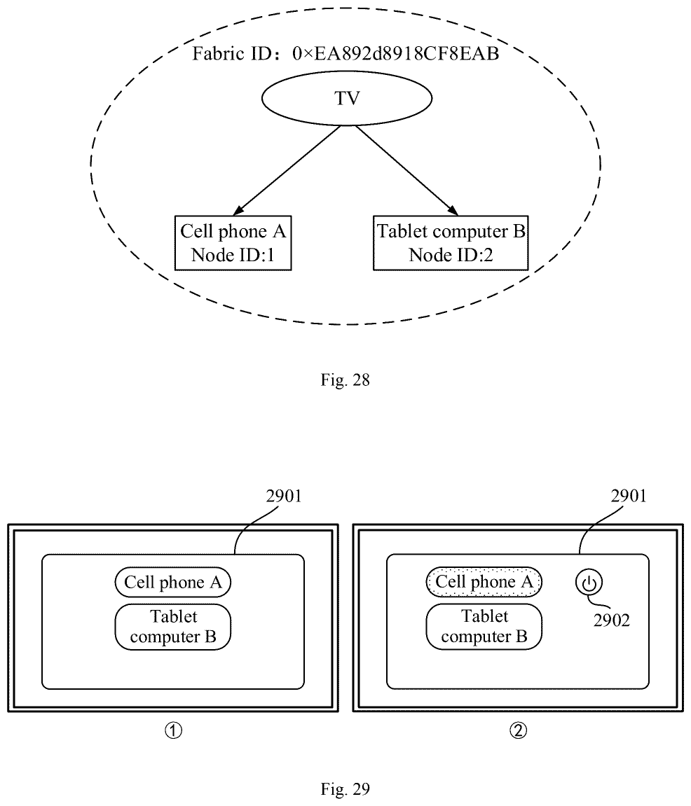

In conjunction with a process shown in FIG. 27, the TV registers a callback function in a local mDNS service, and the callback function is used for displaying an on-line notification of each commissionee device in the virtual domain to which it belongs. The TV can perform network configurations on the cell phone A and the tablet computer B so as to add the cell phone A and the tablet computer B to the virtual domain, as shown in FIG. 28, and a compressed Fabric ID of the virtual domain of the TV is 0xEA892d8918CF8EAB. After the cell phone A and the tablet computer B are added to the virtual domain, a NOC is assigned by the TV and may include a Fabric ID and a Node ID of the corresponding device in the virtual domain, e.g., a Node ID of the cell phone A in the virtual domain is 1, and a Node ID of the tablet computer B in the virtual domain is 2. A specific process executed by the TV shown in FIG. 27 is as follows. S2701, the callback function is registered in the local mDNS service. S2702, the first device is added, the device information is obtained, and the state is set to on-line.

S2703, whether the first device has the WakeOnLan Cluster is determined, if yes, the flow goes to S2704, and if not, the flow goes to S2706.

S2704, whether the WakeOnLan Cluster has the MAC attribute is determined, if yes, the flow goes to S705, and if not, the flow goes to S27041. S27041, the MAC is resolved through the ARP protocol, and the flow goes to S2706.

S2705, the MAC is directly read.

S2706, the device information is stored to a disk, and the first device is

displayed as being in the on-line state in the commissionee device list.

S2707, a timer is started.

S2708, TTL is up, and the UUID of the first device is obtained.

S2709, obtaining of the UUID of the first device fails.

S2710, whether the first device has a valid MAC is determined, if yes, the flow goes to S2711, and if not, the flow goes to S2712.

S2711, the state is displayed as off-line, the first button is displayed, and the flow goes to S2713.

S2712, the state is displayed as off-line, the first button is not displayed, and the flow goes to S2713.

S2713, an mDNS event occurs, and a callback is triggered.

S2714, a Compressed Fabric ID in an Instance Name is resolved.

S2715, whether it is a commissionee device in the Fabric is determined. If yes, the flow goes to S2716, and if not, the flow ends.

S2716, an activation state is redisplayed.

The TV records the Node IDs of the cell phone A and the tablet computer B and other information such as UUID, Name, Vendor Name, supported Clusters, etc., when adding the cell phone A and the tablet computer B to its own Fabric, sets the device states of the cell phone A and the tablet computer B to be on-line by default, i.e., setting PowerState to true, and sets the Mac array of the cell phone A and the tablet computer B to empty. The TV reads the Clusters supported by the cell phone A and the tablet computer B and looks to see whether they include the WakeOnLan Cluster. If yes, a corresponding MAC address is obtained and stored into corresponding device information. The TV may store device information of the cell phone A and the tablet computer B to a disk.

In response to a command from the user, the TV displays a commissionee device list 2901, as shown in \textcircled{1} in FIG. 29, and the commissionee device list 2901 may include options for the cell phone A and the tablet computer B, wherein both the cell phone A and the tablet computer B are displayed in an on-line state, such as a not-grayed-out state, in the commissionee device list 2901. The TV activates timers corresponding to the cell phone A and the tablet computer B respectively, wherein a duration of the timer corresponding to the cell phone A is Time to Live of the DNS-SD record updated by the cell phone A, and a duration of the timer corresponding to the tablet computer B is Time to Live of the DNS-SD record updated by the tablet computer B. The TV obtains device information, such as the UUID, of the cell phone A and the tablet compute B regularly in accordance with the reminder of each timer. Based on that the TV obtains device information, it may determine that the corresponding device is in the on-line state; and based on that it does not obtain device information, it may determine that the corresponding device is in the off-line state. Taking the example that the TV does not obtain the UUID of the cell phone A and obtains the UUID of the tablet computer B, the TV may determine that the cell phone A is in the off-line state and the tablet computer B is still in the on-line state, then it adjusts the PowerState of the cell phone A to false, and keeps the PowerState of the tablet computer B to true. The TV further determines whether an MAC address of the cell phone A is stored, and as an example, the TV determines that the MAC address of the cell phone A is not empty, i.e., a valid MAC address of the cell phone A is stored, the TV may determine that the cell phone A can support the remote wake-on function. As shown

in \textcircled{2} in FIG. 29, the TV updates the commissionee device list 2901, and the commissionee device list 2901 may include options for the cell phone A and the tablet computer B, wherein the cell phone A is displayed in an off-line state in the commissionee device list 2901, such as a grayed-out state, and the commissionee device list 2901 may include a first button 2902 of the cell phone A, which is used for the user to input a remote wake-on instruction. The tablet computer B is still displayed as in the on-line state in the commissionee device list 2901.

In some embodiments, the primary control device may display the on-line state of the commissionee device so as to re-update the commissionee device in the off-line state to the on-line state.

The primary control device stores device information of each first device after performing the network configuration for the first device. After being added to the virtual domain of the primary control device, each first device is a node in the virtual domain, and the primary control device may store device information of each first device in a node information list. The node information list may include node information of each node in the virtual domain of the primary control device, and the node information may include a Node ID of the node in the virtual domain.

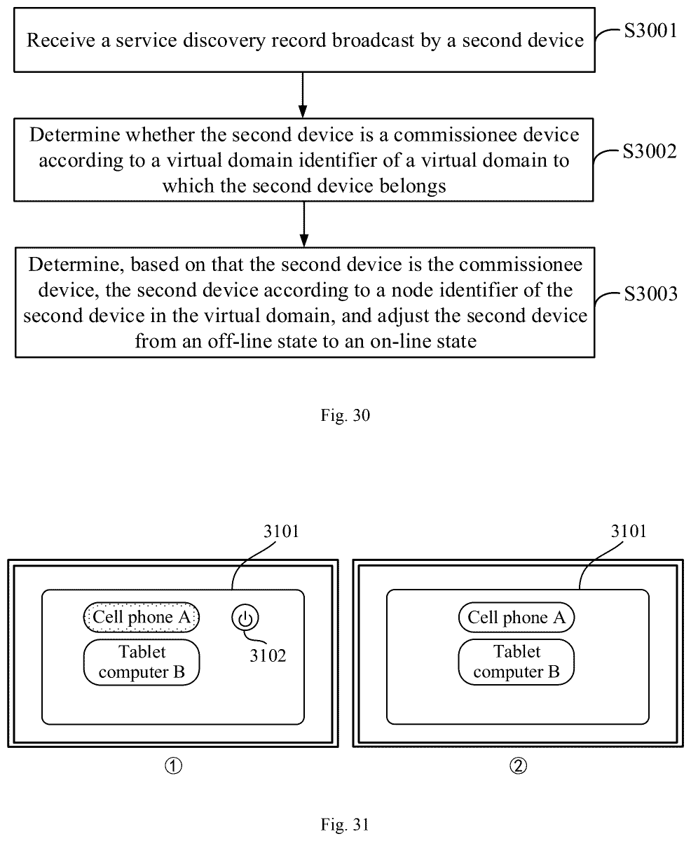

The primary control device may update the device state of the second device in accordance with a process shown in FIG. 30, which may include the following.

S3001, a service discovery record broadcast by the second device is received.

The second device may include the first device in the off-line state, and a Matter device that is not added to the virtual domain of the primary control device.

On the basis of the Matter protocol, the second device publishes a DNS-SD record after being started up. The DNS-SD record may include a virtual domain identifier of a virtual domain to which the second device belongs, and a node identifier of the second device in the virtual domain. For example, the DNS-SD record may include an Instance Name, and the Instance Name may include a Compressed Fabric ID and a Node ID.

S3002, whether the second device is a commissionee device is determined according to the virtual domain identifier of the virtual domain to which the second device belongs.

The primary control device may be informed of the Compressed Fabric ID of the virtual domain created by itself, so that after the second device publishes the DNS-SD record, the primary control device, based on that it receives the DNS-SD record, may determine whether the second device belongs to the virtual domain to which it belongs according to the Compressed Fabric ID in the DNS-SD record so as to determine whether the second device is a commissionee device. Based on that the virtual domain identifier of the virtual domain to which the second device belongs is the same as the virtual domain identifier of the virtual domain of the primary control device, the second device may be determined to be the commissionee device, as well as the second device may be determined to be in an on-line state. Based on that the virtual domain identifier of the virtual domain to which the second device belongs is different from the virtual domain identifier of the primary control device, it can be determined that the second device is not the commissionee device of the primary control device.

S3003, based on that the second device is the commissionee device, the

second device is determined according to the node identifier of the second device in the virtual domain, and the second device is adjusted from the off-line state to the on-line state.

The primary control device, after determining the second device as the commissionee device, further determines the second device in the virtual domain according to the Node ID in the DNS-SD record. In addition, the primary control device adjusts the second device from the off-line state to the on-line state.

In this way, the primary control device may actively display a re-on-line operation of an off-line device and update the device state of the re-on-line device in time.

Taking the primary control device being a TV and the first devices are a cell phone A and a tablet computer B as an example, in conjunction with the above example(s), a process of the primary control device managing the commissionee device after the commissionee device is re-on-line is illustrated.

In conjunction with the process shown in FIG. 27, the TV displays the commissionee device list 3101 as shown in \textcircled{1} in FIG. 31, wherein the cell phone A is displayed in an off-line state in the commissionee device list 3101, the tablet computer B is displayed in an on-line state in the commissionee device list 3101, and the commissionee device list 3101 may further include a first button 3102 of the cell phone A. After the cell phone A is re-on-line, it publishes a DNS-SD record in accordance with the mDNS service, and the DNS-SD record may include the Instance Name which may include the Compressed Fabric ID and the Node ID. The mDNS service will publish the DNS-SD record in a broadcast address, and the callback function for TV registration will be triggered. The TV obtains the Compressed Fabric ID by parsing the DNS-SD record, and compares this Compressed Fabric ID with the Compressed Fabric ID of the virtual domain to which it belongs obtained by itself to identify whether the cell phone A is a commissionee device in this virtual domain. In this example, the TV may determine that the cell phone A is a commissionee device in this virtual domain, and thus determine that the cell phone A is in an on-line state, i.e., the cell phone A is re-on-line. The TV obtains the Node ID by parsing this DNS-SD record and locates the cell phone A in the virtual domain according to this Node ID and readjusts the device state of the cell phone A from the off-line state back to the on-line state. The TV updates the commissionee device list 3101 to display an updated commissionee device list 3101 as shown in \textcircled{2} in FIG. 31, wherein the updated commissionee device list 3101 may include options for the cell phone A and the tablet computer B, wherein both the cell phone A and the tablet computer B are displayed in the commissionee device list 3101 in an on-line state, such as a not-grayed-out state. The updated commissionee device list 3101 may not include the first button 3102 of the cell phone A.

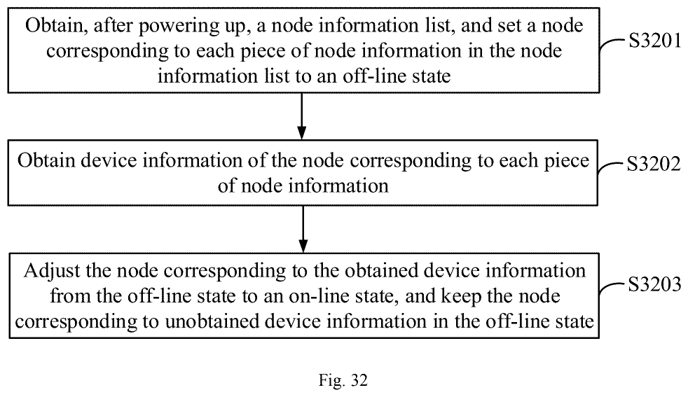

In some other embodiments, the primary control device is re-powered up from a power-down state after performing the network configuration for the commissionee device, and the primary control device, after being re-powered up, may manage the device state of the commissionee device in accordance with a process shown in FIG. 32, which may include the following.

S3201, after powering up, a node information list is obtained, and a node corresponding to each piece of node information in the node information list is set to the off-line state.

After the primary control device can perform the network configuration for

the commissionee devices, the device information of each commissionee device is stored in a form of the node information list which may include the node information (device information) of each node (commissionee device), such as a UUID. A data structure of the node information may refer to struct NodeInfo above, and will not be repeated here.

The primary control device may store the node information list in the disk, and after being re-powered up, the primary control device may read the node information list from the disk and read out the node information of each node, such as the UUID, sequentially from this node information list.

The primary control device sets the device state of each node to the off-line state by default before resuming the device state of each node, such as setting the Power State of each node to false.

S3202, device information of the node corresponding to each piece of node information is obtained.

The primary control device actively obtains device information of each node, such as obtaining the UUID of the node. The primary control device may obtain the device information of each node sequentially in accordance with an order in which each piece of node information is stored in the node information list, an order of Node IDs, etc. In some embodiments, the primary control device may locate a corresponding node in accordance with the Node ID in the node information and send a second request to the node, and the second request is used for requesting device information of the node, such as a UUID. The node feeds the UUID back to the primary control device in response to the second request.

S3203, the node corresponding to the obtained device information is adjusted from the off-line state to an on-line state, and the node corresponding to the unobtained device information is kept in the off-line state.

Based on that the primary control device may obtain the device information fed back from the node, indicating that the node is in the on-line state, the primary control device adjusts the node from the off-line state to the on-line state, such as setting the Power State to true. Based on that the primary control device fails to obtain the device information of the node, indicating that the node is in the off-line state, the primary control device keeps the node in the off-line state.

In this way, the primary control device may actively display and update the device state of each node in the virtual domain after being re-powered up, instead of relying on a subscription mechanism, node active publication, and other modes to determine the device state of the node, even if the primary control device has not subscribed to the Start Up event of the first device or misses to receive the Start Up event sent from the node, it will not affect the ability of the primary control device to display the on-line state of the node, and the primary control device may determine the device state of the first device more accurately and timely.

The primary control device, after being re-powered up, may update the commissionee device list according to the device state of each node.

In some embodiments, the primary control device, after being re-powered up, does not display the commissionee device list, and based on that the user inputs a command to the primary control device, the primary control device obtains the device state of each node in response to the command and displays the commissionee device list according to the obtained device state of each node. Based on that the device state of the node is the on-line state, the node is displayed as in the on-line state in the commissionee device

list; and based on that the device state of the node is the off-line state, the node is displayed as in the off-line state in the commissionee device list.

In some other embodiments, the primary control device, after being re-powered up, displays the commissionee device list and sets each node to the off-line state by default, so that each node is displayed as in the off-line state in the commissionee device list. The primary control device, after determining the device state of each node sequentially, updates the device state of each node displayed in the commissionee device list. Based on that the device state of the node is the on-line state, the node is updated to be displayed as in the on-line in the commissionee device list; and based on that the device state of a node is the off-line state, the node is still displayed as in the off-line state in the commissionee device list.

In this way, after the primary control device is re-powered up, the user may accurately determine the device state of each node on the basis of the commissionee device list, and effectively control each node through the primary control device according to the device state of each node.

In some embodiments, as can be seen above, based on that the node can support the remote wake-on function, the node information of the node may include an MAC address of the node, and the MAC address is used for the primary control device to send a remote wake-on instruction to the node. The primary control device, in response to a command from the user, displays the commissionee device list which may include each node. Based on that the node is in the on-line state, the node is displayed as in the on-line state in the commissionee device list; and based on that the node is in the off-line state, the node is displayed as in the off-line state in the commissionee device list. Based on that the primary control device stores the MAC address of the node in the off-line state, the commissionee device list may further include a first button for the node, the first button is used for the user to input an instruction to control the primary control device to send a remote wake-on instruction to the node, thereby remotely wake on the node.

Taking the primary control device being a TV and the nodes in the virtual domain being capable of including a cell phone A and a tablet computer B as an example, the process of managing the node after the primary control device is re-powered up is discussed.

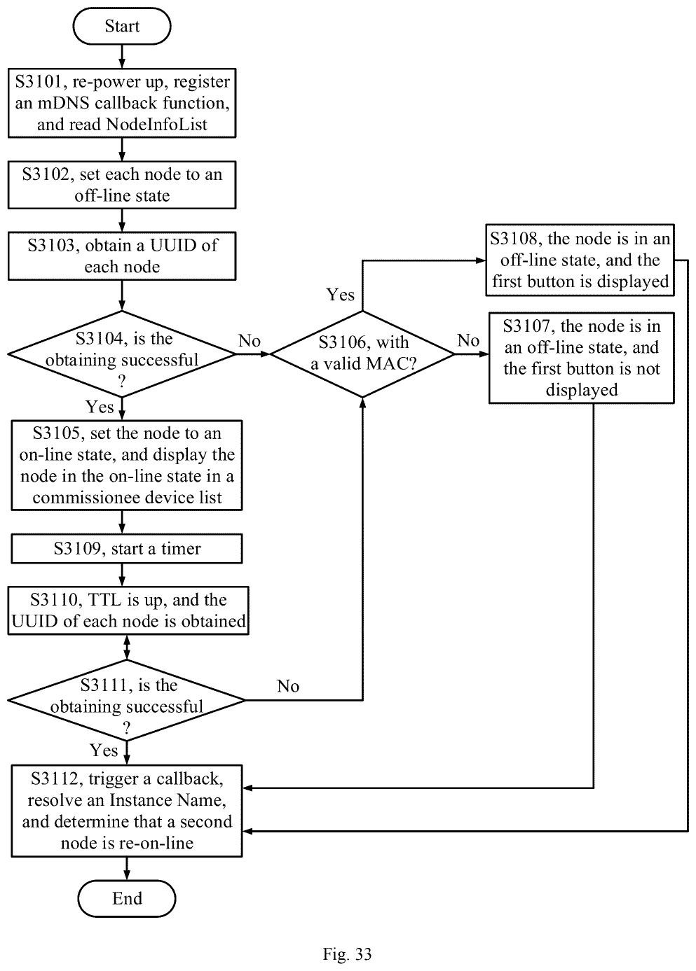

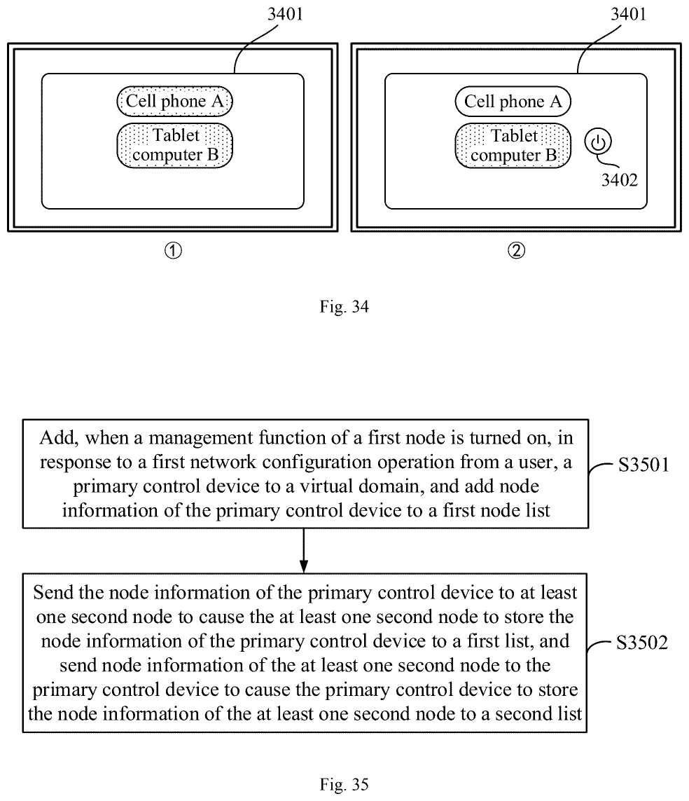

Combined with a process shown in FIG. 33, it is as follows. S3101, the TV, after being re-powered up, obtains the node information list, such as reading the node information list from a disk. The node information list may include node information, such as UUID, of each node in the virtual domain. S3102, the TV sets the device state of each node to the off-line state by default, such as setting the Power States of both the cell phone A and the tablet computer B to false. TV registration is called back to the mDNS service. Based on that the user inputs a command to the TV, the TV, in response to the command, displays the commissionee device list 3401 as shown in \textcircled{1} in FIG. 34, and the commissionee device list 3401 may include options for the cell phone A and the tablet computer B, wherein both the cell phone A and the tablet computer B are displayed in an off-line state, such as a grayed-out state, in the commissionee device list 3401. S3103, the TV may obtain device information, such as a UUID, of the corresponding node in the order in which each piece of node information in the node information list is stored. S3104, the TV can determine whether the obtaining is successful. If yes, the flow goes to S3105, and if not, the flow goes to S3106. S3105, the TV, based on that it obtains the device

information of the node, may determine that the node is in the on-line state, and modify the Power State of the node to true. S3106, the TV, based on that it does not obtain the device information of the node, may determine that the node is in the off-line state, and keep the Power State of the node to false. The TV updates the commissionee device list according to the updated device state of each node. Taking the TV obtaining the device information of the cell phone A and not obtaining the device information of the tablet computer B as an example, the TV further identifies whether the tablet computer B can support the remote wake-on function, for example, the TV identifies whether the node information of the tablet computer B may include an MAC address. Taking the tablet computer B supporting the remote wake-on function as an example, the TV displays the updated commissionee device list 3401 as shown in \textcircled{2} in FIG. 14, and the updated commissionee device list 3401 may include options for the cell phone A and the tablet computer B. S3107, the cell phone A is displayed in the on-line state in the commissionee device list 3401. S3108, the tablet computer B is displayed in the off-line state in the commissionee device list 3401, and the commissionee device list 3401 may include a first button 3402 of the tablet computer B. The first button 3402 is used for the user to input an instruction to remotely wake on the tablet computer B through the TV. S3109, a timer is started. S3110, TTL is up, and the UUID of each node is obtained. S3111, whether the obtaining is successful is determined. If not, the flow goes to S3106, and if yes, the flow goes to S3112. S3112, the mDNS callback is triggered, the Instance Name is resolved, and it is determined that a second node is re-on-line.

In some embodiments, the primary control device, after being re-powered up and determining the node that is in the on-line state (the first node), may update the device state of the first node in accordance with steps S2402-S2404. For example, the primary control device obtains device information of the first node in accordance with the Time to Live of the first node. The primary control device, based on that it obtains the device information of the first node, keeps the first node in the on-line state; and the primary control device, based on that it does not obtain the device information of the first node, sets the first node in the off-line state. When the first node is reset to the off-line state, based on that it is determined that the first node can support the remote wake-on function, the primary control device displays the first button of the first node when displaying the commissionee device list; and based on that it is determined that the first node does not support the remote wake-on function, the primary control device does not display the first button of the first node when displaying the commissionee device list.

In some embodiments, the primary control device, after being re-powered up and determining the node that is in the off-line state (the second node), may update the device state of the second node in accordance with steps S3001-S3003. For example, the primary control device receives a service discovery record broadcast by the second node. Whether the second node is a commissionee device is determined according to the virtual domain identifier of the virtual domain to which the second node belongs. Based on that the second node is the commissionee device, the second node is determined according to the node identifier of the second node in the virtual domain, and the second node is adjusted from the off-line state to the on-line state.

When performing the network configuration for the commissionee device, the primary control device usually needs to maintain a Bluetooth connection with the commissionee device, and needs to interact with the commissionee device between devices, such as scanning a two-dimensional code on

the commissionee device. Therefore, the distance between the primary control device and the commissionee device should not be too far, e.g. not more than 10 meters. Moreover, the primary control device needs to be provided with functions for inter-device interaction with the commissionee device, such as a camera, Bluetooth, and other functions. Further, at least one of the primary control device and the commissionee device is readily movable and easily movable to enable the primary control device and the commissionee device to interact between the devices. It can be seen that the primary control device itself, as well as the primary control device and the commissionee device need to meet high requirements, thus the primary control device can realize the network configuration for the commissionee device to obtain the control privilege to the commissionee device, which will limit the types of devices and scenarios that can participate in device interconnection, and limit the scope of application of device interconnection.

The primary control device and the commissionee device provided by some embodiments of the present application may have various forms of implementation, for example, the primary control device and the commissionee device may be display apparatuses or non-display apparatuses, the primary control device and the commissionee device may have a Bluetooth function or may not have a Bluetooth function, the primary control device and the commissionee device may have a camera or may not have a camera, and the primary control device and the commissionee device may be position-fixed devices or position-movable devices, etc. There is no limit to the distance between the primary control device and the commissionee device and the spatial range in which they are located, e.g. the distance between the primary control device and the commissionee device is greater than 10 meters, or the primary control device and the commissionee device are in different rooms, etc.

In some embodiments, based on that the primary control device and the commissionee device are non-display apparatuses, the non-display apparatus may have various forms of implementation, e.g., it may be a device without a display screen, such as a smart light, a smart refrigerator, a smart cooker, a smart bathroom, a smart air conditioner, a smart soundbox, etc. The non-display apparatus may establish sending and receiving of control signals and data signals with other devices, such as a third-party device, a primary control device, or a commissionee device, through a communicating device.

In some embodiments of the present application, the process of the primary control device performing the network configuration for the commissionee device is to add the commissionee device to the Matter network of the primary control device, and the Matter network may be a virtual domain (Fabric). The primary control device has a corresponding virtual domain, and the virtual domain may include the primary control device and all commissionee devices controlled by the primary control device. The primary control device and the commissionee device belonging to the same one virtual domain access the same one local area network (i.e., a specified network), and the virtual domain to which the devices in the virtual domain belong and their identities in the virtual domain are identified by Node Operational Certificates they hold. After performing the network configuration for the commissionee device, the primary control device marks the addition of the commissionee device to its own virtual domain by assigning a NOC to the commissionee device. The NOC held by each device in the virtual domain may include: a virtual domain identifier, such as a Fabric ID, used for uniquely identifying the virtual domain, and a node identifier, such as a Node ID, used for uniquely identifying the device in the

virtual domain. That is, virtual domains of different primary control devices have different Fabric IDs, and the Node IDs of the devices in the same one virtual domain are different, but the Node IDs of the devices belonging to different virtual domains may be the same. Within the same one local area network, one or more virtual domains may be included, and there may be overlaps between the virtual domains.

When performing the network configuration for the commissionee device, the primary control device scans a two-dimensional code provided by the commissionee device to obtain a passcode associated with the two-dimensional code. After turning on the Bluetooth function, the commissionee device enters into a network configuration state, and provides a device discovery service outward through Bluetooth, such as sending a Bluetooth broadcast outward. When scanning the Bluetooth broadcast of the commissionee device through Bluetooth, the primary control device establishes a first connection with the commissionee device according to the passcode and the device information of the commissionee device, and the first connection is a Bluetooth connection. The primary control device and the commissionee device perform device attestation on the basis of the first secure connection, and the primary control device assigns the NOC to the commissionee device after the commissionee device passes the attestation, as well as can send the NOC and network configuration information of the wireless network, such as an ID of the home wireless network of a current user, and a network password, to the commissionee device through the first connection. After the commissionee device accesses the wireless network according to the network configuration information of the wireless network, the commissionee device may broadcast device information, such as an Internet Protocol (IP) address, and a port number, in the wireless network through a Multicast Domain Name System (mDNS) protocol. The primary control device may obtain the device information of the commissionee device through the mDNS protocol, and establish a second connection with the commissionee device according to the device information of the commissionee device, the second connection being a Wi-Fi connection. The primary control device and the commissionee device may establish a security session on the basis of the second connection according to the NOC held by each of them so as to transmit instructions and data through the security session.

The commissionee device is configured with a first list, such as an Access Control List (ACL). This first list may include node information of control devices that have control privileges for the commissionee device. An example of the ACL table provided by Matter is specifically given below:

Access Control Cluster: {
ACL: [
0: {
FabricIndex: 1,
Privilege: Administer,
AuthMode: CASE,
Subjects: [ 1, 2, 4 ],
Targets: [ ]
}
]
}.

Where there is only one element in an ACL array in the Access Control Cluster, and Privileges in the element are as follows: Administer indicates that the privilege is an administrator privilege; Subjects: [1, 2, 4] indicate that Node IDs of nodes with control privileges in the virtual domain are 1, 2 and 4 respectively; and Targets: [ ] indicates that the nodes have control privileges over all contents. Therefore, the overall meaning of the above example is that the nodes with the Node IDs 1, 2, and 4 have administrator privileges for all functions in this commissionee device. The Subjects array may be modified. Matter provides a relevant function to add a new Node ID so that the node corresponding to the Node ID has a control privilege of the control device, or to delete an existing Node ID so that the node corresponding to the Node ID no longer has the control privilege of the control device.

The primary control device is configured with a second list, such as a Binding Cluster provided by Matter. The second list may include node information of commissionee devices for which the primary control device has control privileges. An example of the Binding Cluster provided by Matter is specifically given below.

| ID | Name | Type | Quality | Constraint |
|---|---|---|---|---|
| 1 | Node | node-id | all | Endpoint |
| 2 | Group | group-id | all | !Endpoint |
| 3 | Endpoint | endpoint | all | !Group |
| | | no | | |
| 4 | Cluster | cluster-id | all | O |

Where, the Node field is used for recording node information of the commissionee device. By modifying the Node field, a Node ID of a commissionee device with a control privilege in the virtual domain is recorded in the Binding Cluster, as well as a Node ID of a commissionee device that no longer has a control privilege is deleted from the Binding Cluster.

The primary control device can send node information, such as device information, and a Node ID in the virtual domain, to the commissionee device which stores it to the first list, and thus the commissionee device determines that the primary control device has a control privilege. The primary control device obtains node information of the commissionee device, such as device information, and a Node ID in the virtual domain, and stores the node information of the commissionee device to the second list, so that the primary control device is determined to have a control privilege to the commissionee device. On the basis of the above process, the primary control device completes the network configuration for the commissionee device, and the primary control device may control the commissionee device.

On the basis of the process of the primary control device performing the network configuration for the commissionee device, it can be seen that the primary control device needs to be provided with a camera so as to be able to scan the two-dimensional code of the commissionee device. At least one of

the primary control device and the commissionee device is readily movable and easily movable to enable the primary control device and the commissionee device to interact between the devices. The primary control device and the commissionee device also need to be configured with a Bluetooth function to establish a Bluetooth connection, and the distance between the primary control device and the commissionee device should not be too far away, e.g., not more than 10 meters, so as to keep the Bluetooth connection available. It can be seen that both the primary control device and the commissionee device need to meet high requirements, thus the primary control device can realize the network configuration for the commissionee device to obtain the control privilege to the commissionee device, which will limit the types of devices and scenarios that can participate in device interconnection, and limit the scope of application of device interconnection.

In view of the above issues, some embodiments of the present application provides a method of assigning control privileges between devices on the basis of a third-party device, on the basis of the third-party device assisting the primary control device in interconnecting with a commissionee device, so as to be compatible with a greater number of device types and scenarios participating in the interconnection of the devices, as well as to expand the scope of application of device interconnection.

The third-party device is a smart device, such as a smartphone, a tablet computer, and a PC. The third-party device integrates a Matter protocol and has a function for network configurations for other devices. The third-party device has mobility and can move to the primary control device and the commissionee device for close device interaction with both.

The third-party device is configured with a first node list and a second node list. The first node list may be named Admin Node List (ANL), and may include node information of a first node. The second node list may be named Normal Node List (NNL) and may include node information of a second node. Both the first node and the second node are network devices that have been added to the virtual domain of the third-party device. The first node may be referred to as an Admin Node, and the second node may be referred to as a Normal Node, wherein the third-party device may assign a control privilege to at least one second node corresponding to the second node list to the first node corresponding to the first node list by managing the first node list and the second node list.

In some embodiments, the third-party device may assign a control privilege of the commissionee device to the primary control device newly added to the virtual domain according to a process shown in FIG. 35, which may include the following.

S3501, when a management function of the first node is turned on, in response to a first network configuration operation from a user, the primary control device is added to the virtual domain, and node information of the primary control device is added to the first node list.

The third-party device is secondarily developed on the basis of the Matter protocol so as to provide a new network configuration function. This new network configuration function may include the management function of the first node, such as a Pair Admin Node function. On the basis of the management function of the first node, the third-party device may set a network device newly added to the virtual domain as the first node and assign a control privilege of the second node to the network device.

The third-party device may be configured with a management page that

may include a switch for the management function of the first node. When the user wants to control the commissionee device through the primary control device, the user may turn on the switch to turn on the management function of the first node of the third-party device. The third-party device, after turning on the management function of the first node, may jump directly to a network configuration interface to cause the user to perform the first network configuration operation on the basis of the network configuration interface. The third-party device, after turning on the management function of the first node, may also, in response to a command from the user, display the network configuration interface to cause the user to perform the first network configuration operation on the basis of the network configuration interface.

When the management function of the first node is turned on, the user may perform a first network configuration operation on the third-party device to cause the third-party device to perform a network configuration for the primary control device.

The first network configuration operation may be that the user can use the third-party device to scan a two-dimensional code provided by the primary control device, and the two-dimensional code may be affixed to a housing of the primary control device, or displayed on a display of the primary control device. The third-party device obtains a passcode provided by the primary control device by parsing the two-dimensional code.

The first network configuration operation may further be that the user inputs a pairing code provided by the primary control device in the third-party device. The third-party device obtains the passcode provided by the primary control device according to the pairing code, e.g., the third-party device may send a request containing the pairing code to the primary control device to request the passcode from the primary control device, and the primary control device receives the request, and after identifying that the pairing code is correct, feeds back the passcode to the third-party device.

The first network configuration operation may also be that the user can use a Near Field Communication (NFC) region of the third-party device to approach or touch a NFC region of the primary control device. After the third-party device establishes a NFC connection with the primary control device, the primary control device can send the passcode to the third-party device through the NFC connection.

In some embodiments, based on that the primary control device does not have a function to direct access a Wi-Fi network, e.g., based on that the primary control device is a non-display apparatus, the primary control device is added to the Wi-Fi network with the assistance of the third-party device. Both the primary control device and the third-party device turn on a Bluetooth function, and the primary control device provides a device discovery service outward on the basis of a device discovery protocol, such as sending a Bluetooth broadcast outward. The third-party device, after discovering the primary control device, establishes a first connection with the primary control device, the first connection being a Bluetooth connection. The third-party device and the primary control device, according to the passcode and on the basis of the first connection, establish a first security session, such as a Passcode-Authenticated Session Establishment (PASE) session. On the basis of the first security session, the third-party device can perform device attestation with the primary control device to ensure the security of the device attestation process of the third-party device and the primary control device. For example, the third-party device may send an attestation request to the primary control device, the primary

control device, in response to the attestation request, feeds back a device certificate, and the third-party device can perform device attestation on the primary control device according to the device certificate. After the primary control device passes the device attestation, the third-party device assigns a NOC to the primary control device and can send this NOC and configuration information of the wireless network to the primary control device on the basis of the first security session so as to cause the primary control device to access the wireless network according to the configuration information of the wireless network. After the primary control device accesses the wireless network according to the network configuration information of the wireless network, the primary control device may broadcast device information, such as an IP address, and a port number, in the wireless network through the mDNS protocol. The third-party device may obtain the device information of the primary control device through the mDNS protocol and establish a second connection with the primary control device according to the device information of the primary control device, the second connection being a Wi-Fi connection. The third-party device and the primary control device may establish a second security session, such as a Certificate-Authenticated Session Establishment (CASE) session, on the basis of the second connection according to the NOC held by each of them, so as to transmit instructions and data through the second security session. The primary control device is configured with a first list, such as an ACL. The third-party device is configured with a second list, such as a Binding Cluster provided by Matter. Node information, such as device information, and a Node ID in the virtual domain, is sent to the primary control device by the third-party device and is stored by the primary control device to the first list, and thus the primary control device determines that the third-party device has a control privilege. The third-party device obtains node information of the primary control device, such as device information, and a Node ID in the virtual domain, and stores the node information of the primary control device to the second list, so that the third-party device is determined to have a control privilege of the primary control device. On the basis of the above process, the third-party device completes the network configuration for the primary control device, and the third-party device may control the primary control device.

In some other embodiments, based on that the primary control device has the function of directly accessing the Wi-Fi network, e.g., the primary control device is a display apparatus, the primary control device may directly access the same Wi-Fi network as the third-party device on the basis of the operation from the user, i.e., being added to the virtual domain of the third-party device. The third-party device assigns a NOC to the primary control device and establishes a second connection directly with the primary control device, as well as can send the NOC to the primary control device on the basis of the second connection. The third-party device and the primary control device may establish a second security session on the basis of the second connection according to the NOC held by each of them. Accordingly, the third-party device stores the node information of the primary control device to the second list, and the primary control device stores the node information of the third-party device to the first list. On the basis of the above process, the third-party device completes the network configuration for the primary control device, and the third-party device may control the primary control device.

On the basis that the third-party device has enabled the management function of the first node, the third-party device may determine that the primary control device is the first node. After the primary control device is added to the virtual domain of the third-party device, the third-party device adds the

node information of the primary control device to the first node list to manage the primary control device as the first node. The node information of the primary control device may include the Node ID of the primary control device in the virtual domain, and may also include device information of the primary control device, such as an IP address, a port number, and a device name.

As a result, the third-party device has the basis for assigning a control privilege of the second node to the primary control device.

S3502, the node information of the primary control device is sent to at least one second node to cause the at least one second node to store the node information of the primary control device to the first list, and the node information of the at least one second node is sent to the primary control device to cause the primary control device to store the node information of the at least one second node to the second list.

The second node is a network device that is added to the virtual domain of the third-party device before the primary control device.

In some embodiments, the at least one second node is all of the second nodes corresponding to the second node list.

The third-party device determines node information of the primary control device from the first node list, such as latest node information added to the first node list. The third-party device can send the node information of the primary control device to the second node corresponding to each piece of node information sequentially in accordance with the order of the node information in the second node list. The third party device can read each piece of node information in the second node list sequentially and can send the node information of the primary control device to the second node corresponding to the node information, and reads the next piece of node information after sending the node information of the primary control device. The third-party device may also send the node information of the primary control device to all the second nodes once. After receiving the node information of the primary control device, each second node stores the node information of the primary control device to the first list in a device. As a result, each second node may determine that the primary control device has a control privilege.

Accordingly, the third-party device can send the node information of each second node to the primary control device. The third-party device may send the node information of the second node to the primary control device after sending the node information of the primary control device to one second node, or may send the node information of all the second nodes to the primary control device once. After receiving the node information of each second node, the primary control device stores the node information of the second node to the second list in the device. As a result, it may be determined that the primary control device has the control privilege of each second node.

In some other embodiments, the at least one second node is a second node selected by the user from all the second nodes.

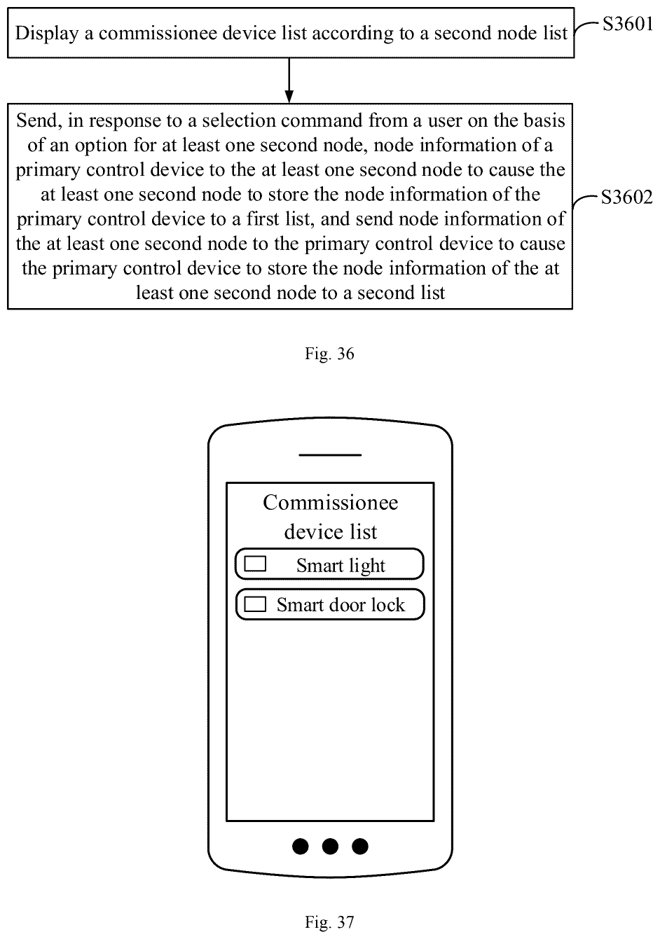

The third-party device may assign the control privilege of the second node to the primary control device in accordance with a process shown in FIG. 36, which may include the following.

S3601, a commissionee device list is displayed according to the second

node list.

The third-party device may automatically display the commissionee device list after the successful network configuration for the primary control device. The third-party device, in response to the command from the user, may further display the commissionee device list after the successful network configuration for the primary control device.

The commissionee device list may include an option for the second node. Taking the third-party device being a cell phone as an example, reference may be made to the commissionee device list shown in FIG. 37, and based on that the second node list may include a smart light and a smart door lock, the cell phone displays the commissionee device list which may include options for the smart light and the smart door lock.

S3602, in response to a selective command from the user on the basis of an option of at least one second node, the node information of the primary control device is sent to the at least one second node to cause the at least one second node to store the node information of the primary control device to the first list, and the node information of the at least one second node is sent to the primary control device to cause the primary control device to store the node information of the at least one second node to the second list.

The at least one second node is a second node for which the user wants to enable the primary control device to have the control privilege. The process of the third-party device, in response to the selective command from the user on the basis of the option of the at least one second node, sending the node information of the primary control device to the at least one second node, and causing the at least one second node to store the node information of the primary control device to the first list in the device may refer to embodiments related to the at least one second node being all of the second nodes in the second node list, which is not repeated here. Accordingly, the process of the third-party device sending the node information of the at least one second node to the primary control device and causing the primary control device to store the node information of the at least one second node to the second list in the device may refer to embodiments related to the at least one second node being all the second nodes in the second node list, which is not repeated here.

On the basis of the above process, with the assistance of the third-party device, the user may newly add the network device to the virtual domain of the third-party device as the primary control device, and the third-party device assigns to the primary control device the control privilege of the second node that has been added to the virtual domain, so as to realize the effect of the network configuration by the primary control device for each second node without the need of a direct network configuration by the primary control device for each second node. Based on this, the primary control device does not need to meet the camera, Bluetooth function, mobility and other harsh conditions, and may be compatible with primary control devices of more device types and scenarios, expanding the scope of application of device interconnection.

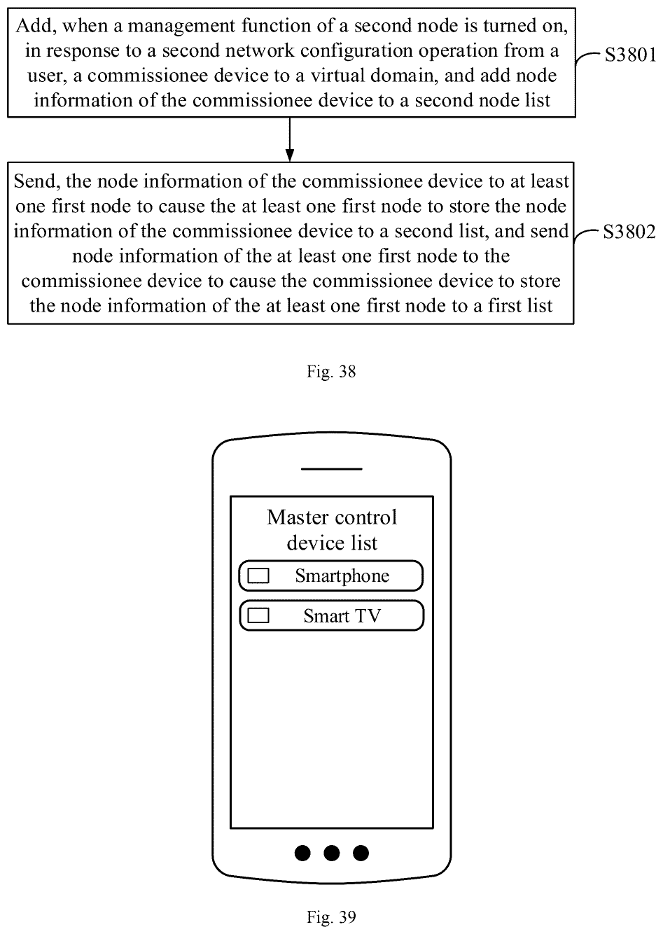

In some embodiments, the third-party device may assign the primary control device with a control privilege to the control device newly added to the virtual domain in accordance with a process shown in FIG. 38, which may include the following.

S3801, when a management function of the second node is turned on, in

response to a second network configuration operation from a user, the commissionee device is added to the virtual domain, and node information of the commissionee device is added to the second node list.

The third-party device is secondarily developed on the basis of the Matter protocol so as to provide a new network configuration function. This new network configuration function may include the management function of the second node, such as a Pair Admin Node function. On the basis of the management function of the second node, the third-party device may set the network device newly added to the virtual domain as a second node and assign a first node with a control privilege to the network device.

The third-party device may be configured with a management page that may include a switch for the management function of the second node. The switch may be turned on to enable the management function of the second node of the third-party device when the user wants to assign a primary control device with a control privilege to the commissionee device. The third-party device, after turning on the management function of the second node, may jump directly to a network configuration interface to cause the user to perform a second network configuration operation on the basis of the network configuration interface. The third-party device, after turning on the management function of the second node, may also, in response to a command from the user, display the network configuration interface to cause the user to perform the second network configuration operation on the basis of the network configuration interface.

When the management function of the second node is turned on, the user may perform a second network configuration operation on the third-party device to cause the third-party device to perform a network configuration for the commissionee device.

The second network configuration operation may refer to the first network configuration operation, which is not repeated here. The third-party device may obtain the passcode provided by the commissionee device through the second network configuration operation. The process of the third-party device performing the network configuration for the commissionee device is similar to the process of the network configuration for the primary control device, which is not repeated here.

On the basis that the third-party device has enabled the management function of the second node, the third-party device may determine that the commissionee device is the second node. After the commissionee device is added to the virtual domain of the third-party device, the third-party device adds the node information of the commissionee device to the second node list to manage the commissionee device as the second node. The node information of the commissionee device may include a Node ID of the commissionee device in the virtual domain, and may also include device information of the commissionee device, such as an IP address, a port number, and a device name.

As a result, the third-party device has the basis for assigning a first node with a control privilege to the commissionee device.

S3802, the node information of the commissionee device is sent to at least one first node to cause the at least one first node to store the node information of the commissionee device to the second list, and the node information of the at least one first node is sent to the commissionee device to cause

the commissionee device to store the node information of the at least one first node to the first list.

The first node is a network device that is added to the virtual domain of the third-party device before the commissionee device. The at least one first node may be all of the first nodes corresponding to the first node list. The at least one first node may be a first node selected by the user from all the first nodes. The process of the third party device sending the node information of the commissionee device to the at least one first node, and the process of sending the node information of the at least one first node to the commissionee device, may refer to the process of the third party device sending the node information of the primary control device to the at least one second node, and the process of sending the node information of the at least one second node to the primary control device, which is not repeated here. Based on that the at least one first node is a first node selected by the user from all first nodes, the third-party device may display a primary control device list according to the first node list, and the primary control device list may include options for the first nodes. Taking the third-party device being a cell phone as an example, reference may be made to the primary control device list shown in FIG. 39, and based on that the first node list may include a smartphone and a smart TV, the cell phone displays a primary control device list which may include options for the smartphone and the smart TV. The user may select the first node to control the commissionee device on the basis of the option for the first node in the primary control device list.

On the basis of the above process, with the assistance of the third-party device, the user may newly add the network device to the virtual domain of the third-party device as the commissionee device, and the third-party device assigns to the commissionee device the first node with a control privilege that has been added to the virtual domain, so as to realize the effect of the network configuration by each first node for the commissionee device without the need of a direct network configuration by these first nodes for the commissionee device. Based on this, the commissionee device does not need to meet the camera, Bluetooth function, mobility and other harsh conditions, and may be compatible with commissionee devices of more device types and scenarios, expanding the scope of application of device interconnection.

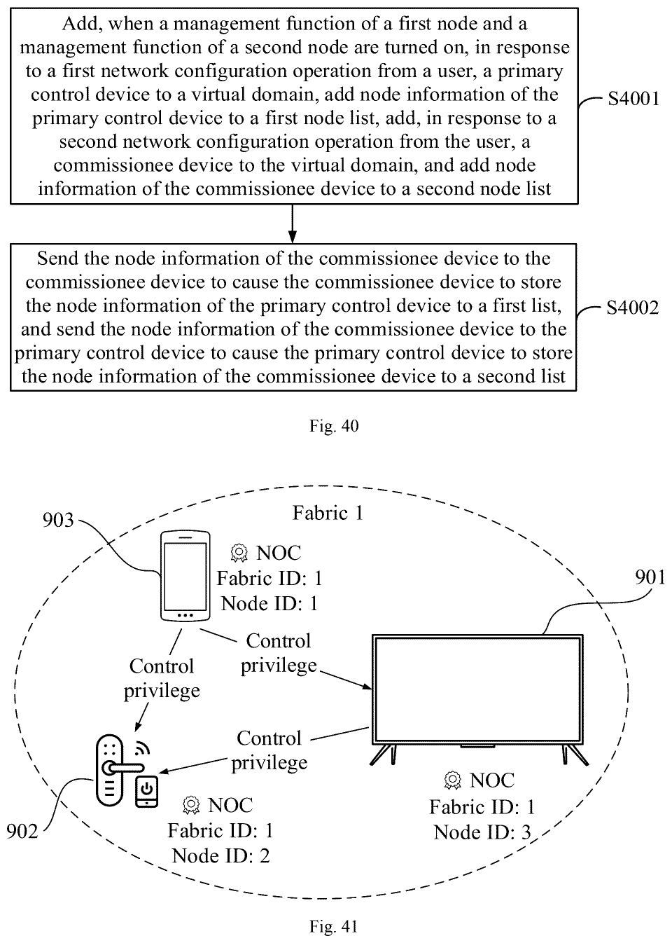

In some embodiments, the third-party device may assign a control privilege of the commissionee device newly added to the virtual domain to the primary control device newly added to the virtual domain according to a process shown in FIG. 40, which may include the following.

S4001, when the management function of the first node and the management function of the second node are turned on, in response to a first network configuration operation from the user, the primary control device is added to the virtual domain, and the node information of the primary control device is added to the first node list, and in response to the second network configuration operation from the user, the commissionee device is added to the virtual domain, and the node information of the commissionee device is added to the second node list.

The third-party device is secondarily developed on the basis of the Matter protocol so as to provide a new network configuration function. This new network configuration function may include the management function of the first node and the management function of the second node. When turning on the management function of the first node, the third-party device may set a network device newly added to the virtual domain as the first node and assign a control privilege of the second node to the network device. When turning on the management function of the second node, the third-party device may set a network device newly added to the

virtual domain as a second node, and assign the first node with a control privilege to the network device. The management function of the first node and the management function of the second node cannot be turned on at the same time so as to ensure that the third-party device accurately determines the current device of the network configuration as the first node or the second node.

S4002, node information of the commissionee device is sent to the commissionee device to cause the commissionee device to store the node information of the primary control device to the first list, and the node information of the commissionee device is sent to the primary control device to cause the primary control device to store the node information of the commissionee device to the second list.

In some embodiments, the third-party device can perform the network configuration for the primary control device before performing the network configuration for the commissionee device. After performing the network configuration for the primary control device, the third-party device may assign the control privilege of the second node that has been added to the virtual domain to the primary control device, or may cancel the assignment of the control privilege of the second node to the primary control device. After performing the network configuration for the commissionee device, the third-party device assigns the primary control device with the control privilege to the commissionee device to realize the network configuration between the primary control device and the commissionee device. The third-party device may further assign other first nodes with control privileges to the commissionee device.

In some other embodiments, the third-party device can perform the network configuration for the commissionee device before performing the network configuration for the primary control device. After performing the network configuration for the commissionee device, the third-party device may assign the first node with the control privilege that has been added to the virtual domain to the commissionee device, or may cancel the assignment of the first node with the control privilege to the commissionee device. After performing the network configuration for the primary control device, the third-party device assigns the primary control device with the control privilege to the commissionee device to realize the network configuration between the primary control device and the commissionee device. The third-party device may further assign control privileges of other second nodes to the primary control device.

The process of the third-party device assigning the control privilege of the commissionee device to the primary control device may refer to the process of the third-party device assigning the control privilege of the second node to the primary control device, and the process of the third-party device assigning the primary control device with the control privilege to the commissionee device may refer to the process of the third-party device assigning the first node with the control privilege to the commissionee device, neither of which is repeated here.

On the basis of the above process, with the assistance of the third-party device, the user may add the network devices that need to perform network configurations with each other to the virtual domain of the third-party device as the primary control device and the commissionee device respectively, and the third-party device assigns the control privilege of the commissionee device to the primary control device, so that there is no need for the primary control device to perform the network configuration directly to the commissionee device, realizing the effect of the primary control device performing the network configuration for the

commissionee device. Based on this, the primary control device and the commissionee device do not need to meet a camera, a Bluetooth function, mobility and other harsh conditions, and may be compatible with network devices of more device types and scenarios, expanding the scope of application of device interconnection.

An exemplary illustration of the process of an inter-device network configuration between the primary control device and the commissionee device on the basis of the third-party device is provided in conjunction with the following example.

FIG. 41 is a schematic diagram of a scenario in which a primary control device and a commissionee device perform an inter-device network configuration on the basis of a third-party device. Taking the primary control device being a smart TV 4101, the commissionee device being a smart door lock 4102, and the third-party device being a cell phone 4103 as an example, as shown in FIG. 41, the smart TV 4101 and the smart door lock 4102 are located in different rooms, e.g., the smart TV 4101 is located in a bedroom, and the smart door lock 4102 is located in a living room. The distance between the smart TV 4101 and the smart door lock 4102 is more than 10 meters, and the two cannot make a Bluetooth connection. After being installed, the smart TV 4101 and the smart door lock 4102 are not easy to move. When the user needs to control the smart door lock 4102 through the smart TV 4101, it is impossible that a network configuration is performed on the smart door lock 4102 directly through the smart TV 4101 to obtain a control privilege over the smart door lock 4102.

The user may assign the control privilege to the smart door lock 4102 for the smart TV 4101 through the cell phone 4103. The cell phone 4103 is integrated with a Matter protocol and, after secondary development on the basis of the Matter protocol, has a management function of the first node and a management function of the second node.

When the cell phone 4103 turns on the management function of the first node, the user may scan a two-dimensional code provided by the smart TV 4101 through the cell phone 4103 to perform the network configuration on the smart TV 4101. After the smart TV 4101 is added to a virtual domain (e.g., Faric1) of the cell phone 4103, the cell phone 4103 assigns a NOC to the smart TV 4101, and the NOC may include a Node ID of the smart TV 4101 in Faric1, e.g., Node ID: 2. The cell phone 4103 stores the node information (which may include the Node ID: 2, device information, etc.) of the smart TV 4101 to the second list, and thus the cell phone 4103 may be determined to have the control privilege of the smart device 4101. Accordingly, the cell phone 4103 can send the node information (which may include the Node ID of the cell phone 4103 in Faric1, such as a Node ID: 1, and device information) to the smart TV 4101 to cause the smart TV 4101 to store the node information of the cell phone 4103 to the first list in the device, and thus, the smart device 4101 may determine that the cell phone 4103 has the control privilege. The cell phone 4103 determines the smart TV 4101 as the first node and stores the node information of the smart TV 4101 to the first node list. The cell phone 4103 may send a node of the smart TV 4101 to at least one second node corresponding to the second node list, and as an example, the second node list may include node information of a smart watch and a smart soundbox, the cell phone 4103 may send the node information of the smart TV 4101 to the smart watch and the smart soundbox one by one. The smart watch and smart soundbox receive and store the node information of the smart TV 4101 into the first list in the device. As a result, the smart watch and smart soundbox may determine that the smart TV 4101

has the control privilege. The node information of the smart watch and the smart soundbox may further be sent from the cell phone 4103 to the smart TV 4101 and is stored by the smart TV 4101 into the second list in the device, so that the smart TV 4101 may be determined to have control privileges of the smart watch and the smart soundbox.

When the cell phone 4103 turns on the management function of the second node, the user may scan a two-dimensional code provided by the smart door lock 4102 through the cell phone 4103 to perform the network configuration on the smart door lock 4102. After the smart door lock 4102 is added to Fabric1, the cell phone 4103 assigns a NOC to the smart door lock 4102, and the NOC may include a Node ID of the smart door lock 4102 in Fabric1, such as a Node ID: 3. The cell phone 4103 stores the node information (which may include the Node ID: 3, device information, etc.) of the smart door lock 4102 to the second list, and thus the cell phone 4103 may be determined to have the control privilege of the smart door lock 4102. Accordingly, the cell phone 4103 can send the node information to the smart door lock 4102 to cause the smart door lock 4102 to store the node information of the cell phone 4103 to the first list in the device, and thus the smart door lock 4102 can determine that the cell phone 4103 has the control privilege. The cell phone 4103 determines the smart door lock 4102 as the second node and stores the node information of the smart door lock 4102 to the first node list. The cell phone 4103 may send the node information of the smart door lock 4102 to the smart TV 4101 in accordance with the first node list, and the smart TV 4101 receives and stores the node information of the smart door lock 4102 into the second list in the device. As a result, the smart TV 4101 may be determined to have the control privilege of the smart door lock 4102. The node information of the smart TV 4101 is further sent from the cell phone 4103 to the smart door lock 4102 and is stored by the smart door lock 4102 into the first list in the device, so that the smart door lock 4102 may determine that the smart TV 4101 has the control privilege. The cell phone 4103 may further send the node information of the smart door lock 4102 to other first nodes in the first node list, and as an example, the first node list may include the smart TV 4101, and a tablet computer, the cell phone 4103 may also send the node information of the smart door lock 4102 to the tablet computer to enable the tablet computer to have the control privilege of the smart door lock 4102.

On the basis of the above process, as shown in FIG. 41, the cell phone 4103 has the control privileges of both the smart TV 4101 and the smart door lock 4102 at the same time, and may control the smart TV 4101 and the smart door lock 4102 in Fabric 1. The smart TV 4101 obtains the control privilege of the smart door lock 4102 with the assistance of the cell phone 4103, and may also control the smart door lock 4102 in Fabric 1. As a result, the problem that the smart TV 4101 cannot directly perform the network configuration for the smart door lock 4102 may be solved, and device interconnection between the smart TV 4101 and the smart door lock 4102 is realized.

The primary control device (the first node) may control the commissionee device after obtaining the control privilege of the commissionee device (the second node) on the basis of the third-party device. The commissionee device may broadcast device information, such as an IP address and a port number, in the virtual domain through the mDNS protocol. The primary control device may receive the device information broadcast by the commissionee device in the virtual domain and determine whether it has the

control privilege of the commissionee device on the basis of the node information of the commissionee device recorded in the second list. After being determined to have the control privilege of the commissionee device, the primary control device may establish a Wi-Fi connection with the commissionee device according to the device information of the commissionee device, such as an IP address, and establish a second security session on the basis of the NOC held by each of them and the Wi-Fi connection so as to control the commissionee device through the second security session. After receiving a command sent from the primary control device, the commissionee device may obtain the node information of the primary control device through parsing. The commissionee device determines whether the primary control device has the control privilege according to the node information of the primary control device recorded in the first list, and executes a corresponding task in response to the command after determining that the primary control device has the control privilege.

The user may delete the control privilege of the first node over the second node through the third-party device.

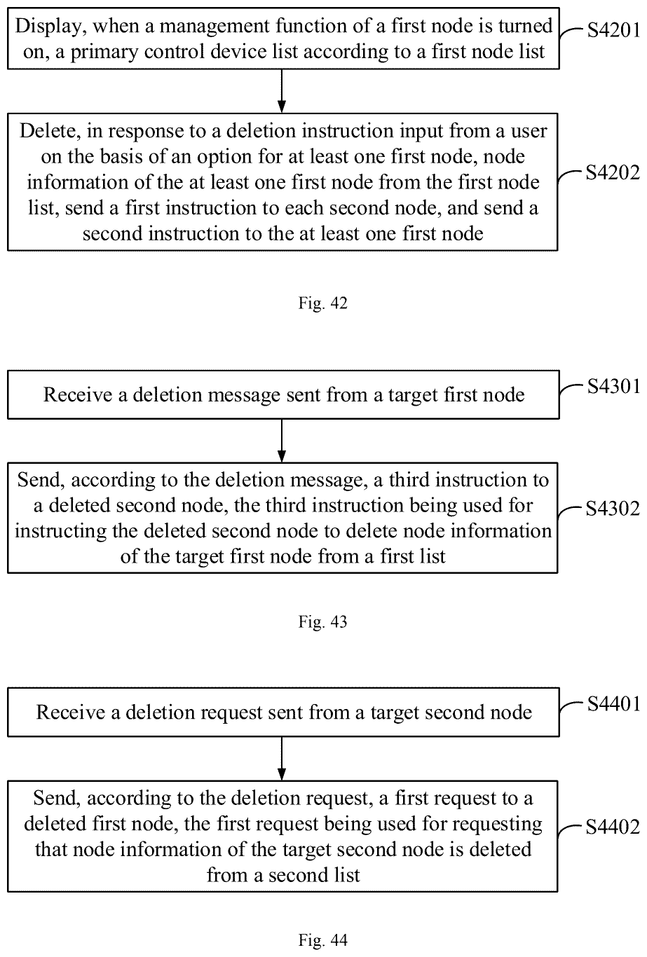

In some embodiments, the third-party device may delete the control privilege of the first node over the second node in accordance with a process shown in FIG. 42, which may include the following.

S4201, when the management function of the first node is turned on, the primary control device list is displayed according to the first node list.

The primary control device list may include an option for the first node.

S4202, in response to a deletion instruction input from the user on the basis of an option for the at least one first node, the node information of the at least one first node is deleted from the first node list, a first instruction is sent to each second node, and a second instruction is sent to the at least one first node.

When needing to delete the control privilege of the first node in the virtual domain of the third-party device over the second node, the user may select the option for the first node to be deleted on the basis of the primary control device list and input the deletion instruction. The third-party device will, in response to the deletion instruction, delete the node information of the selected first node from the first node list, so that these first nodes are no longer in a position to be assigned control privileges of the second node.

The third-party device further can send a first instruction to each second node, and the first instruction is used for instructing the second node to delete the node information of the at least one first node from the first list. After receiving the first instruction, each second node identifies whether node information of these first nodes exists in the first list. If yes, the node information of these first nodes is deleted from the first list. As a result, each second node may determine that these first nodes no longer have control privileges.

The third-party device further can send a second instruction to the at least one first node, and the second instruction is used for instructing the first node to delete the node information of each second node from the second list. After receiving the second instruction, the at least one first node identifies the node information of the second node recorded in the second list and deletes the node information of each second node from the second list. As a result, the at least one first node may be determined to no longer have the control privilege of each second node.

On the basis of the above process, the user may delete the control privilege

of the first node for the second node in a batch mode on the basis of the first node list and the second node list of the third-party device, the user does not need to go back and forth to the first node and the second node to perform operations respectively, but may complete the change of the control privileges directly on the basis of the third-party device, and thus the operation is more convenient.

In some other embodiments, the third-party device may delete the control privilege of the first node over the second node in accordance with a process shown in FIG. 43, which may include the following.

S4301, a deletion message sent from a target first node is received.

When the user wants to cancel the control for the target first node over the second node, the user may perform a deletion operation on the target first node. For example, the user may send a command to the target first node to cause the target first node to display the commissionee device list to which it has control privileges, and the commissionee device list may include an option for each second node controlled by the target first node. The user may input a deletion instruction on the basis of the options for the second nodes that the user wants to de-control, the target first node, in response to the deletion instruction, deletes the node information of these second nodes from the second list, and thus the target first node may determine that it no longer has the control privileges of these second nodes. The target first node further can send a deletion message to the third-party device, and the deletion message may include node information of the deleted second node.

S4302, according to the deletion message, a third instruction is sent to the deleted second node.

According to the received deletion message, the third-party device determines the target first node, and the deleted second node. The third party device can generate a third instruction and can send the third instruction to the deleted second node. The third instruction is used for instructing the deleted second node to delete the node information of the target first node from the first list, and the deleted second node, in response to the third instruction, deletes the node information of the target first node from the first list. As a result, each deleted second nodes may determine that the target first node no longer has control privileges.

On the basis of the above process, the user may purposefully cancel the control for the second node on the first node and synchronize the node information of the first node with control privileges in the deleted second node through the third-party device, without having to perform the corresponding deletion operation on the second node, which may effectively simplify the user operation.

In some other embodiments, the third-party device may delete the control privilege of the first node over the second node in accordance with a process shown in FIG. 44, which may include the following.

S4401, a deletion request sent from a target second node is received.

When the user wants to cancel the control for the first node over the target second node, the deletion request may be sent from the target second node. For example, the user may send a command to the target second node to cause the target second node to display a primary control device list having control privileges over it, and the primary control device list may include an option for each first node controlling the target second node. The user may input a deletion instruction on the basis of the option for the first node whose control the user wants to cancel, the target second node can send the deletion request to the third-party device

in response to the deletion instruction, and the deletion request may include node information of the deleted first node.

S4402, according to the deletion request, a first request is sent to the deleted first node.

The third-party device determines the target second node, and the deleted first node according to the received deletion request. The third-party device can generate a first request and can send the first request to the deleted first node. The first request is used for requesting that the node information of the target second node is deleted from the second list, and the deleted first node, in response to the first request, determines whether the control over the target second node may be canceled. For example, the deleted first node, in response to the first request, may display or broadcast inquiry information, such as “whether to cancel the control over the target second node”, and deletes the node information of the target second node from the second list after receiving a determination command from the user. As a result, the deleted first node may be determined to no longer have the control privilege for the target second node.

In some embodiments, the third-party device may generate inquiry information for each deleted first node according to the deletion request, and directly display or play each piece of inquiry information, so that the user may directly input instructions on the basis of the third-party device with respect to the inquiry information to avoid the user traveling back and forth between the first node and the second node, which may effectively simplify the user operation.

Based on that the deleted first node deletes the node information of the target second node, the deleted first node may send back a deletion notification to the third party device, and the deletion notification may include the node information of the target second node that has been deleted. The third-party device may, according to the deletion notification, determine the deleted first node and the second node deleted by the first node, and generate a fourth instruction that is used for instructing the deletion of the node information of the first node from the first list. The third-party device can send the fourth instruction to the corresponding target second node, and the target second node deletes the node information of the corresponding first node from the first list in response to the fourth instruction. As a result, the target second node may determine that the deleted first node no longer has control privileges.

On the basis of the above process, the user may request the cancellation of the control from the first node through the second node, and synchronize the node information of the second node with the control privilege in the deleted first node through the third-party device.

In some other embodiments, the first node and the second node may also interact with instructions and requests to change control privileges on the basis of the Wi-Fi connection so as to complete the change of control privileges.

The Internet of Things is an Internet-based information carrier that allows all devices that can be independently addressed to form an interconnected network. In order to meet the needs of rapid product launch, as well as subsequent continuous updating and improvement, etc., an Internet of Things device will undergo system upgrades during use after the launch. The Internet of Things device may download

an upgrade package via an OTA technology and use the upgrade package for system upgrades, enabling incremental deployment.

In order to meet the needs of rapid product launch, as well as subsequent continuous updating and improvement, etc., an Internet of Things device will undergo system upgrades during use after the launch. The Internet of Things device may download an upgrade package via the Over The Air (OTA) technology and use the upgrade package for system upgrades, enabling incremental deployment.

Different Internet of Things devices may need to rely on different applications for system upgrades, e.g., these Internet of Things devices themselves need to download corresponding applications, and the user can perform OTA upgrades on the basis of the applications installed on the Internet of Things devices. Alternatively, based on that the Internet of Things device itself is not user-friendly for direct operation, the user can control the Internet of Things device via a control device to perform OTA upgrades to the Internet of Things device, in which case both the Internet of Things device and the control device need to install the same application. Based on that the same control device can control a plurality of Internet of Things devices for OTA upgrades, it is necessary to install an application corresponding to each Internet of Things device and control the corresponding Internet of Things device for the OTA upgrade on the basis of a different application respectively. This results in more stress on the control device and a more cumbersome upgrade operation for the user. Moreover, many Internet of Things devices may not be able to perform OTA upgrades independently due to the cost control or the communication protocol limitations, etc.

In order to solve the above problem, some embodiments of the present application provides a system upgrade method, wherein a smart device that is unable to perform an OTA upgrade independently can perform an OTA proxy upgrade by means of a display apparatus that can support an OTA upgrade proxy service, and the OTA proxy service provided by the display apparatus for the smart device does not need to rely on a specified application.

The OTA proxy upgrade is: the display apparatus downloads the upgrade package from the cloud server, and then the smart device downloads this upgrade package from the display apparatus and can use this upgrade package to upgrade the system. The display apparatus is an OTA Provider, and the display apparatus may provide OTA system upgrade proxy services. The display apparatus itself does not distinguish between device types; any type of device can act as an OTA Provider, and the display apparatus needs to access the Internet or access database resources that contain upgraded versions of software. The smart device is an OTA Requestor, cannot independently perform the OTA system upgrade, and needs to use the OTA Provider for the OTA system upgrade. The smart device can discover the OTA Provider in the added virtual domain (specified below) and query a new software version by sending a query request to the OTA Provider.

The smart device may be a non-display apparatus that does not have a visual interface, such as a smart door lock, a smart headphone, a smart stereo, a smart light, a smart air conditioner, a smart stove, and a smart bathroom. The non-display apparatus may include a communicating device, and the non-display apparatus may communicate with other Internet of Things devices through the communicating

device. In some embodiments, the smart device may also be a display apparatus having a visual interface, such as a display apparatus 200.

In embodiments of the present application, the concept of a virtual domain (Fabric) is introduced. Internet of Things devices may be divided into control devices and commissionee devices in accordance with functions, wherein each control device has a corresponding virtual domain, and the virtual domain may include a control device and all commissionee devices controlled by the control device. The control device and the commissionee device belonging to the same one virtual domain access the same one local area network (i.e., a specified network), and the virtual domain to which the devices in the virtual domain belong and their identities in the virtual domain are identified by Node Operational Certificates (NOCs) they hold. After performing a network configuration for the commissionee device, the control device marks the addition of the commissionee device to its own virtual domain by assigning the NOC to the commissionee device. The NOC held by each device in the virtual domain may include: a virtual domain identifier, such as a Fabric ID, used for uniquely identifying the virtual domain, and a node identifier, such as a Node ID, used for uniquely identifying the device in the virtual domain. That is, virtual domains of different control devices have different Fabric IDs, and the Node IDs of the devices in the same one virtual domain are different, but the Node IDs of the devices belonging to different virtual domains may be the same. Within the same one local area network, one or more virtual domains may be included, and there may be overlaps between the virtual domains.

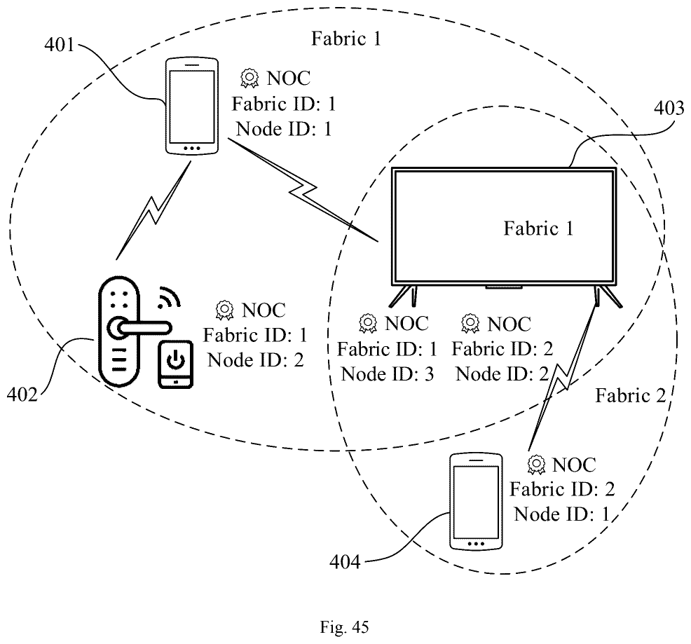

Reference may be made to FIG. 45 which is a schematic diagram of virtual domains in the same one wireless local area network, which may include virtual domains Fabric 1 and Fabric 2, as shown in FIG. 45, wherein Fabric 1 is a virtual domain of a cell phone 4501, Fabric 1 may also include a smart door lock 4502 and a TV 4503 controlled by the cell phone 4501, Fabric B is a virtual domain of a cell phone 404, and Fabric 2 may further include the TV 4503 controlled by the cell phone 404. The NOC held by the cell phone 4501 may include a Fabric ID: 1 and a Node ID: 1. The smart door lock 4502 holds a NOC assigned by the cell phone 4501, and the NOC may include a Fabric ID: 1 and a Node ID: 2. The TV 4503 holds a NOC assigned by the cell phone 4501, and the NOC may include a Fabric ID: 1 and a Node ID: 3. The TV 4503 further holds a NOC assigned by the cell phone 404, and the NOC may include a Fabric ID: 2 and a Node ID: 2. The NOC held by the cell phone 404 may include a Fabric ID: 2 and a Node ID: 1.

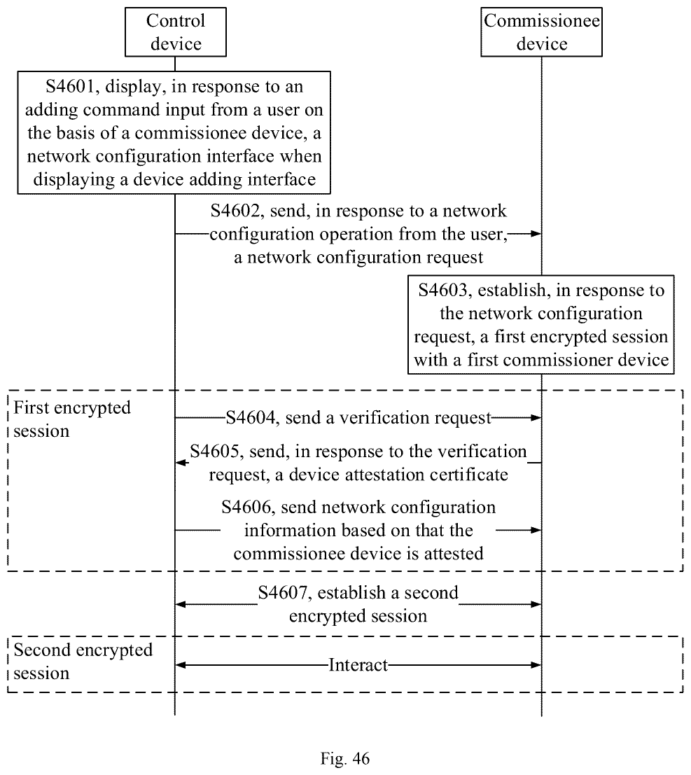

A process of the control device adding the commissionee device to a virtual domain may be referred to as a network configuration process, and a process of the control device performing a network configuration for the commissionee device may refer to FIG. 46 and may include the following.

S4601, the control device, in response to an adding command input from a user on the basis of the commissionee device, displays a network configuration interface when displaying a device adding interface.

The device adding interface may include the commissionee device discovered by the control device, and one or more commissionee devices may be provided.

The adding command is used for instructing a commissionee device that is waiting for a network configuration.

In the present application, the control device does not directly add the

commissionee device as the commissionee device, but rather ensures the security of controlling the operation of the commissionee device through a process of the network configuration for the commissionee device. Thus the control device, in response to the adding command, displays a network configuration interface. The network configuration interface is used for the user to perform the network configuration operation on the commissionee device.

S4602, the control device, in response to the network configuration operation from the user, sends a network configuration request to the commissionee device.

The network configuration operation is used for obtaining the passcode provided by the commissionee device. The network configuration operation may be scanning a two-dimensional code carried on the commissionee device, which is associated with the passcode, or inputting a pairing code of the commissionee device, which is used for requesting the passcode, or establishing Near Field Communication (NFC) with the commissionee device to obtain the passcode from the commissionee device via NFC communication, etc.

S4603, the commissionee device, in response to the network configuration request sent from the control device, establishes a first encrypted session with the control device.

The commissionee device and the control device establish the first encrypted session on the basis of the passcode provided by the commissionee device and a session protocol. The session protocol may be a Passcode-Authenticated Session Establishment (PASE) protocol.

S4604, the control device sends a verification request to the commissionee device via the first encrypted session.

S4605, the commissionee device, in response to the verification request sent from the control device via the first encrypted session, sends a device attestation certificate to the control device via the first encrypted session.

The control device and the commissionee device are protected by the first encrypted session, and the control device can perform device verification on the commissionee device on the basis of the device attestation certificate provided by the commissionee device, so as to ensure the validity of the commissionee device through the above verification process.

S4606, the control device, based on that the commissionee device is identified to be attested according to the device attestation certificate, sends network configuration information to the commissionee device through the first encrypted session, and, after the network configuration for the commissionee device, displays a commissionee device interface.

After the commissionee device is attested, the control device, via the first encrypted session, can send the network configuration information to the commissionee device to add the commissionee device to the virtual domain of the control device. The network configuration information may include a NOC assigned by the control device to the commissionee device. Based on that the commissionee device does not access the specified wireless network, e.g., a Bluetooth device that cannot independently access the wireless network, etc., or a device that has accessed a wireless network that is different from the specified wireless network, etc., the network configuration information may further include network interface configuration information, which

is used for the commissionee device to access the specified wireless network where the control device is located.

S4607, the control device and the commissionee device establish a second encrypted session and interact via the second encrypted session.

The control device and the commissionee device may establish the second encrypted session on the basis of a NOC held by each of them and a session protocol. The session protocol may be a Sigma protocol, and the established second encrypted session may be a Certificate-Authenticated Session Establishment (CASE) session.

The interaction between the control device and the commissionee device via the second encrypted session may ensure the security of the control over the commissionee device by the control device, as well as avoid the interference in the commissionee device by other control devices.

The commissionee device may be added to the virtual domain of at least one control device in accordance with the above network configuration process. A control privilege of each control device for the commissionee device may be managed. For example, the control device of the first virtual domain to which the commissionee device is added is configured with an administrator privilege, i.e., the highest privilege. The control device with the administrator privilege may control the commissionee device to be added to virtual domains of other control devices, as well as set control privileges of other control devices. The commissionee device may accurately respond to commands of different control devices on the basis of the control privilege of each control device, avoiding interference between the control devices as well as avoiding overstepping the privilege of each control device.

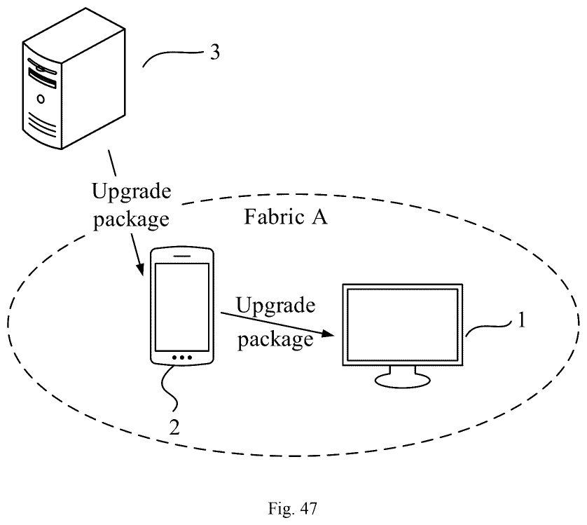

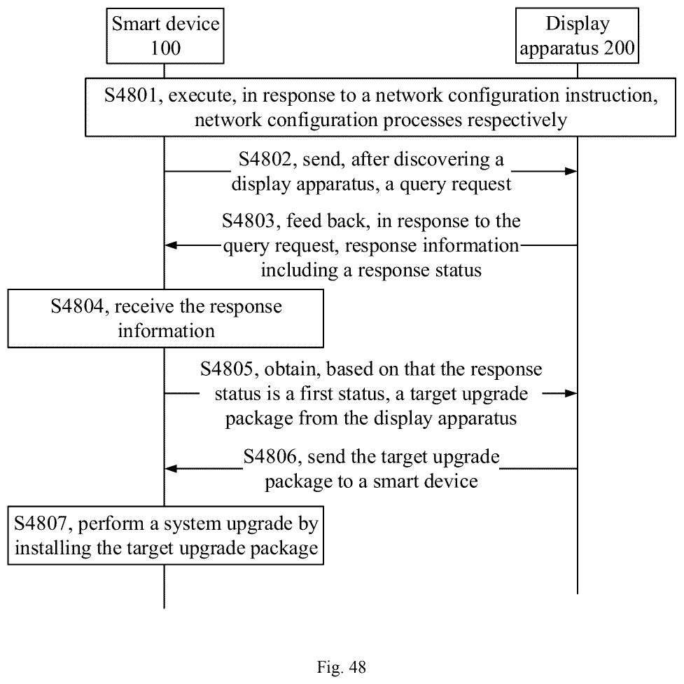

In some embodiments of the present application, the display apparatus and the smart device for performing the OTA proxy upgrade are set as two Internet of Things devices located in the same one virtual domain, i.e., the smart device can perform the OTA proxy upgrade through the display apparatus located in the same one virtual domain. Referring to a schematic diagram of a scenario shown in FIG. 47, the smart device 100 and the display apparatus 200 are located in the same Fabric, e.g., Fabric A. The smart device 100 may download an upgrade package from a cloud server 3 via the display apparatus 200 to perform the OTA upgrade. A process of a system upgrade by the smart device 100 via the display apparatus 200 may refer to a process shown in FIG. 48 and may include the following.

S4801, the smart device and the display apparatus, in response to a network configuration instruction, perform network configuration processes respectively.

A process of the smart device 100 and the display apparatus 200 being added to the virtual domain may be divided according to roles of the two in the virtual domain (the control device and the commissionee device), wherein the control device has a function of performing a network configuration for the commissionee device, and thus the control device may also be referred to as a configuration device; and the commissionee device has a function of receiving the network configuration by the control device, and thus the commissionee device may also be referred to as a to-be-configured device.

A scenario in which the smart device 100 and the display apparatus 200 may be located in the same one virtual domain is discussed below.

In a scenario, based on that the smart device 100 is a configuration device

and the smart device 100 discovers the display apparatus 200 and can perform a network configuration for the display apparatus 200, i.e., the display apparatus 200 is a to-be-configured device, the display apparatus 200 will be added to the virtual domain of the smart device 100. At this time, the smart device 100 and the display apparatus 200 are located in the same one virtual domain, which is a virtual domain of the smart device 100. A process of the smart device 100 performing the network configuration for the display apparatus 200 may refer to steps S501-S507, which is not repeated here.

In a scenario, based on that the display apparatus 200 is a configuration device and the display apparatus 200 discovers the smart device 100 and can perform a network configuration for the smart device 100, i.e., the smart device 100 is a to-be-configured device, the smart device 100 will be added to the virtual domain of the display apparatus 200. At this time, the smart device 100 and the display apparatus 200 are located in the same one virtual domain, which is a virtual domain of the display apparatus 200. A process of the display apparatus 200 performing the network configuration for the smart device 100 may refer to steps S501-S507, which is not repeated here.

In a scenario, based on that both the smart device 100 and the display apparatus 200 are to-be-configured devices, and another device, such as a first device, discovers the smart device 100 and the display apparatus 200 and can perform network configurations for the smart device 100 and the display apparatus 200, i.e., that first device is a configuration device, both the smart device 100 and the display apparatus 200 will be added to the virtual domain of the first device. At this time, the smart device 100 and the display apparatus 200 are located in the same one virtual domain, which is a virtual domain of the first device. A process of the first device performing the network configurations for the smart device 100 and the display apparatus 200 may refer to steps S501-S507, which is not repeated here.

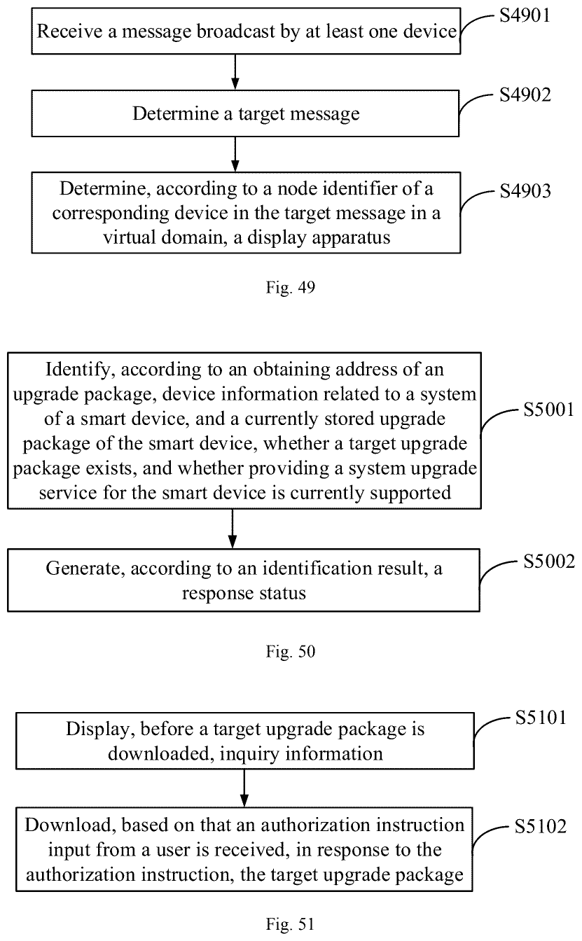

The premise of the smart device 100 being capable of performing the OTA proxy upgrade via the display apparatus 200 is to determine the display apparatus 200 that can support providing an OTA proxy service in the same one virtual domain. The smart device 100 may identify the display apparatus 200 in accordance with a process shown in FIG. 49, which may include the following.

S4901, a message broadcast by at least one device is received.

The at least one device provides a device discovery service outward, and on the basis of the device discovery service, broadcasts the message outward. The at least one device and the smart device 100 may be located in the same one virtual domain or in different virtual domains.

The message broadcast by the at least one device may include: an identifier of the virtual domain in which the corresponding device is located, a node identifier of the corresponding device in the virtual domain, and a device identifier of the corresponding device. A device ID is used for indicating whether the corresponding device provides a system upgrade proxy service.

In some embodiments, the smart device 100 may receive messages broadcast by other devices according to a preset period, i.e., the smart device 100 identifies the display apparatus 200 according to the preset period.

In some embodiments, the smart device 100 may actively obtain messages

broadcast by other devices in response to commands from the user, i.e., the smart device 100 actively searches for the display apparatus 200. For example, the smart device 100 is a non-display apparatus 100, and the smart device 100 may actively search for the display apparatus 200 in response to a voice command from the user. Or, the smart device 100 actively searches for the display apparatus 200 in response to a reset operation from the user. For another example, the smart device 100 is a display apparatus 20000, may display an upgrade option, and may actively search for the display apparatus 200 in response to a command input from the user on the basis of the upgrade option.

S4902, a target message is determined.

The target message is determined according to an identifier of a virtual domain and a device identifier in the message broadcast by each device. The identifier of the virtual domain in which the corresponding device in the target message is located is the same as the identifier of the virtual domain in which the smart device 100 is located, i.e., the corresponding device of the target message is located in the same one virtual domain as the smart device 100. The device identifier of the corresponding device in the target message indicates that a software upgrade proxy service is provided, i.e., the corresponding device of the target message is a device that can support the OTA upgrade proxy service.

S4903, the display apparatus is determined according to the node identifier of the corresponding device in the target message in the virtual domain.

The corresponding device of the target message may be determined to be the display apparatus 200, and specifically the display apparatus 200 may be located in the virtual domain according to the node identifier of the corresponding device in the target message in the virtual domain. As a result, the smart device 100 discovers the display apparatus 200.

In some embodiments, the smart device 100 identifies the display apparatus 200, stopping a discovery process for other devices in the current round.

In some embodiments, based on that the smart device 100 identifies a plurality of devices that may serve as display apparatuses, the smart device 100 may determine the display apparatus 200 from the plurality of devices in accordance with an order in which the broadcasts are received, a communication quality, etc.

In some embodiments, based on that the smart device 100 identifies a plurality of devices that may serve as display apparatus, and the smart device 100 is the display apparatus 20000, the smart device 100 may display a display apparatus list, which may include the plurality of devices that may serve as the display apparatuses. The smart device 100 may, in response to a selective command from the user on the basis of a display apparatus, use a device selected by the user as the display apparatus 200.

S4802, the smart device, after discovering the display apparatus, sends a query request to the display apparatus.

The query request is used for querying the display apparatus 200 for the existence of a target upgrade package used by the smart device 100 to perform a system upgrade. The target upgrade package may be an upgrade package of a version higher than the current version of the system of the

smart device 100, such as an upgrade package of the latest version. The upgrade package may be an image file (Image).

The query request may include device information related to the system of the smart device 100, a current version of the system, and an address for obtaining an upgrade package. Information of each part of the query request may be represented in corresponding fields.

Device information related to the system of the smart device 100 may include: a vendor identifier, a product identifier, a hardware version, and a supported download protocol (which is a protocol for downloading an upgrade package from the display apparatus 200). The current version of the system is the software version. The address for obtaining the upgrade package is an address in the cloud server 3 of a database where the upgrade package for the smart device 100 is located.

The query request may also include whether the smart device 100 can support a user interface, as well as prompting the user for authorization via a pop-up window.

The user may add a vendor identifier in a Vendor ID field, a product identifier in a Product ID field, the current version of the system in a Software Version field, a supported download protocol in Protocols Supported, a hardware version in Hardware Version, the obtaining address of the upgrade package in Location, and whether a user interface is supported in Requestor Can Consent, and the user is prompted for authorization through a pop-up window.

A data structure of the query request may refer to Table 1.

TABLE 1

| ID | Name | Type | conformance | comments |
|---|---|---|---|---|
| 0 | Vendor ID | uint16 | M | Vendor ID |
| 1 | Product ID | uint16 | M | Product ID |
| 2 | SoftwareVersion | Uint32 | M | SoftwareVersion |
| 3 | ProtocolsSupported | procotolEnum | M | Supported download transmission |
| | | | | protocol |
| 4 | HardwareVersion | Uint16 | O | HardwareVersion |
| 5 | Location | String | O | Address for obtaining updated version |
| 6 | RequestorCanConsent | bool | O | If the device can support the user |
| | | | | interface, the user can be prompted for |
| | | | | authorization through a pop-up |
| | | | | window |

S4803, the display apparatus, in response to the query request of the smart device, feeds back response information to the smart device, and the response information may include a response status.

The response status of the display apparatus 200 may be identified by a Status field in the response information. The response status of the display apparatus 200 is used for indicating whether a target upgrade package for the smart device 100 exists in the display apparatus 200, and whether providing a system upgrade proxy service for the smart device 100 is currently supported.

The display apparatus 200 may obtain the response status in accordance with the process shown in FIG. 50, which may include the following.

S5001, according to the obtaining address of the upgrade package, the device information related to the system of the smart device, and the currently stored upgrade package of the smart device, whether a target upgrade package exists is identified, and whether providing the system upgrade service for the smart device is currently supported is identified.

The display apparatus 200, according to the obtaining address of the upgrade package and the device information associated with the system of the smart device, may determine the latest version of the upgrade package of the system of the smart device 100 from the database of the upgrade package of the smart device 100, as well as determine whether the latest version is the same as the current version of the system of the smart device 100. Based on that the latest version is the same as the current version of the system of the smart device 100, the smart device 100 currently holds the latest version of the system and does not require a system upgrade. Based on that the latest version is different from the current version of the system of the smart device 100, the smart device 100 needs a system upgrade.

Based on that it is identified that the smart device 100 needs a system upgrade, the display apparatus 200 further identifies whether the current download of the target upgrade package from the cloud server 3 is completed. Based on that the target upgrade package has been downloaded, the target upgrade package already exists. Based on that the target upgrade package has not been downloaded, the target upgrade package does not exist.

The display apparatus 200 also needs to identify whether providing a system upgrade service for the smart device 100 is currently supported. Based on that the display apparatus 200 is providing system upgrade services for other devices, the display apparatus 200 is currently verifying whether the upgrade package can be obtained in accordance with the obtaining address of the upgrade package, the display apparatus 200 is currently downloading the target upgrade package from the cloud server 3, the display apparatus 200 is currently verifying whether the download protocol supported by the smart device 100 is supported, and the display apparatus 200 determines that the download protocol supported by the smart device 100 is not supported, then the display apparatus 200 recognizes that providing the system upgrade service for the smart device 100 is not currently supported.

S5002, a response status is generated according to a recognition result.

The display apparatus 200 can generate different response statuses

according to the recognition results, and the response statuses of the display apparatus 200 may include a first status, a second status, a third status, and a fourth status.

The first status is that the target upgrade package already exists in the display apparatus 200, and the display apparatus 200 currently can support providing the system upgrade service for the smart device 100. The first status may be represented as update available.

The second status is that the smart device 100 requires a system upgrade, while the display apparatus 200 is providing system upgrade services for other devices, the display apparatus 200 is currently verifying whether the upgrade package can be obtained in accordance with the obtaining address of the upgrade package, the display apparatus 200 is currently downloading the target upgrade package from the cloud server 3, and the display apparatus 200 is currently verifying whether the download protocol supported by the smart device 100 is supported. The second status may be represented as busy. The display apparatus 200 is providing system upgrade services to other devices, may provide a download transmission service to other devices, or is downloading an upgrade package.

The third status is that the smart device 100 does not require a system upgrade. The third status is represented as not available.

The fourth status is that the display apparatus 200 does not support the download protocol supported by the smart device 100. The fourth status is represented as download protocol not supported.

In some embodiments, based on that the target upgrade package used by the smart device 100 to perform the system upgrade does not exist in the display apparatus 200, the display apparatus 200, in response to the query request, further needs to download the target upgrade package from the cloud server 3.

In some embodiments, the display apparatus 200 recognizes that the smart device 100 requires a system upgrade, the display apparatus 200 confirms that the target upgrade package can be obtained from the cloud server 3, as well as can support a download protocol supported by the smart device 100, and the display apparatus 200 responds to the query request to instantly download the target upgrade package from the cloud server 3. For example, the display apparatus 200 suspends other tasks currently being executed, such as other download tasks, and prioritizes the execution of an OTA proxy upgrade service for the smart device 100, prioritizing the downloading of the target upgrade package from the cloud server 3 for the smart device 100.

Alternatively, the display apparatus 200, in response to the query request, delays downloading the target upgrade package from the cloud server 3. For example, the display apparatus 200 prioritizes the execution of other tasks, such as other download tasks, etc., and executes the OTA proxy upgrade service for the smart device 100 after the other tasks are executed.

The display apparatus 200 may download the target upgrade package from the cloud server according to a process as shown in FIG. 51, which may include the following.

S5101, inquiry information is displayed before downloading the target upgrade package.

The display apparatus 200 may display the inquiry information based on that it identifies that the target upgrade package does not exist and determines that the target upgrade package can be downloaded from the cloud server 3. This inquiry information is used for inquiring whether the user authorizes

the download process of the target upgrade package. For example, based on that the display apparatus 200 is a non-display apparatus 100, the display apparatus 200 may display the inquiry information by playing a voice or the like, such as playing a voice “whether to agree to perform a proxy upgrade for the smart device xx”. Based on that the display apparatus 200 is a display apparatus 20000, the display apparatus 200 may display inquiry information, such as displaying the text “Do you agree to perform a proxy upgrade for the smart device xx”.

S5102, based on that an authorization instruction input from the user is received, in response to the authorization instruction, the target upgrade package is downloaded from the cloud server.

The OTA proxy upgrade service to the smart device 100 is managed through the user of the display apparatus 200. Based on that the user agrees to provide the OTA proxy upgrade service for the smart device 100, the user may input the authorization instruction to authorize the display apparatus 200 to be able to download the target upgrade package from the cloud server 3. Based on that the user does not agree to provide the OTA proxy upgrade service for the smart device 100, the user may input a prohibit instruction to prohibit the display apparatus 200 from downloading the target upgrade package from the cloud server 3.

In some embodiments, based on that the display apparatus 200 is in the first status, the response information of the display apparatus 200 may also include an upgrade package address (Image URI) field, a Software Version field, and a Software Version String.

The Image URL field is used for adding address information of the target upgrade package in the display apparatus 200, according to which the smart device 100 can obtain the target upgrade package from the display apparatus 200. The software version field is used for adding the version corresponding to the target upgrade package (which may be referred to as the version to be upgraded). The Software Version String field is used for adding the string version corresponding to the target upgrade package. The smart device 2 can determine the version to be upgraded corresponding to the target upgrade package according to the above fields, and then accurately obtain the target upgrade package from the display apparatus 200 according to the version to be upgraded.

In some embodiments, the display apparatus 200 may also add a Delayed Action Time field in the response information, and add a timeout period in the Delayed Action Time field. Based on that the display apparatus 200 does not receive an instruction sent from the smart device 100, such as a re-initiated query request, and a download request, within this timeout period, the display apparatus 200 stops providing the smart device 100 with the current system upgrade proxy service, so as to avoid the display apparatus 200 being occupied by the smart device 100 for a long period of time and not being able to provide the other devices with the OTA proxy upgrade service. Accordingly, the smart device 100 can send an instruction to the display apparatus 1 within the timeout period according to the timeout period in the Delayed Action Time field to ensure the action of this OTA proxy upgrade process.

In some embodiments, the display apparatus 200 may also add a User Consent Needed field to the response information for adding whether or not the display apparatus 200 can support a user interface and can support prompting the user for authorization via a pop-up window.

A data structure of the response information may refer to Table 2.

TABLE 2

| ID | Name | Type | conformance | comments |
|---|---|---|---|---|
| 0 | Status | StatusEnum | M | Response status |
| 1 | DelayedActionTime | Uint32 | O | Waiting time |
| 2 | ImageURI | String | O | Image download address |
| 3 | SoftwareVersion | uint32 | O | SoftwareVersion |
| 4 | SoftwareVersionString | String | O | Software Version String |
| 5 | UpdateToken | octstr | O | Token |
| 6 | UserConsentNeeded | bool | O | If the device supports the user |
| | | | | interface, the user can be prompted |
| | | | | for authorization through a pop-up |
| | | | | window |

In some embodiments, based on that the display apparatus 200 is a configuration device, the user may PR4T control the system upgrade of the smart device 100 through the display apparatus 200. For example, a user may input a command to the display apparatus 200 for performing a system upgrade for the smart device 100. The command is equivalent to a query request sent from the user, and the display apparatus 200 obtains the response status in response to the command and returns the response information to the smart device 100 without the need for the smart device 100 to send a query request to the display apparatus 200.

S4804, the smart device receives the response information returned from the display apparatus.

The response information may include a response status of the display apparatus 200, as described with reference to step S4803. According to the response status of the display apparatus 200, the smart device 100 can determine whether a system upgrade is required, and whether an OTA proxy upgrade is currently available through the display apparatus 200.

S4805, based on that the response status is the first status, the smart device obtains the target upgrade package from the display apparatus.

For example, based on that the smart device 100 identifies update available from the Status field of the response information, the smart device 100 may determine that the display apparatus 200 is in the first status. When the display apparatus 200 is in the first status, the smart device 100 may also obtain address information of the target upgrade package in the display apparatus 200 from the Image URI field of the response information, and obtain the version to be upgraded corresponding to the target upgrade package from the Software Version field of the response information.

The smart device 100 obtains the target upgrade package from the display

apparatus 200 according to the address information of the target upgrade package in the display apparatus 200, and the version to be upgraded corresponding to the target upgrade package.

S4806, the display apparatus sends the target upgrade package to the smart device when the response status is the first status.

In some embodiments, based on that the display apparatus 200 identifies that the current response status is the first status, the display apparatus 200 may actively send the target upgrade package to the smart device 100.

In some embodiments, upon receiving a download request sent from the smart device 100, the display apparatus 200 can send the target upgrade package to the smart device 100 based on that it is determined that the current response status is the first status. The download request sent from the smart device is used for requesting the download of the target upgrade package from the display apparatus 200. The download request may carry the address information of the target upgrade package in the display apparatus 200, the corresponding version to be upgraded, and other information.

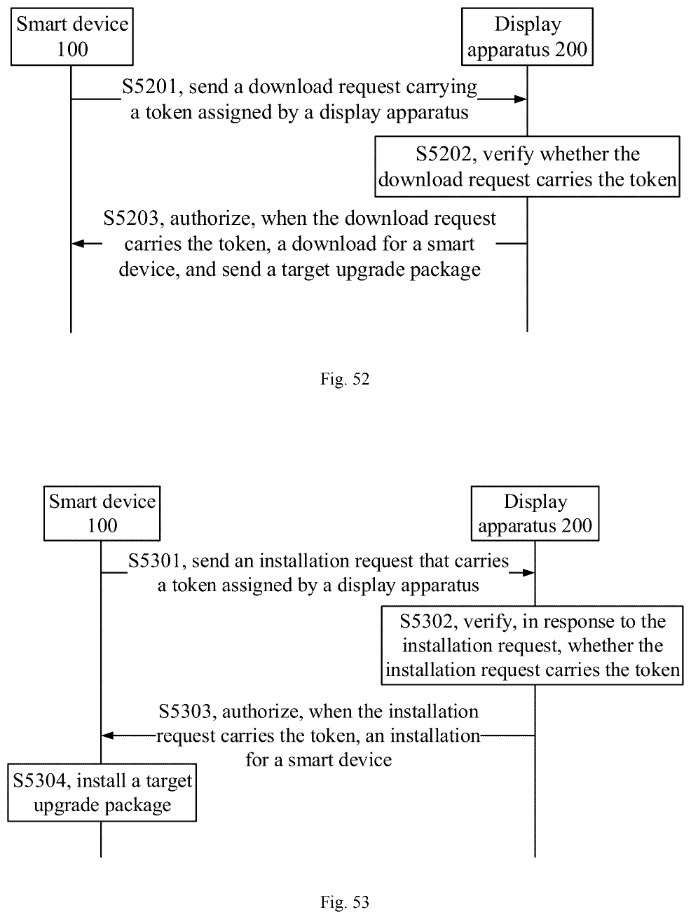

In order to ensure the security of the transmission of the target upgrade package between the smart device 100 and the display apparatus 200, the download process of the smart device 100 downloading the target upgrade package from the display apparatus 200 may be protected by a Token. The display apparatus 200 adds an Update Token field in the response information fed back to the smart device 100, the update token field is used for carrying the token assigned by the display apparatus 200 for the smart device 100, and the token is used for verifying authorization. The process of the smart device 100 downloading the target upgrade package from the display apparatus 200 may refer to FIG. 52, which may include the following.

S5201, the smart device sends a download request to the display apparatus, wherein the download request carries the token assigned by the display apparatus.

The smart device 100 requests to download the target upgrade package from the display apparatus 200 by sending the download request, such as UpdateApplyRequestor, to the display apparatus 200. The smart device 100 needs to carry the token assigned by the display apparatus 200 in the download request so as to use the token to cause the display apparatus 200 to verify authorization for the download process.

S5202, the display apparatus verifies whether the download request carries the token.

The display apparatus 200 verifies whether the download request carries the token to verify the process of downloading the target upgrade package by the smart device 100.

S5203, the display apparatus authorizes a download for the smart device when the download request carries the token, and the target upgrade package is sent to the smart device.

The display apparatus 200, based on that it identifies that the download request carries the token, believes that the smart device 100 passes the verification, authorizes the download for the smart device 100, and, after authorizing the download for the smart device 100, can send the target upgrade package to the smart device 100 to cause the smart device 100 to obtain the target upgrade package from the display apparatus 200.

In some embodiments, the display apparatus 200 may provide the target

upgrade package to the smart device 100 through a Big Data Exchange (BDx) protocol, an alternative protocol supported by both the display apparatus 200 and the smart device 100, etc.

S4807, the smart device performs a system upgrade by installing the target upgrade package.

After the smart device 100 obtains the target upgrade package from the display apparatus 200, it installs the target upgrade package to upgrade the system to the version to be upgraded corresponding to the target upgrade package.

In some embodiments, the process of installing the target upgrade package by the smart device 100 may also be protected by the token. The process of installing the target upgrade package by the smart device 100 may refer to FIG. 53, which may include the following.

S5301, the smart device sends an installation request to the display apparatus, wherein the installation request carries the token assigned by the display apparatus.

The smart device 100 requests authorization to install the target upgrade package by sending the installation request, such as NotifyUpdateApplied, to the display apparatus 200. The smart device 100 needs to carry the token assigned by the display apparatus 200 in the installation request so as to use the token to cause the display apparatus 200 to verify authorization for the installation process.

S5302, the display apparatus, in response to the installation request, verifies whether the installation request carries the token.

The display apparatus 200 verifies whether the installation request carries the token so as to verify the process of installing the target upgrade package by the smart device 100.

S5303, the display apparatus authorizes the installation for the smart device when the installation request carries the token.

The display apparatus 200, based on that it identifies that the installation request carries the token, believes that the smart device 100 passes the verification and authorizes the installation for the smart device 100.

S5304, the smart device installs the target upgrade package after being authorized for installation.

The smart device 2 installs the target upgrade package after being authorized for installation.

In some embodiments, the display apparatus 200 may, in response to the installation request of the smart device 100, instantly verify the installation process of the smart device 100, and instantly authorize the installation for the smart device 100 after the smart device 100 passes the verification.

In some embodiments, the display apparatus 200 may, in response to the installation request of the smart device 100, delay the verification for the installation process of the smart device 100, and/or delay the authorized installation for the smart device 100 after the smart device 100 passes the verification.

In some embodiments, based on that the response status of the display apparatus 200 is the second status, the smart device 100 can send the query request to the display apparatus 200 again.

For example, based on that the smart device 100 identifies busy from the status field of the response information, the smart device 100 may determine that the display apparatus 200 is in the second status. While the display apparatus 200 is in the second status, the smart device 100 may determine that a system upgrade is required, but the display apparatus 200 does not currently support providing a

system upgrade service for the smart device 100. The smart device 100 may send the query request to the display apparatus 200 again without having to execute the discovery process of the display apparatus again, and once the response status of the display apparatus 200 is changed, such as to the first status, the smart device 100 can quickly perform an OTA proxy upgrade through the display apparatus 200. The display apparatus 200 obtains the response status again after receiving the query request sent from the smart device 100 again. A process of obtaining the response status may refer to steps S5001-S5002 and will not be repeated here. For example, the display apparatus 200, in response to the query request sent again by the smart device 100, identifies that the download of the target upgrade package is currently completed and that the system upgrade service for the smart device 100 is currently supported, so it may be determined that the response status is changed to the first status.

In some embodiments, the smart device 100 may send the query request to the display apparatus 200 again in accordance with a preset period (e.g., a period for querying whether a system upgrade is required, or a shorter period). In some embodiments, the smart device 100 may send the query request to the display apparatus 200 again in response to the command from the user. For example, based on that the smart device 100 displays that the status of the display apparatus 200 is busy, such as displaying the text “busy” or sending a voice prompt, the user may input the command to the smart device 100, instructing the smart device 100 to send the query request to the display apparatus 200 again.

In some embodiments, based on that the response status of the display apparatus 200 is the third status, the smart device 100 confirms that a system upgrade is not currently required.

For example, based on that the smart device 100 identifies not available from the status field of the response information, the smart device 100 may determine that the display apparatus 200 is in the third status. When the display apparatus 200 in the third status, the smart device 100 may determine that no system upgrade is currently required, and thus may end this OTA proxy upgrade process.

In some embodiments, based on that the response status of the display apparatus 200 is the fourth status, the smart device 100 can send a query request to other devices used for providing system upgrade proxy services in the virtual domain where it is located.

For example, based on that the smart device 100 identifies download protocol not supported from the status field of the response information, the smart device 100 may determine that the display apparatus 200 is in the fourth status. With the display apparatus 200 in the fourth status, the smart device 100 may determine that the display apparatus 200 is unable to support the download protocol supported by the smart device 100, and thus is not capable of acting as a display apparatus. To ensure that the smart device 100 can perform the system upgrade, the smart device 100 may send a query request to other devices that are used for providing the system upgrade proxy services in the virtual domain where it is located so as to perform the OTA proxy upgrade through other display apparatuses. The OTA proxy upgrade of the smart device 100 through other display apparatuses may refer to steps S4801-S4807, which will not be repeated here.

In some embodiments, the smart device 100 may send the query request to other display apparatuses in accordance with a preset period (e.g., a period for querying whether a system upgrade is required, or a shorter period). In some embodiments, the smart device 100 may send a query request to

other display apparatuses in response to a command from the user. For example, based on that the smart device 100 displays that the status of the display apparatus 200 is download protocol not supported, such as displaying the text “download protocol not supported”, or can send a voice prompt, the user may input the command to the smart device 100 to instruct the smart device 100 to send the query request to the other display apparatuses.

A process of an OTA proxy upgrade of the smart device 100 through the display apparatus 200 is illustrated in conjunction with the following examples.

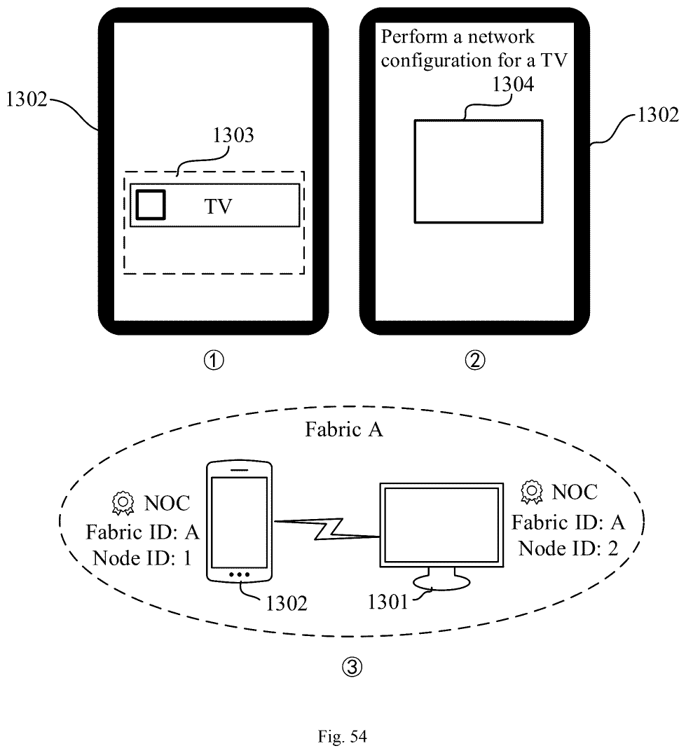

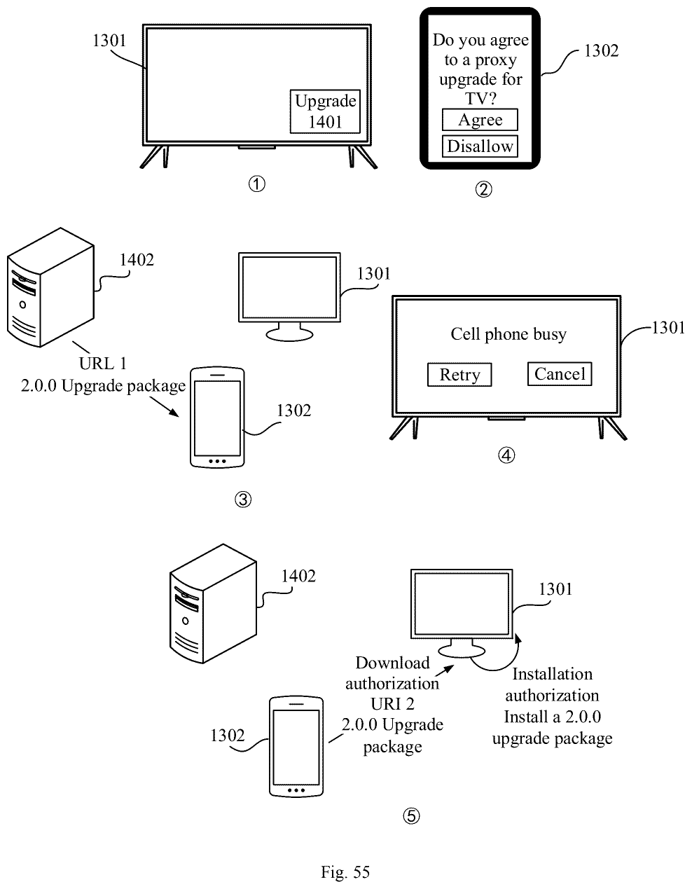

The smart device 100 being a device having a visual interface, the smart device 100 being a to-be-configured device, and the display apparatus 200 being a configuration device are taken as an example. In conjunction with FIG. 54 and FIG. 55, the process of realizing the OTA proxy upgrade of the TV 1301 through the cell phone 1302 is illustrated by taking the smart device 100 being the TV 1301 and the display apparatus 200 being the cell phone 1302 as an example.

In conjunction with the network configuration process shown in FIG. 54, the TV 1301 and the cell phone 1302 access a wireless network, such as WiFi-AAAA, and provide a device discovery service outward. After discovering the TV 1301, the cell phone 1302 displays a device adding interface as shown in \textcircled{1} in FIG. 54 in response to a first display command from the user. The device adding interface may include a device list 1303, and the device list 1303 may include to-be-configured devices that have been found, such as the TV 1301.

The TV 1301 and the cell phone 1302 execute network configuration processes in response to a network configuration instruction respectively. For example, the user inputs an adding command on the basis of an option for the TV 1301, the cell phone 1302, in response to the adding command, displays a network configuration interface as shown in \textcircled{2} in FIG. 54, and the network configuration interface may include a scanning box 1304. The user scans a two-dimensional code provided by the TV 1301 via the scanning box 1304 so as to send a network configuration request to the TV 1301. The TV 1301, in response to the network configuration request, returns a passcode to the cell phone 1302 and establishes a first encrypted session with the cell phone 1302 on the basis of the passcode. via the first encrypted session, the cell phone 1302 can send a verification request to the TV 1301, and the TV 1301 feeds back a device attestation certificate in response to the verification request. The cell phone 1302 verifies the validity of the TV 1301 according to the device attestation certificate. After the TV 1301 is attested, the cell phone 1302 adds the TV 1301 to the virtual domain Fabric A to which it belongs, and can send network configuration information to the TV 1301, and the network configuration information may include a NOC assigned by the cell phone 1302 to the TV 1301. As shown in \textcircled{3} in FIG. 54, the NOC held by the cell phone 1302 may include: a Fabric ID: A and a Node ID: 1, and the NOC held by the TV 1301 may include: a Fabric ID: A and a Node ID: 2. Thus, the process of the network configuration of the TV 1301 and the cell phone 1302 is completed, and the TV 1301 and the cell phone 1302 are located in the same one virtual domain Fabric A.

In conjunction with the OTA proxy upgrade process shown in FIG. 55, the cell phone 1302 broadcasts a message outward, which may include a Fabric ID: A, a Node ID: 1, a device identifier (e.g., 0x0014, which identifies the provision of the system upgrade proxy service), an Endpoint ID, etc. The TV 1301 may receive, in accordance with a preset period, a message broadcast by each device (may include the cell phone 1302), and identify a target message that may be used as a display apparatus according to the

received message. The TV 1301 may also search for a display apparatus in response to a command from the user. For example, the TV 1301 displays an upgrade option 1401 as shown in \textcircled{1} in FIG. 55, the user may input a command on the basis of the upgrade option 1401, and the TV 1301 searches for a display apparatus in response to the command. Based on that the TV 1301 identifies only that the cell phone 1302 is located in the same one virtual domain Fabric A as the TV 1301 in various received broadcast messages, and the cell phone 1302 may provide a system upgrade proxy service, the message broadcast by the cell phone 1302 may be determined to be the target message. The TV 1301 further locates the cell phone 1302 within Fabric A according to the Node ID: 1.

After discovering the cell phone 1302 (a display apparatus), the TV 1301 can send a query request to the cell phone 1302. The query request may carry device information related to the system of the TV 1301, the current version of the system, and an obtaining address of the upgrade package. Information of each part may be represented in a corresponding field. The current software version of the system being 1.0.0, and the obtaining address of the upgrade package in the cloud server 1402 being URL 1 are taken as an example.

The cell phone 1302, in response to the query request, obtains the response status. For example, the cell phone 1302 determines by verification that an upgrade package for the TV 1301 is available in accordance with the URL 1 and may determine that the latest version of the system of the TV 1301 is 2.0.0, that the latest version is higher than the current software version of the system of the TV 1301, and that the TV 1301 requires a system upgrade. Based on that the cell phone 1302 identifies that an upgrade package with version 2.0.0 does not currently exist and can support a download protocol supported by the TV 1301 (e.g., the BDx protocol), the cell phone 1302 can generate a response status as the second status (e.g., busy). The cell phone 1302 returns response information to the TV 1301 and adds busy in the status field. The cell phone 1302 may also add a timeout period, such as 3s, in delayed action time. Based on that the cell phone 1302 does not receive an instruction sent from the TV 1301 within 3s, it ends this system upgrade proxy service. The cell phone 1302 may display inquiry information “Do you agree to a proxy upgrade for TV” as shown in Qin FIG. 55, as well as display an Agree option and a Disallow option. Based on that the user inputs an authorization instruction on the basis of the Agree option, the cell phone 1302 downloads an upgrade package of version 2.0.0 from the cloud server 1402 in response to the authorization instruction in accordance with the URL 1. Based on that the user inputs a disallowing instruction on the basis of the Disallow option, the cell phone 1302 ends this system upgrade proxy service. Taking the user authorization to download the upgrade package as an example, as shown in \textcircled{3} in FIG. 55, the cell phone 1302 downloads the upgrade package of version 2.0.0 from the cloud server 1402 in accordance with the URL 1.

The TV 1301 receives the response information and determines that the cell phone 1302 is in the busy status. The TV 1301 may send the query request to the cell phone 1302 again in accordance with a preset period, or the TV 1301 may send the query request to the cell phone 1302 again in response to a command input from the user. For example, the TV 1301 receives response information to display the response status of the cell phone 1302 such as “cell phone busy” as shown in \textcircled{4} in FIG. 55, as well as to display a Retry option and a Cancel option. Based on that the user inputs a command on the basis of the Retry option, the TV 1301 can send a query request to the cell phone 1302 again in response to that command.

The cell phone 1302, in response to the query request sent again by the TV

1301, based on that it identifies that the download of the upgrade package with version 2.0.0 has been completed and that it currently can support the provision of the system upgrade proxy service for the TV 1301, returns response information to the TV 1301 and adds update available in the status field. The cell phone 1302 also adds the address, e.g., URI 2, of the upgrade package in the cell phone 1302 in the Image URI field, and adds the version, e.g., 2.0.0, of the upgrade package in the software version field. The cell phone 1302 also adds the token, e.g., token X, assigned for the TV 1301 in the update token field.

After receiving the response information, the TV 1301 identifies that the cell phone 1301 is currently in the update available status. The TV 1301 can send a download request to the cell phone 1302 and carries the token X within the download request. The cell phone 1302, in response to the download request, identifies that the download request carries the token X. The TV 1301 passes the verification, and the cell phone 1302 authorizes the download process for the TV 1301. As shown in \textcircled{5} in FIG. 55, after being authorized to download, the TV 1301 downloads the upgrade package of version 2.0.0 from the cell phone 1302 by using a supported download protocol, such as the BDx protocol, in accordance with URI 2 and version 2.0.0.

After completing the download of the upgrade package, the TV 1301 can send an installation request to the cell phone 1302 and carries the token X within the installation request. The cell phone 1302, in response to the installation request, identifies that the installation request carries the token X. The TV 1301 passes the verification, and the cell phone 1302 authorizes the installation process for the TV 1301. After being authorized for installation, the TV 1301 installs the upgrade package to upgrade the system to version 2.0.0.

After completing the installation, the TV 1301 can send an installation completion message to the cell phone 1302. The TV 1301 may also display prompt information to prompt the user for the completion of the system upgrade.

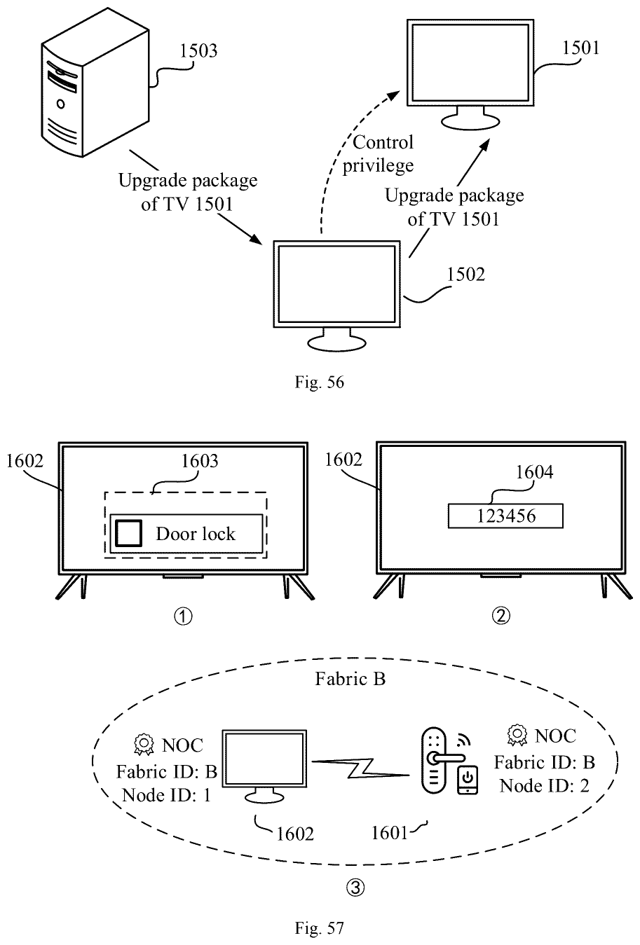

In conjunction with the OTA proxy upgrade scenario shown in FIG. 56, the process of an OTA proxy upgrade of the TV 1501 through the TV 1502 is illustrated by taking the example of the smart device 100 being the TV 1501, the display apparatus 200 being the TV 1502, and a network configuration being performed on the smart device 100 by the display apparatus 200.

The process of the TV 1502 performing the network configuration for the TV 1501 may refer to the above example(s), which is not repeated here. The TV 1502 has a control privilege for the TV 1501, e.g., the TV 1502 may be a TV used by a parent, and the TV 1501 may be a TV used by a child. The parent may control a system upgrade for the TV 1501 used by the child via the TV 1502. For example, the TV 1501 disables the function of automatically discovering a display apparatus for the OTA proxy upgrade to avoid the TV 1502 being upgraded to turn on functions that are not suitable for use of the child. The parent may, when a system upgrade of the TV 1501 is required, directly input a command to the TV 1502, which is equivalent to a query request actively sent from the TV 1501. At this time, since the TV 1501 is a configuration device of the TV 1502, the TV 1501 and the TV 1502 are necessarily located in the same one virtual domain, and the TV 1502 may serve as a display apparatus for the TV 1501. The TV 1501 can perform a system upgrade of the TV 1502 in response to the command. The process of the TV 1502 downloading a target upgrade package from the cloud server 1503 may again be authorized by the parent or may no longer be authorized by the parent. The TV 1502 may send the

target upgrade package directly to the TV 1501 without the TV 1501 having to send a download request, or it may directly issue an installation privilege for the TV 1501 to cause the TV 1501 to complete the system upgrade as soon as possible.

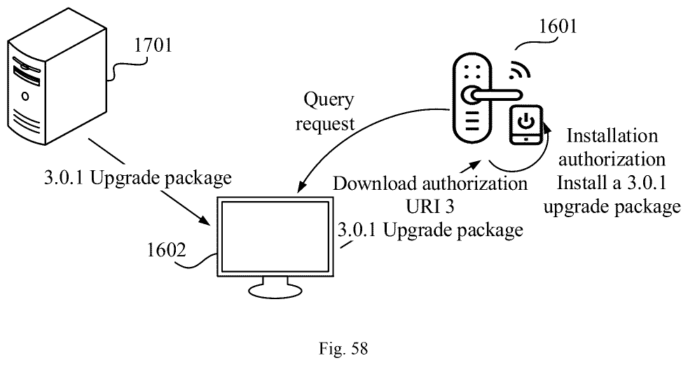

The smart device 100 being a device that does not have a visual interface, the smart device 100 being a to-be-configured device, and the display apparatus 200 being a configuration device are taken as an example. In conjunction with FIG. 57 and FIG. 58, the process of realizing an OTA proxy upgrade of the door lock 1601 through the TV 1602 is illustrated by using the smart device 100 being the door lock 1601 and the display apparatus 200 being the TV 1602 as an example.

In conjunction with the network configuration process shown in FIG. 57, the door lock 1601 turns on a Bluetooth function and provides a device discovery service outward, after discovering the door lock 1601, the TV 1602, in response to a first display command from a user, displays a device adding interface as shown in \textcircled{1} in FIG. 58, the device adding interface may include a device list 1603 which may include a found to-be-configured device, such as the door lock 1601.

The door lock 1601 and the TV 1602, in response to the network configuration instruction, execute network configuration processes respectively. For example, the user inputs an adding command on the basis of an option for the door lock 1601, the TV 1602, in response to the adding command, displays a network configuration interface as shown in \textcircled{2} in FIG. 57, and the network configuration interface may include a text input box 1604. The user can send a network configuration request to the door lock 1601 by inputting a pairing code, such as 123456, into the text input box 1604. In response to the network configuration request, the door lock 1601 returns a passcode to the TV 1602 and establishes a first encrypted session with the TV 1602 on the basis of the passcode. via the first encrypted session, the TV 1602 can send a verification request to the door lock 1601, and the door lock 1601 feeds back a device attestation certificate in response to the verification request. The TV 1602 verifies the validity of the door lock 1601 according to the device attestation certificate. After the door lock 1601 is attested, the TV 1602 adds the door lock 1601 to the virtual domain Fabric B to which it belongs and can send network configuration information to the door lock 1601, and the network configuration information may include the NOC assigned to the door lock 1601 by the TV 1602. As shown in \textcircled{3} in FIG. 57, the NOC held by the TV 1602 may include: a Fabric ID: B and a Node ID: 1, and the NOC held by the door lock 1601 may include: a Fabric ID: B and a Node ID: 2. The network configuration information sent from the TV 1602 to the door lock 1601 may also include network interface configuration information, such as a network name, e.g., BBBB, of a wireless network WiFi-BBBB, where the TV 1602 is located, and an SSID, e.g., 123456789. The door lock 1601 accesses the wireless network WiFi-BBBB in accordance with the network interface configuration information. As a result, the network configuration process of the door lock 1601 and the TV 1602 is completed, and the door lock 1601 and the TV 1602 are located in the same one virtual domain Fabric B.

In conjunction with the OTA proxy upgrade process shown in FIG. 58, the TV 1602 broadcasts a message outward, which may include a Fabric ID: B, a Node ID: 1, a device identifier (e.g., 0x0014, which identifies the provision of the system upgrade proxy service), an Endpoint ID, etc. The door lock 1601 may, in accordance with a preset period, receive a message broadcast by each device (which may include the

TV 1602), and identify a target message that may be used as a display apparatus according to the received message. Based on that the door lock 1601 identifies only that the TV 1602 and the door lock 1601 are located in the same one virtual domain Fabric B in the various received broadcast messages, and the TV 1602 may provide a system upgrade proxy service, the message broadcast by the TV 1602 may be determined as the target message. The door lock 1601 further locates the TV 1602 in Fabric B according to the Node ID: 1.

After discovering the TV 1602 (display apparatus), the door lock 1601 can send a query request to the TV 1602. The process of the TV 1602 returning response information to the door lock 1601 in response to the query request may refer to the above example(s), which is not repeated here. After the TV 1602 obtains authorization from the user, as shown in FIG. 58, the TV 1602 obtains a target upgrade package, such as an upgrade package of version 3.0.1, from the cloud server 1701.

When the response information returned by the TV 1602 carries update available in the status field, the door lock 1601 identifies the address, e.g., URI 3, of the upgrade package in the TV 1602 from the Image URI field, identifies the version, e.g., 3.0.1, of the target upgrade package from the software version field, and obtains a token, e.g., token Y, from the update token field.

The door lock 1601 can send a download request to the TV 1602 and carries the token Y within the download request. The TV 1602, in response to the download request, identifies that the download request carries the token Y. The door lock 1601 passes the verification, and the TV 1602 authorizes the download process for the door lock 1601. As shown in FIG. 58, the door lock 1601, after being authorized to download, can use a supported download protocol, such as the BDx protocol, to download the upgrade package of version 3.0.1 from the TV 1602 in accordance with URL 3 and version 3.0.1.

After completing the download of the upgrade package, the door lock 1601 can send an installation request to the TV 1602 and carries the token Y within the installation request. The TV 1602, in response to the installation request, identifies that the installation request carries the token Y, the door lock 1601 passes the verification, and the TV 1602 authorizes the installation process for the door lock 1601. After being authorized for installation, the door lock 1601 installs the upgrade package to upgrade the system to version 3.0.1.

After completing the installation, the door lock 1601 can send an installation completion message to the TV 1602. The door lock 1601 may also display prompt information to prompt the user for the completion of the system upgrade.

In some embodiments, after performing the network configuration for the smart device 100, the display apparatus 200 has a control privilege for the smart device 100. The smart device 100 may automatically perform an OTA upgrade through the display apparatus 200, at this time, the user has no perception of the OTA upgrade process of the smart device 100, and the OTA upgrade of the smart device 100 will not have an impact on the user. On the basis of the control privilege of the display apparatus 200 over the smart device 100, the user may actively control the OTA upgrade of the smart device 100 through the display apparatus 200, so as to realize the active control of the OTA upgrade process of the smart device 100 by the user.

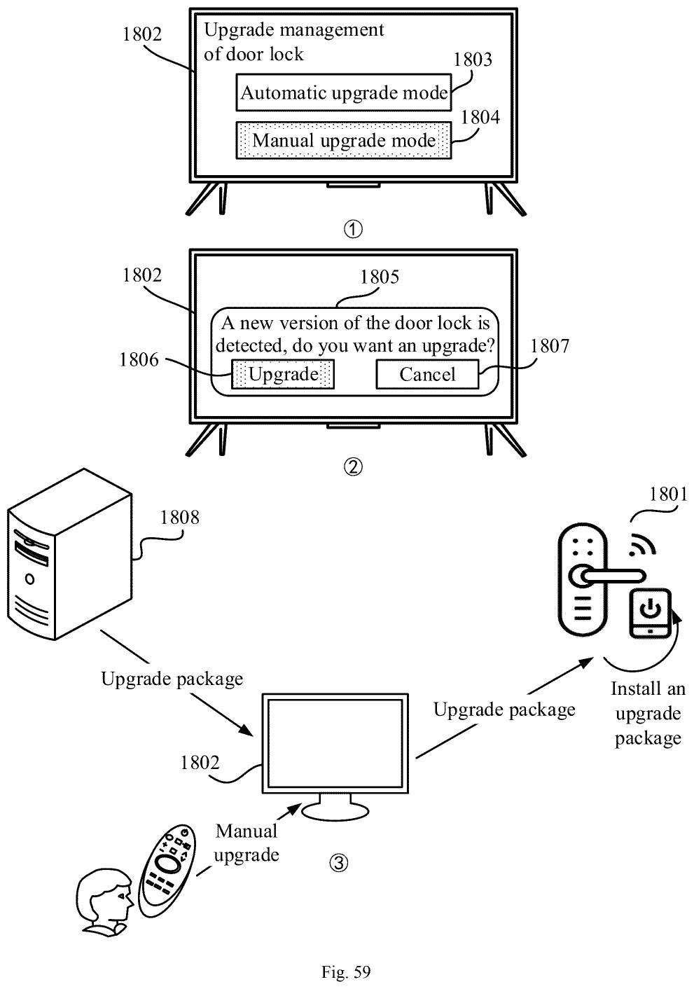

In conjunction with the OTA proxy upgrade scenario shown in FIG. 59, the

process of the OTA proxy upgrade of the door lock 1801 through the TV 1802 is illustrated by taking the example of the smart device 100 being a door lock 1801, the display apparatus 200 being a TV 1802, and a network configuration being performed on the smart device 100 by the display apparatus 200.

The process of the TV 1802 performing the network configuration for the door lock 1801 may refer to the above example(s), which is not repeated here. The TV 1802 has the control privilege for the door lock 1801. The user may manage the OTA upgrade process of the door lock 1801 via the TV 1802, for example, the user may control the TV 1802 to display an upgrade management page of the door lock 1801 by inputting a command to the TV 1802, which may refer to the upgrade management page of the door lock 1801 as shown in \textcircled{1} in FIG. 18, and the upgrade management page may include an automatic upgrade mode option 1803 and a manual upgrade mode option 1804. Based on that the user selects the automatic upgrade mode option 1803, the door lock 1801 will perform an automatic OTA upgrade, and the process of the automatic OTA upgrade of the door lock 1801 may refer to the above example(s), which is not repeated here. Based on that the user selects the manual upgrade mode option 1804, as shown in \textcircled{1} in FIG. 59 with a gray background to indicate that the manual upgrade mode option 1804 is selected, the TV 1802 will send a turn-off instruction to the door lock 1801 to turn off the automatic OTA upgrade function of the door lock 1801. The TV 1802 may, in response to a query command from the user, query whether the door lock 1801 requires a system upgrade. The TV 1802 may also enable an upgrade displaying service for the door lock 1801 to actively display whether the door lock 1801 requires the system upgrade. The TV 1802 displays an upgrade prompt when it detects that the door lock 1801 requires an upgrade, e.g., as shown in \textcircled{2} in FIG. 59, displays the upgrade prompt in the form of a pop-up window 1805 such as “A new version of the door lock is detected, do you want an upgrade?”. The TV 1802 may also display a logo on an icon of the door lock 1801 to indicate that the door lock 1801 requires an upgrade. When the door lock 1801 requires an upgrade, the TV 1802 may perform an OTA upgrade for the door lock 1801 in response to an upgrade command from the user. For example, as shown in \textcircled{2} in FIG. 59, the pop-up window 1805 may also include an upgrade option 1806 and a cancel option 1807. Based on that the user selects the upgrade option 1806, as shown in \textcircled{2} in FIG. 59 with a gray background indicating that the upgrade option 1806 is selected, the TV 1802 downloads the upgrade package from the cloud server 1808 as shown in \textcircled{3} in FIG. 59 and can perform an OTA upgrade for the door lock 1801. Based on that the user selects the cancel option 1807, the TV 1802 does not provide an OTA upgrade service for the door lock 1801. The users may also switch the door lock 1801 to the automatic upgrade mode through an upgrade management page of the door lock 1801. The process of obtaining the response status of the TV 1802 before upgrading the door lock 1801 in response to the command from the user, the download authorization process of the door lock 1801, and the installation authorization process of the door lock 1802 may all refer to the above example(s), which is not repeated here.

For ease of explanation, the above description has been made in conjunction with specific embodiments. However, the above discussion in some embodiments is not intended to be exhaustive or to limit some embodiments to specific forms disclosed above. Various modifications and deformations may be obtained according to the above instruction. The above implementations have been selected

and described to better explain the present disclosure, thereby enabling better use of the implementations by those skilled in the art.

What is claimed is:

1. An electronic device, comprising:
a display, configured to display an image and/or a user interface, wherein the user interface comprises a device adding interface;
a memory, configured to store computer instructions and a node operational certificate corresponding to a virtual domain of the electronic device, wherein the virtual domain comprises the electronic device and one or more commissionee devices associated by the electronic device; and
at least one processor, in connection with the display, the memory and configured to execute the computer instructions to cause the electronic device to execute:
controlling, in response to an adding command input from a user on the basis of a first device, the display to display a network configuration interface, wherein the adding command is used for instructing a network configuration for the first device, and the network configuration interface is used for the user to perform a network configuration operation on the first device;
sending, in response to the network configuration operation from the user, a network configuration request to the first device, wherein the network configuration request is used for requesting an establishment of a first encrypted session with the first device;
sending a verification request to the first device via the first encrypted session, wherein the verification request is used for requesting a device attestation certificate of the first device;
sending, based on that the first device is identified to be attested according to a received device attestation certificate, network configuration information to the first device via the first encrypted session, wherein the network configuration information comprises a node operational certificate assigned to the first device; and
controlling, after the network configuration for the first device, the display to display a commissionee device interface, wherein the commissionee device interface comprises the first device;
sending, in response to a selection command input from the user on the basis of the first device, an interaction request to the first device via the first encrypted session, wherein the interaction request is used for requesting establishment of a second encrypted session with the first device, and the second encrypted session is established on the basis of the node operational certificate held by the electronic device and the node operational certificate held by the first device respectively; and
sending, in response to a control operation from the user, a corresponding command to the first device via the second encrypted session.

2. The electronic device according to claim 1, wherein the at least one processor is further configured to execute the computer instructions to cause the electronic device to execute:
searching for, in response to a first display command input from the user, the first device on the basis of a discovery protocol supported by the first device; and
controlling the display to display the device adding interface, wherein an item of the first device is displayed in the device adding interface based on that the first device is discovered.

3. The electronic device according to claim 1, wherein the at least one processor is configured to execute the computer instructions to cause the electronic device to execute:
obtaining, in response to the network configuration operation from the user, a passcode from the first device; and
establishing, according to the passcode and a first encrypted session protocol, the first encrypted session with the first device.

4. The electronic device according to claim 3, wherein:
the network configuration operation is, based on that the network configuration interface comprises a scanning box for a two-dimensional code, to scan the two-dimensional code provided by the first device through the scanning box, and the two-dimensional code is used for providing the passcode;
the network configuration operation is, based on that the network configuration interface comprises an input box for a pairing code, to input the pairing code of the first device in the input box, and the pairing code of the first device is used for obtaining the passcode; and
prompt information prompts, based on that the network configuration interface comprises the prompt information, to obtain the passcode through a near field communication technology, then the network configuration operation is to establish near field communication between the electronic device and the first device, and the near field communication is used for obtaining the passcode.

5. The electronic device according to claim 1, wherein the network configuration information further comprises network interface configuration information, and the at least one processor is configured to execute the computer instructions to cause the electronic device to execute:
determining whether the first device has accessed a specified network; and
sending, based on that the first device does not access the specified network, a network configuration instruction to the first device via the first encrypted session to instruct the first device to access the specified network according to the network interface configuration information.

6. The electronic device according to claim 1, wherein the at least one processor is configured to execute the computer instructions to cause the electronic device to perform:
controlling the display to display the first device in a first region of the commissionee device interface, wherein the first region is a region where a classification to which the commissionee device belongs is undefined; and
the at least one processor is further configured to execute the computer instructions to cause the electronic device to perform:
control, in response to a movement command input from the user on the basis of the first device, the display to move the first device into a second region to be displayed, wherein the second region is a region in the commissionee device interface where the classification to which the commissionee device belongs is defined.

7. The electronic device according to claim 1, wherein the at least one processor is configured to execute the computer instructions to cause the electronic device to perform:
sending, in response to a service turn-on command input from the user, a first instruction to the first device via the second encrypted session, wherein the first instruction is used for instructing the first device to resume providing a device discovery service to an external device, and the first device discontinues providing the device discovery service to an external device after establishing the first encrypted session with the electronic device;
displaying, in response to a second display command input from the user, a control privilege management interface, wherein the control privilege management interface comprises a privilege available to a second device to control the first device, and the second device completes the network configuration for the first device when the first device resumes providing the device discovery service to an external device; and
sending, in response to a privilege management command input from the user on the basis of the privilege management interface, a second instruction to the first device via the second encrypted session, wherein the second instruction is used for instructing the first device to set the privilege instructed by the privilege management command for the second device.

8. The electronic device according to claim 1, wherein the at least one processor is configured to execute the computer instructions to cause the electronic device to execute:
setting the first device to an on-line state after the network configuration for the first device;
obtaining device information of the first device in accordance with time-to-live of a service discovery record issued by the first device;
keeping the first device in the on-line state based on that the device information of the first device is obtained; and
setting the first device to an off-line state based on that the device information of the first device is not obtained.

9. The electronic device according to claim 8, wherein the at least one processor is configured to execute the computer instructions to cause the electronic device to execute:
obtaining a media access control address of the first device during the network configuration for the first device, wherein the media access control address is an address used by a primary control device to send a remote wake-on instruction to the first device; and
controlling the memory to store the media access control address of the first device.

10. The electronic device according to claim 9, wherein the at least one processor is configured to execute the computer instructions to cause the electronic device to execute:
obtaining a Cluster supported by the first device;
determining whether the Cluster comprises a remote wake-on cluster;
determining, based on that the remote wake-on cluster is comprised, whether an attribute of the media access control address exists;
obtaining, based on that the attribute of the media access control address exists, the media access control address; and
obtaining, based on that the attribute of the media access control address does not exist, the media access control address according to an address resolution protocol.

11. The electronic device according to claim 9, wherein the at least one processor is configured to execute the computer instructions to cause the electronic device to execute:
controlling, in response to a command from the user, the display to display a commissionee device list, wherein the commissionee device list comprises the first device;
wherein the first device is displayed as being in the on-line state in the commissionee device list based on that the first device is in the on-line state; and
the first device is displayed as being in the off-line state in the commissionee device list based on that the first device is in the off-line state, wherein the commissionee device list further comprises a first button of the first device based on that the memory stores the media access control address of the first device, and the first button is used for inputting the remote wake-on instruction.

12. A method for an electronic device, comprising:
controlling, in response to an adding command input from a user on the basis of a first device, a display to display a network configuration interface, wherein the adding command is used for instructing a network configuration for the first device, and the network configuration interface is used for the user to perform a network configuration operation on the first device;
sending, in response to the network configuration operation from the user, a network configuration request to the first device, wherein the network configuration request is used for requesting an establishment of a first encrypted session with the first device;
sending a verification request to the first device via the first encrypted session, wherein the verification request is used for requesting a device attestation certificate of the first device;
sending, based on that the first device is identified to be attested according to a received device attestation certificate, network configuration information to the first device via the first encrypted session, wherein the network configuration information comprises a node operational certificate assigned to the first device; and
controlling, after the network configuration for the first device, the display to display a commissionee device interface, wherein the commissionee device interface comprises the first device;
sending, in response to a selection command input from the user on the basis of the first device, an interaction request to the first device via the first encrypted session, wherein the interaction request is used for requesting establishment of a second encrypted session with the first device, and the second encrypted session is established on the basis of the node operational certificate held by the electronic device and the node operational certificate held by the first device respectively; and
sending, in response to a control operation from the user, a corresponding command to the first device via the second encrypted session.

13. The method according to claim 12, further comprising:
searching for, in response to a first display command input from the user, the first device on the basis of a discovery protocol supported by the first device; and
controlling the display to display the device adding interface, wherein an item of the first device is displayed in the device adding interface based on that the first device is discovered.

14. The method according to claim 12, further comprising:
obtaining, in response to the network configuration operation from the user, a passcode from the first device; and
establishing, according to the passcode and a first encrypted session protocol, the first encrypted session with the first device.

15. The method according to claim 14, wherein:
the network configuration operation is, based on that the network configuration interface comprises a scanning box for a two-dimensional code, to scan the two-dimensional code provided by the first device through the scanning box, and the two-dimensional code is used for providing the passcode;
the network configuration operation is, based on that the network configuration interface comprises an input box for a pairing code, to input the pairing code of the first device in the input box, and the pairing code of the first device is used for obtaining the passcode; and
prompt information prompts, based on that the network configuration interface comprises the prompt information, to obtain the passcode through a near field communication technology, then the network configuration operation is to establish near field communication between the electronic device and the first device, and the near field communication is used for obtaining the passcode.

16. The method according to claim 12, wherein the network configuration information further comprises network interface configuration information, and the method further comprises:
determining whether the first device has accessed a specified network; and
sending, based on that the first device does not access the specified network, a network configuration instruction to the first device via the first encrypted session to instruct the first device to access the specified network according to the network interface configuration information.

17. The method according to claim 12, further comprising:
controlling the display to display the first device in a first region of the commissionee device interface, wherein the first region is a region where a classification to which the commissionee device belongs is undefined; and
the at least one processor is further configured to execute the computer instructions to cause the electronic device to perform:
control, in response to a movement command input from the user on the basis of the first device, the display to move the first device into a second region to be displayed, wherein the second region is a region in the commissionee device interface where the classification to which the commissionee device belongs is defined.

18. The method according to claim 12, further comprising:
sending, in response to a service turn-on command input from the user, a first instruction to the first device via the second encrypted session, wherein the first instruction is used for instructing the first device to resume providing a device discovery service to an external device, and the first device discontinues providing the device discovery service to an external device after establishing the first encrypted session with the electronic device;
displaying, in response to a second display command input from the user, a control privilege management interface, wherein the control privilege management interface comprises a privilege available to a second device to control the first device, and the second device completes the network configuration for the first device when the first device resumes providing the device discovery service to an external device; and
sending, in response to a privilege management command input from the user on the basis of the privilege management interface, a second instruction to the first device via the second encrypted session, wherein the second instruction is used for instructing the first device to set the privilege instructed by the privilege management command for the second device.

19. The method according to claim 12, further comprising:
setting the first device to an on-line state after the network configuration for the first device;
obtaining device information of the first device in accordance with time-to-live of a service discovery record issued by the first device;
keeping the first device in the on-line state based on that the device information of the first device is obtained; and
setting the first device to an off-line state based on that the device information of the first device is not obtained.

20. The method according to claim 19, further comprising:
obtaining a media access control address of the first device during the network configuration for the first device, wherein the media access control address is an address used by a primary control device to send a remote wake-on instruction to the first device; and
controlling the memory to store the media access control address of the first device.
